(19) United States
(12) Patent Application Publication
(10) Pub. No.: US 2025/0090290 A1
(43) Pub. Date: Mar. 20, 2025

(54) INTRAORAL COLORIMETRIC SENSORS FOR PATIENT MONITORING

(71) Applicant: Align Technology, Inc., San Jose, CA (US)

(72) Inventors: Byong-Ho Park, San Jose, CA (US); Hunho Jo, San Jose, CA (US); Zijie Zhu, San Jose, CA (US); Wesly Wong, Cupertino, CA (US); Fred Ting, San Jose, CA (US); Zhichao Zhang, Walnut Creek, CA (US); Robert Nettles-Miller, San Jose, CA (US); Sheyda Nazarian, San Jose, CA (US); Yixin Xu, San Jose, CA (US); Vincent Yeh, Fremont, CA (US); Sangshik Park, San Jose, CA (US); Changgyu Bak, Seoul (KR); Jun Sato, San Jose, CA (US)

(21) Appl. No.: 18/885,409

(22) Filed: Sep. 13, 2024

Related U.S. Application Data
(60) Provisional application No. 63/583,121, filed on Sep. 15, 2023.

(51) Int. Cl. A61C 19/04

(52) U.S. Cl. CPC A61C 19/04

(57) ABSTRACT

Intraoral sensors and associated systems, devices, and methods are provided. In some embodiments, an intraoral sensor for sensing pH within an intraoral cavity of a subject includes a film composed of a biocompatible polymer and a pH-sensitive molecule. The pH-sensitive molecule can be configured to change in color based on a pH within a subject's intraoral cavity. The pH-sensitive molecule can be immobilized in the film. The intraoral sensor can also include an adhesive configured to couple the film to a surface of a dental appliance or a tooth of the subject.

### CROSS-REFERENCE TO RELATED APPLICATION(S)

The present application claims the benefit of priority to U.S. Provisional Application No. 63/583,121, filed Sep. 15, 2023, the disclosure of which is incorporated by reference herein in its entirety.

### TECHNICAL FIELD

The present technology generally relates to medical devices, and in particular, to intraoral sensors for monitoring dental treatment and/or oral health.

### BACKGROUND

The pH conditions within an individual's mouth can significantly affect their oral health. For instance, Gram-negative anaerobic microorganisms that are associated with periodontal disease proliferate under acidic conditions, such that an individual may be more susceptible to dental decay, halitosis, periodontitis, and/or other conditions if their intraoral pH is not maintained at or near neutrality (e.g., pH 6.7 to 7.3). However, most individuals are unaware of their intraoral PH levels, and technologies for accurate, easy to use, and cost-effective intraoral pH monitoring are lacking. Conventional pH sensor systems generally require complex electronics and bulky instrumentation, and are therefore poorly suited for routine monitoring of an individual's intraoral pH.

During orthodontic or dental treatment, the dental practitioner may rely on the patient to comply with the prescribed dental appliance usage. In some instances, a patient may not wear a dental appliance as prescribed by the dental practitioner. Failure to wear a dental appliance correctly or failure to wear the dental appliance for periods of time extending beyond what is recommended may interrupt a dental treatment plan and lengthen the overall period of treatment. There is a need for methods and apparatuses that allow monitoring of the wearing and/or effects of intraoral appliances.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a perspective view of a dental appliance including an intraoral sensor configured in accordance with embodiments of the present technology.

FIG. 1B is a top view of the intraoral sensor of FIG. 1A.

FIG. 1C is a side cross-sectional view of a portion of the dental appliance and intraoral sensor of FIG. 1A.

FIG. 2A is a side cross-sectional view of a dental appliance coupled to an intraoral sensor via an adhesive, in accordance with embodiments of the present technology.

FIG. 2B is a side cross-sectional view of a dental appliance coupled to an intraoral sensor via interlocking features, in accordance with embodiments of the present technology.

FIG. 2C is a side cross-sectional view of a dental appliance coupled to an intraoral sensor via fasteners, in accordance with embodiments of the present technology.

FIG. 3A is a top view of an intraoral sensor including a sensor substrate and a color reference marker, in accordance with embodiments of the present technology.

FIG. 3B is a side cross-sectional view of a portion of a dental appliance including the intraoral sensor of FIG. 3A.

FIG. 3C is a side cross-sectional view of a portion of a dental appliance including the intraoral sensor of FIG. 3A in another configuration.

FIG. 4A is a top view of an intraoral sensor including a sensor substrate and a color reference marker, in accordance with embodiments of the present technology.

FIG. 4B is a side cross-sectional view of a portion of a dental appliance including the intraoral sensor of FIG. 4A.

FIG. 4C is a side cross-sectional view of a portion of a dental appliance including the intraoral sensor of FIG. 4A in another configuration.

FIG. 5A is a perspective view of a dental appliance including an intraoral sensor and a separate color reference marker, in accordance with embodiments of the present technology.

FIG. 5B is a perspective view of a dental appliance including an intraoral sensor and a color reference marker that are concentric with each other, in accordance with embodiments of the present technology.

FIG. 5C is a perspective view of a dental appliance including an intraoral sensor and a color reference marker that are concentric with each other, in accordance with embodiments of the present technology.

FIG. 5D is a perspective view of a dental appliance including an intraoral sensor and a plurality of color reference markers, in accordance with embodiments of the present technology.

FIG. 5E is a perspective view of a dental appliance including a plurality of intraoral sensors and a color reference marker, in accordance with embodiments of the present technology.

FIG. 5F is a perspective view of a dental appliance including a plurality of intraoral sensors and a plurality of color reference markers, in accordance with embodiments of the present technology.

FIG. 5G is a perspective view of a dental appliance including an intraoral sensor and a plurality of color reference markers arranged in an ornamental design, in accordance with embodiments of the present technology.

FIG. 5H is a perspective view of a dental appliance including a plurality of intraoral sensors and a plurality of color reference markers arranged in an ornamental design, in accordance with embodiments of the present technology.

FIG. 6A is a side cross-sectional view of a portion of a dental appliance including an intraoral sensor with a barrier layer, in accordance with embodiments of the present technology.

FIG. 6B is a side cross-sectional view of a portion of a dental appliance including an intraoral sensor with a barrier layer, in accordance with embodiments of the present technology.

FIG. 7 is a top view of a dental appliance including a plurality of intraoral sensors, in accordance with embodiments of the present technology.

FIG. 8 illustrates a reaction scheme for preparing a chlorophenol red-poly(vinyl alcohol) (PVA) conjugate, in accordance with embodiments of the present technology.

FIG. 9 illustrates a process for preparing a dental appliance with an intraoral sensor, in accordance with embodiments of the present technology.

FIG. 10 illustrates a color reference chart that can be used with an intraoral sensor, in accordance with embodiments of the present technology.

FIG. 11 is a schematic diagram of an ecosystem for monitoring a subject's intraoral health, in accordance with embodiments of the present technology.

FIG. 12 is a block diagram illustrating a general overview of a receptacle for use with an intraoral sensor, in accordance with embodiments of the present technology.

FIG. 13A is a side perspective view of a dental appliance case with an imaging device, in accordance with embodiments of the present technology.

FIG. 13B is a front perspective view of the dental appliance case of FIG. 13A.

FIG. 14A is a side perspective view of a dental appliance case with a spectrophotometer, in accordance with embodiments of the present technology.

FIG. 14B is a front perspective view of the dental appliance case of FIG. 14A.

FIGS. 15A and 15B are perspective views of a receptacle for optical sensing, in accordance with embodiments of the present technology.

FIG. 16 is a flow diagram illustrating a method for monitoring a subject's intraoral cavity, in accordance with embodiments of the present technology.

FIGS. 17A-17E schematically illustrate various techniques for obtaining image data of an intraoral sensor, in accordance with embodiments of the present technology.

FIG. 18 is a flow diagram illustrating a workflow for extracting features from image data of an intraoral sensor, in accordance with embodiments of the present technology.

FIGS. 19A-19E illustrate workflows for determining pH values from image data using a pH prediction model, in accordance with embodiments of the present technology.

FIGS. 20A-20C illustrate workflows for calibrating a pH prediction model, in accordance with embodiments of the present technology.

FIG. 21 is a partially schematic illustration of a portion of a dental appliance configured for detection of dental caries, in accordance with embodiments of the present technology.

FIGS. 22A and 22B are partially schematic illustration of various techniques for fabricating dental appliances with colorimetric molecules for detection of dental caries, in accordance with embodiments of the present technology.

FIGS. 23A and 23B illustrate examples of colorimetric molecules that may be used for detection of dental caries, in accordance with embodiments of the present technology.

FIGS. 24A-24D are photographs of a dental appliance including a compliance indicator, in accordance with embodiments of the present technology.

FIG. 25 illustrates a dental appliance including a compliance indicator and a color reference marker, in accordance with embodiments of the present technology.

FIG. 26A is a perspective view of a dental appliance including a compliance indicator, a color reference marker, a pH sensor, and a temperature sensor, in accordance with embodiments of the present technology.

FIG. 26B is a flow diagram illustrating a workflow for obtaining training data for a wear time estimation model, in accordance with embodiments of the present technology.

FIG. 26C is a flow diagram illustrating a workflow for training a wear time estimation model, in accordance with embodiments of the present technology.

FIG. 26D is a flow diagram illustrating a workflow for determining wear time using a wear time estimation model, in accordance with embodiments of the present technology.

FIG. 27 illustrate a dental appliance including a compliance indicator and a color reference marker separate from the dental appliance, in accordance with embodiments of the present technology.

FIG. 28A illustrates a representative example of a tooth repositioning appliance configured in accordance with embodiments of the present technology.

FIG. 28B illustrates a tooth repositioning system including a plurality of appliances, in accordance with embodiments of the present technology.

FIG. 28C illustrates a method of orthodontic treatment using a plurality of appliances, in accordance with embodiments of the present technology.

FIG. 29 illustrates a method for designing an orthodontic appliance, in accordance with embodiments of the present technology.

FIG. 30 illustrates a method for digitally planning an orthodontic treatment and/or design or fabrication of an appliance, in accordance with embodiments of the present technology.

FIG. 31 is a series of photographs illustrating pH testing of chlorophenol red-PVA sensors with two different film thicknesses.

FIGS. 32A and 32B are photographs illustrating the effects of fabrication substrates on film quality.

FIG. 33A illustrates a RGB value versus pH value calibration curve.

FIG. 33B illustrates colors and corresponding pH values of an intraoral sensor obtained using an image processing mobile application.

FIG. 34A is a photograph illustrating a delphinidin chloride dye at different pH values.

FIG. 34B is a series of photographs illustrating sensors formed with a delphinidin chloride dye and poly(2-hydroxethyl methacrylate) or gelatin.

### DETAILED DESCRIPTION

The present technology relates to intraoral sensors for monitoring a subject's oral health, and associated systems, devices, and methods. In some embodiments, for example, an intraoral sensor for sensing pH within an intraoral cavity of a subject is provided. The intraoral sensor can include a film composed of a biocompatible polymer and a pH-sensitive molecule. The pH-sensitive molecule can be configured to change in color based on a pH within a subject's intraoral cavity. For instance, the pH-sensitive molecule can have a first color if the pH is within a range associated with normal oral health (e.g., greater than 5.5), and a second, different color if the pH is within a range associated with an oral disease or condition (e.g., less than 5.5). The pH-sensitive molecule can be immobilized in the film, such as via covalent conjugation to the biocompatible polymer, thereby providing a stable colorimetric pH indication over extended periods of use (e.g., at least one week to two weeks). The intraoral sensor can optionally include an adhesive configured to couple the film to a surface of a dental appliance (e.g., an aligner, palatal expander, mouth guard, night guard, retainer) or a tooth of the subject. Accordingly, the intraoral sensor can be easily and rapidly applied to the dental appliance or to the subject's tooth to provide on demand monitoring of intraoral pH.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Devices, Systems, and Methods for Intraoral Sensing

### A. Intraoral Sensors

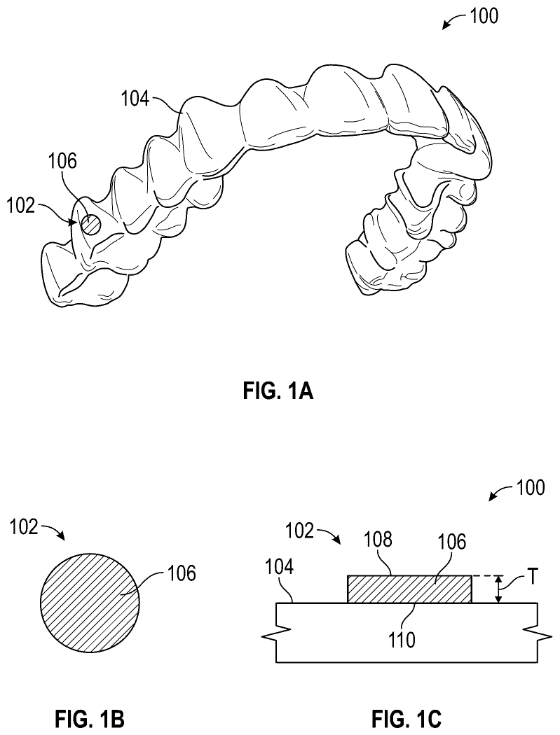

FIGS. 1A-1C illustrate a dental appliance 100 including an intraoral sensor 102 configured in accordance with embodiments of the present technology. Specifically, FIG. 1A is a perspective view of the appliance 100 and intraoral sensor 102, FIG. 1B is a top view of the intraoral sensor 102, and FIG. 1C is a side cross-sectional view of a portion of the appliance 100 including the intraoral sensor 102.

Referring first to FIG. 1A, the appliance 100 can be any device configured to be worn on a subject's teeth, such as an aligner, palatal expander, mouth guard, night guard, retainer, sleep apnea treatment device, etc. The appliance 100 can include a polymeric shell 104 having a plurality of tooth-receiving cavities shaped to accommodate some or all of the subject's teeth. In some embodiments, the appliance 100 is worn by the subject to implement a dental treatment for the subject's teeth. For instance, the appliance 100 can be used to reposition at least some of the teeth from a first arrangement toward a second arrangement in accordance with an orthodontic treatment plan. Additional examples and details of dental appliances that may be used as the appliance 100 are provided in Section II below.

The intraoral sensor 102 is coupled to the appliance 100 such that, when the appliance 100 is worn on the subject's teeth, the intraoral sensor 102 is exposed to intraoral fluids (e.g., saliva, gingival crevicular fluid (GCF)). Accordingly, the intraoral sensor 102 can be used to monitor the pH of the intraoral fluids, which can be representative of the overall pH of the subject's intraoral cavity and can correlate to the oral health of the subject. In some embodiments, the intraoral sensor 102 provides a visual indication of the pH of the intraoral cavity that is detectable by the naked eye and/or using an optical sensing device, as described further herein. For example, the visual indication can be a colorimetric indication in which at least a portion of the intraoral sensor 102 (or the entire intraoral sensor 102) changes in color based on the pH of the intraoral cavity.

The intraoral sensor 102 can include at least one pH-sensitive molecule that changes in color based on the pH of the subject's intraoral cavity, thus providing the colorimetric indication of the intraoral sensor 102. For example, the pH-sensitive molecule can exhibit a first color for a first pH range that is associated with a healthy oral state (e.g., the subject does not have an oral disease or condition, and/or has a reduced risk of developing an oral disease or condition), and a second, different color for a second pH range that is associated with an oral disease or condition (e.g., the subject has an oral disease or condition, and/or has an increased risk of developing an oral disease or condition). In some embodiments, the first pH range is greater than or equal to 5.5, 6, 6.5, 7, or 7.5; and the second pH range is less than 7.5, 7, 6.5, 6, or 5.5. In some embodiments, the pH-sensitive molecule changes from the first color to the second color (or vice-versa) when the pH of the intraoral cavity is within a range from 5 to 7, or from 6 to 8. In other embodiments, however, the pH-sensitive molecule can be configured to change in color over different pH ranges, depending on the oral disease or condition of interest. Moreover, the intraoral sensor 102 can optionally include a plurality of different pH-sensitive molecules that collectively produce a color change over a desired pH range. Additional details and examples of pH-sensitive molecules and associated compositions that can be used in the intraoral sensor 102 are provided in, e.g., Section I.B below.

In some embodiments, the intraoral sensor 102 includes a sensor substrate 106, and the pH-sensitive molecule is immobilized in the sensor substrate 106. The sensor substrate 106 can be a film or other similar structure (e.g., membrane, sheet, tape) that is composed of one or more biocompatible materials that provide a scaffold for immobilization of the pH-sensitive molecule, while also allowing intraoral fluids to access and interact with the pH-sensitive molecule. For instance, the sensor substrate 106 can be composed of one or more biocompatible polymers that are covalently conjugated to the pH-sensitive molecule. Alternatively or in combination, the pH-sensitive molecule can be immobilized within the sensor substrate 106 using other techniques, such as non-covalent interactions (e.g., ionic bonding, hydrogen bonding, hydrophobic interactions, Van der Waals interactions) and/or physical entrapment (e.g., within a polymer network having a mesh size smaller than the size of the pH-sensitive molecule). Additional details and examples of biocompatible polymers and associated compositions that can be present in the sensor substrate 106 are provided in, e.g., Section I.B below.

The intraoral sensor 102 can be positioned at any suitable location on the appliance 100. In FIG. 1A, for example, the intraoral sensor 102 is coupled to an exterior surface of the appliance 100 (the surface away from the tooth-receiving cavities), such as a buccal surface of the appliance 100. In other embodiments, however, the intraoral sensor 102 can be positioned at a different location, such as a lingual surface of the appliance 100 or on an interior surface of the appliance 100 (the surface adjacent to the tooth-receiving cavities). Moreover, although the intraoral sensor 102 is depicted as being positioned at a distal portion of the appliance 100 (e.g., near the subject's molars), in other embodiments, the intraoral sensor 102 can be positioned at a mesial portion of the appliance 100 (e.g., near the subject's canines and/or incisors). Positioning the intraoral sensor 102 at the distal portion of the appliance 100 may be advantageous for reducing the visibility of the intraoral sensor 102 and/or maintaining continuous contact with intraoral fluids, while positioning the intraoral sensor 102 at the mesial portion of the appliance 100 may be desired if the intraoral sensor 102 is also intended to serve as a decorative feature (e.g., a decorative sticker).

Referring next to FIGS. 1B and 1C, the intraoral sensor 102 can have any suitable geometry. In the illustrated embodiment, for example, the sensor substrate 106 of the intraoral sensor 102 has a circular shape. In other embodiments, however, the sensor substrate 106 can have a different shape, such as an oval shape, square shape, rectangular shape, diamond shape, triangular shape, cross shape, star shape, annular shape, etc. The dimensions of the sensor substrate 106 can also be varied as desired. For instance, the sensor substrate 106 can have a length, width, and/or diameter within a range from 1 mm to 10 mm, 1 mm to 5 mm, 2 mm to 10 mm, 2 mm to 5 mm, or 5 mm to 10 mm. In some embodiments, the sensor substrate 106 has a surface area that is sufficiently large so that the color of the sensor substrate 106 is perceivable by the naked eye and/or detectable by an optical sensing device, but sufficiently small so that intraoral fluids can diffuse rapidly into the entire sensor substrate 106. For example, the surface area of the sensor substrate 106 can be within a range from 1 mm² to 100 mm², 1 mm² to 75 mm², 1 mm² to 50 mm², 1 mm² to 25 mm², 10 mm² to 100 mm², 10 mm² to 75 mm², 10 mm² to 50 mm², 10 mm² to 25 mm², 25 mm² to 100 mm², 25 mm² to 75 mm², 25 mm² to 50 mm², 50 mm² to 100 mm², 50 mm² to 75 mm², or 75 mm² to 100 mm².

As shown in FIG. 1C, the sensor substrate 106 can have a thickness T, which can be sufficiently small to allow for rapid migration of intraoral fluids into the sensor substrate 106 and/or avoid causing discomfort to the subject, but sufficiently large so that the intraoral sensor 102 has enough mechanical strength to withstand being handled and/or forces in the intraoral cavity (e.g., due to speaking, gargling, bruxism, etc.). For instance, the thickness T can be within a range from 1 μm to 5 μm, 1 μm to 10 μm, 1 μm to 50 μm, 5 μm to 10 μm, 5 μm to 50 μm, 10 μm to 50 μm, 10 μm to 100 μm, 50 μm to 1 mm, 50 μm to 500 μm, 50 μm to 100 μm, or 100 μm to 500 μm. Although the sensor substrate 106 is depicted as having a flat cross-sectional shape with a uniform thickness, in other embodiments, the sensor substrate 106 can have a cross-sectional shape with a variable thickness, such as a convex cross-sectional shape that is thicker in the middle and thinner at the edges, a concave cross-sectional shape that is thinner in the middle and thicker at the edges, etc.

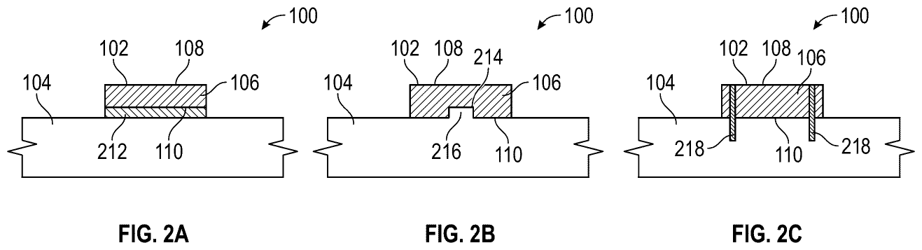

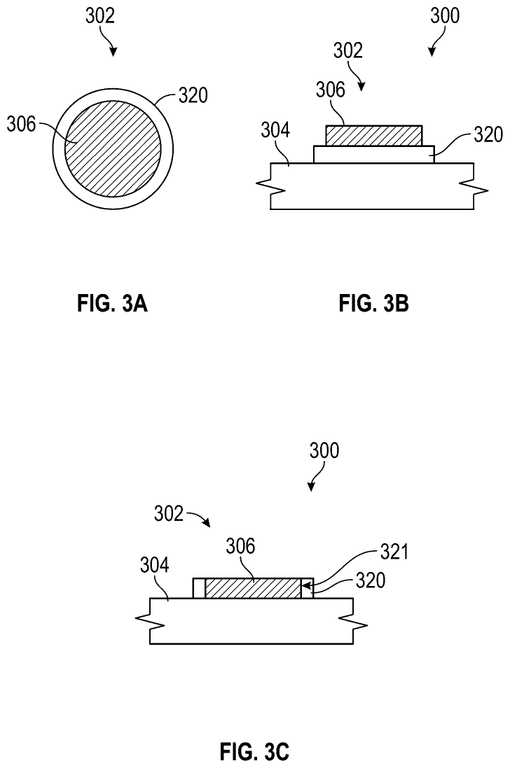

As best seen in FIG. 1C, the sensor substrate 106 can have a first surface 108 (e.g., an upper surface) that is configured to be oriented toward the subject's intraoral cavity to receive the intraoral fluids, and a second surface 110 (e.g., a lower surface) that is configured to be oriented toward and coupled to the appliance 100. The first surface 108 can be completely uncovered (e.g., there is no barrier layer or other material disposed over the first surface 108), and thus can be directly exposed to the intraoral environment when the appliance 100 is worn on the subject's teeth. Alternatively, the intraoral sensor 102 can include a barrier layer covering a portion of the first surface 108 such that only a portion of the first surface 108 is directly exposed to the intraoral environment, or the barrier layer can cover the entirety of the first surface 108 such that the first surface 108 is not directly exposed to the intraoral environment (e.g., as described further below in connection with FIGS. 3A and 3B). In some embodiments, when the intraoral sensor 102 is coupled to the appliance 100, the second surface 110 is in direct contact with the shell 104 of the appliance 100, while in other embodiments, the intraoral sensor 102 can include one or more additional components that are interposed between the second surface 110 and the shell 104 (e.g., an adhesive, as described further below in connection with FIG. 2A).

In some embodiments, the intraoral sensor 102 is a discrete component that is attached to the appliance 100, rather than being integrally formed with the appliance 100. This approach can be advantageous, for example, to allow the location of the intraoral sensor 102 to be customized for the particular subject and/or appliance 100, to allow the intraoral sensor 102 to be easily replaced with another intraoral sensor 102, and/or to allow additional intraoral sensors 102 to be attached to the appliance 100 at various locations. The intraoral sensor 102 can be attached to the appliance 100 at any suitable point in time. For example, the intraoral sensor 102 can be attached to the appliance 100 by a manufacturer before the appliance 100 is delivered to the subject or to a healthcare provider of the subject. As another example, the intraoral sensor 102 can be attached to the appliance 100 by a healthcare provider at any point during treatment. In yet another example, the intraoral sensor 102 can be attached to the appliance 100 by the subject at any point during treatment.

The intraoral sensor 102 can be attached to the appliance 100 using any suitable technique, such as via adhesives (e.g., curable adhesives, pressure-sensitive adhesives, contact adhesives), fasteners (e.g., pins, staples, tacks), mechanical fit (e.g., snap fit, interference fit), or suitable combinations thereof. In some embodiments, the intraoral sensor 102 is directly attached to the appliance 100, while in other embodiments, the intraoral sensor 102 is attached to an intermediary component (e.g., a bracket, base, receptacle, or other mounting structure) via any suitable attachment technique, and the intermediary component is attached to the appliance 100 via any suitable technique or is integrally formed with the appliance 100. Optionally, the intraoral sensor 102 can be coated onto the surface of the appliance 100 by spraying, painting, jetting, extruding, etc.

In some embodiments, the intraoral sensor 102 is a sticker or similar adhesive device that can be applied to the appliance 100 (e.g., to the outer or inner surface of the appliance 100) simply by pressing the intraoral sensor 102 against the appliance 100. In such embodiments, multiple intraoral sensors 102 can be provided as part of a kit (e.g., a sticker pack). A user can apply one or more intraoral sensors 102 from the kit to the appliance 100 for monitoring oral health, tooth decay progression, and/or other oral diseases or conditions as described herein.

FIGS. 2A-2C illustrate representative examples of attachment techniques for coupling the intraoral sensor 102 to the appliance 100, in accordance with embodiments of the present technology. Any of the embodiments of FIGS. 2A-2C can be combined with each other and/or with any of the other attachment techniques described herein.

FIG. 2A is a side cross-sectional view of a portion of an appliance 100 that is coupled to an intraoral sensor 102 via an adhesive 212, in accordance with embodiments of the present technology. As shown in FIG. 2A, the intraoral sensor 102 can be attached to a surface of the appliance 100 (e.g., to a surface of the shell 104) using the adhesive 212. The adhesive 212 can be a curable adhesive, a pressure-sensitive adhesive, a contact adhesive, or any other suitable biocompatible adhesive material. For example, the adhesive 212 can be or include a UV curable adhesive, such as Dymax 1187-M-SV01, Dymax 1040-M, or 3M Transbond Light Cure Adhesive. As another example, the adhesive 212 can be a medical transfer adhesive, such as 3M 1504XL Hi Tack.

As shown in FIG. 2A, the adhesive 212 can be a separate material (e.g., a layer, film, tape) that is interposed between the second surface 110 of the sensor substrate 106 and the surface of the appliance 100. In such embodiments, the adhesive 212 can be part of the intraoral sensor 102 or part of the appliance 100, or can be a separate component that is applied to the intraoral sensor 102 and/or to the appliance 100 before use. Alternatively, the sensor substrate 106 itself can be made out of an adhesive material configured to adhere to the appliance 100, such that the sensor substrate 106 can be directly attached to the surface of the appliance 100, rather than requiring a separate adhesive 212.

The adhesive 212 can be used to attach the intraoral sensor 102 to the appliance 100 in various ways. For example, in embodiments where the adhesive 212 is a curable adhesive, a small amount of the adhesive 212 can be applied to the surface of the appliance 100 at a desired location, the intraoral sensor 102 can be placed onto the adhesive 212, and curing energy (e.g., UV light) can be applied to cure the adhesive 212, thereby attaching the intraoral sensor 102 to the appliance 100. As another example, in embodiments where the adhesive 212 is pressure-sensitive adhesive, a contact adhesive, or other adhesive that bonds to a surface upon direct contact with the surface, the adhesive 212 can be applied to the intraoral sensor 102, and the intraoral sensor 102 can then be placed against the appliance 100 so that the adhesive 212 comes into direct contact with the appliance 100, thereby attaching the intraoral sensor 102 to the appliance 100. In such embodiments, the intraoral sensor 102 can be easily replaced with a new sensor, such as by separating the intraoral sensor 102 from the adhesive 212 and applying a new intraoral sensor 102 to the adhesive 212, or by removing the intraoral sensor 102 and adhesive 212 from the appliance 100 and replacing with a new intraoral sensor 102 and adhesive 212.

FIG. 2B is a side cross-sectional view of a portion of an appliance 100 that is coupled to an intraoral sensor 102 via interlocking features 214, 216, in accordance with embodiments of the present technology. As shown in FIG. 2B, the second surface 110 of the intraoral sensor 102 can include a first feature 214 that mates with a corresponding second feature 216 on the surface of the appliance 100 (e.g., on the surface of the shell 104) to form a snap fit. In the illustrated embodiment, the first feature 214 is a recess (e.g., a groove, indentation, hole) and the second feature 216 is a protrusion (e.g., a ridge, bump, pin) that fits into the recess. In other embodiments, the geometries can be reversed, in that the first feature 214 can be a protrusion and the second feature 216 can be a protrusion. Other types of interlocking elements can alternatively or additionally be used, such as other snap fit elements, interference fit elements, etc. Moreover, although FIG. 2B illustrates a single first feature 214 and a single second feature 216, the intraoral sensor 102 and appliance 100 can each independently include any suitable number of interlocking features.

FIG. 2C is a side cross-sectional view of a portion of an appliance 100 that is coupled to an intraoral sensor 102 via fasteners 218, in accordance with embodiments of the present technology. As shown in FIG. 2C, the fasteners 218 can be pins, staples, tacks, etc., that pass through a portion of the intraoral sensor 102 and through a portion of the appliance 100 (e.g., of the shell 104) to secure the intraoral sensor 102 and appliance 100 to each other. The fasteners 218 can be part of the intraoral sensor 102 or part of the appliance 100, or can be separate components that are coupled to the intraoral sensor 102 and appliance 100. Although FIG. 2C illustrates two fasteners 218, in other embodiments, the intraoral sensor 102 can be attached to the appliance 100 using a different number of fasteners 218, such as one, three, four, five, or more fasteners 218.

FIGS. 3A-7 and the accompanying description provide additional features of intraoral sensors and appliances configured in accordance with embodiments of the present technology. Any of the embodiments described in connection with FIGS. 3A-7 can be combined with each other and/or with the embodiments described in connection with FIGS. 1A-2C. Moreover, the intraoral sensors and appliances described in connection with FIGS. 3A-7 can be generally similar to the intraoral sensor 102 and appliance 100 of FIGS. 1A-2C, such that like numbers (e.g., intraoral sensor 102 versus intraoral sensor 302) are used to identify similar or identical components, and the following discussion of FIGS. 3A-7 will be limited to those features that differ from the embodiments described in connection with FIGS. 1A-2C.

In some embodiments, an intraoral sensor of the present technology is used in combination with at least one color reference marker. A color reference marker can be a component having a fixed color that does not change based on the pH of the subject's intraoral cavity. For example, the color reference marker can be a colored film, membrane, sheet, layer, etc., that is made from a biocompatible material (e.g., a biocompatible polymer) or that is made from a non-biocompatible material that is coated or otherwise covered with a biocompatible material. In some embodiments, the fixed color of the color reference marker is selected to provide a high visual contrast with the color of the intraoral sensor to facilitate detection of the color of the intraoral sensor (e.g., by the naked eye and/or using an optical sensing device). For instance, the color reference marker can be a light and/or neutral color, such as white.

Alternatively or in combination, the fixed color of the color reference marker can be used to account for differences in environmental conditions that may affect the detected color of the intraoral sensor. In some instances, lighting conditions and/or background colors may affect how the color of the intraoral sensor is perceived by the human eye. Lighting conditions and/or background colors may also affect the appearance of the intraoral sensor (e.g., RGB value, color intensity) in images of the intraoral sensor (e.g., photographs). In such embodiments, the fixed color can act as a reference for calibrating or otherwise adjusting the detected color of the intraoral sensor to account for variations that are due to environment conditions rather than pH, as discussed further below.

The color reference marker can be part of the intraoral sensor. For instance, the color reference marker can be positioned around the sensor substrate of the intraoral sensor, adjacent to one or more sides of the sensor substrate, underneath the sensor substrate, or any other suitable location. The color reference marker can be integrally formed with the sensor substrate (e.g., part of the same film as the sensor substrate), or can be a separate component that is coupled to the sensor substrate (e.g., a different film, membrane, layer, etc., than the sensor substrate). Alternatively, the color reference marker can be separate from the intraoral sensor and can be placed on the dental appliance proximate to the intraoral sensor, e.g., on the same side of the dental appliance as the intraoral sensor. The color reference marker can have any suitable shape, such as a circular shape, an oval shape, square shape, rectangular shape, diamond shape, triangular shape, cross shape, star shape, annular shape, etc.

For example, FIG. 3A is a top view of an intraoral sensor 302 including a sensor substrate 306 and a color reference marker 320, and FIG. 3B is a side cross-sectional view of a portion of a dental appliance 300 including the intraoral sensor 302, in accordance with embodiments of the present technology. Referring to FIGS. 3A and 3B together, the color reference marker 320 can be a film, membrane, sheet, etc., that is positioned below the sensor substrate 306, and is interposed between the sensor substrate 306 and the surface of the appliance 300 (e.g., the surface of the polymeric shell 304 of the appliance 300). The color reference marker 320 can be larger than the sensor substrate 306 such that the edges of the color reference marker 320 extend past the edges of the sensor substrate 306. In the illustrated embodiment, for example, the sensor substrate 306 has a circular shape with a first diameter, and the color reference marker 320 has a circular shape with a second, larger diameter such that the color reference marker 320 forms the periphery of the intraoral sensor 302. The sensor substrate 306 and color reference marker 320 can have the same thickness or can have different thicknesses (e.g., the sensor substrate 306 can be thicker than the color reference marker 320, or vice-versa).

FIG. 3C is a side-cross sectional view of a portion of a dental appliance 300 showing another configuration for the intraoral sensor 302, in accordance with embodiments of the present technology. In the embodiment of FIG. 3C, the color reference marker 320 has an annular shape with a central hole 321, and the sensor substrate 306 is positioned within the hole 321, such that the sensor substrate 306 is surrounded by the color reference marker 320. Accordingly, the sensor substrate 306 and the color reference marker 320 can be part of the same layer of the intraoral sensor 302, rather than being arranged in different layers. The sensor substrate 306 and color reference marker 320 can have the same thickness or can have different thicknesses (e.g., the sensor substrate 306 can be thicker than the color reference marker 320, or vice-versa).

The sensor substrate 306 and color reference marker 320 of FIGS. 3A-3C can be coupled to each other and/or to the appliance 300 using any of the attachment techniques described herein. For instance, the intraoral sensor 302 can include an adhesive between one or more portions of the sensor substrate 306 and the color reference marker 320 to attach these components to each other. In some embodiments, the sensor substrate 306 and color reference marker 320 are attached to each other to form the intraoral sensor 302, and the intraoral sensor 302 is then attached to the appliance 300 as a unitary component. Alternatively, the intraoral sensor 302 can be assembled in situ on the appliance 300, e.g., the color reference marker 320 can be attached to the appliance 300 before the sensor substrate 306 is attached, or vice-versa.

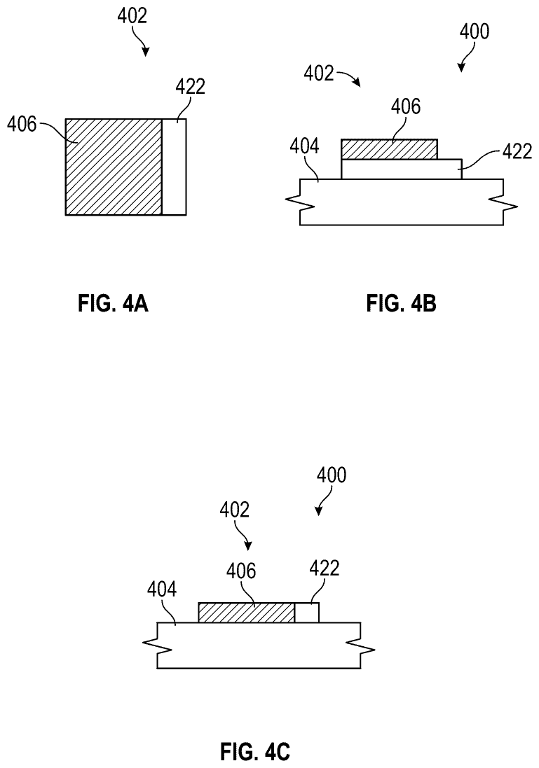

FIG. 4A is a top view of an intraoral sensor 402 including a sensor substrate 406 and a color reference marker 422, and FIG. 4B is a side cross-sectional view of a portion of a dental appliance 400 including the intraoral sensor 402, in accordance with embodiments of the present technology. Referring to FIGS. 4A and 4B together, the color reference marker 422 can be a film, membrane, sheet, etc., that is positioned below the sensor substrate 406, and is interposed between the sensor substrate 406 and the surface of the appliance 400 (e.g., the surface of the polymeric shell 404 of the appliance 400). The color reference marker 422 can be larger than the sensor substrate 406 such that at least one edge of the color reference marker 422 extends past the a corresponding edge of the sensor substrate 406 In the illustrated embodiment, for example, the sensor substrate 406 has a square shape with a first surface area, and the color reference marker 422 has a rectangular shape with a second, larger surface area such that the color reference marker 422 forms one side of the intraoral sensor 402. The sensor substrate 406 and color reference marker 422 can have the same thickness or can have different thicknesses (e.g., the sensor substrate 406 can be thicker than the color reference marker 422, or vice-versa).

FIG. 4C is a side-cross sectional view of a portion of a dental appliance 400 showing another configuration for the color reference marker 422 of the intraoral sensor 402, in accordance with embodiments of the present technology. In the embodiment of FIG. 4C, the color reference marker 422 is a rectangular strip positioned at one side of the sensor substrate 406. Accordingly, the sensor substrate 406 and the color reference marker 422 can be part of the same layer of the intraoral sensor 402, rather than being arranged in different layers. The sensor substrate 406 and color reference marker 422 can have the same thickness or can have different thicknesses (e.g., the sensor substrate 406 can be thicker than the color reference marker 422, or vice-versa).

The sensor substrate 406 and color reference marker 422 of FIGS. 4A-4C can be coupled to each other and/or to the appliance 400 using any of the attachment techniques described herein. For instance, the intraoral sensor 402 can include an adhesive between one or more portions of the sensor substrate 406 and the color reference marker 422 to attach these components to each other. In some embodiments, the sensor substrate 406 and color reference marker 422 are attached to each other to form the intraoral sensor 402, and the intraoral sensor 402 is then attached to the appliance 400 as a unitary component. Alternatively, the intraoral sensor 402 can be assembled in situ on the appliance 400, e.g., the color reference marker 422 can be attached to the appliance 400 before the sensor substrate 406 is attached, or vice-versa.

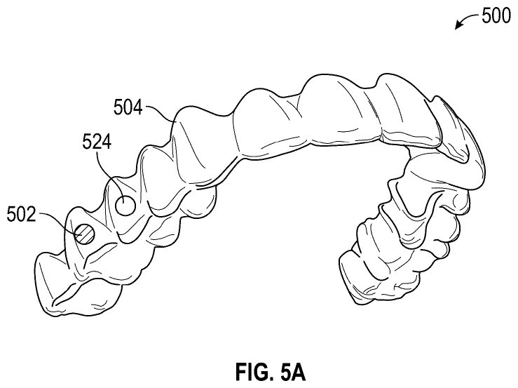

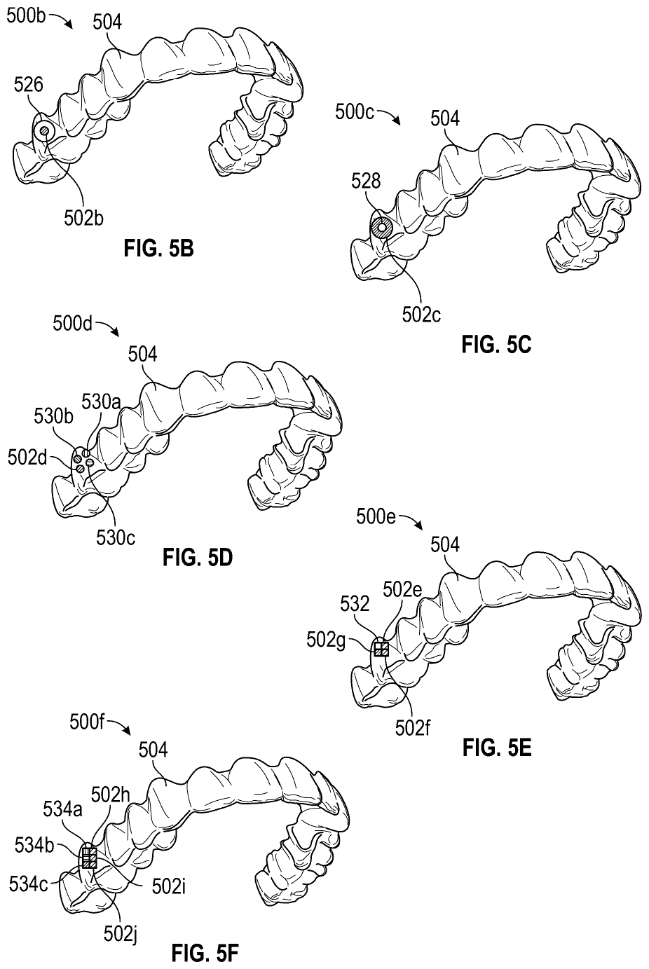

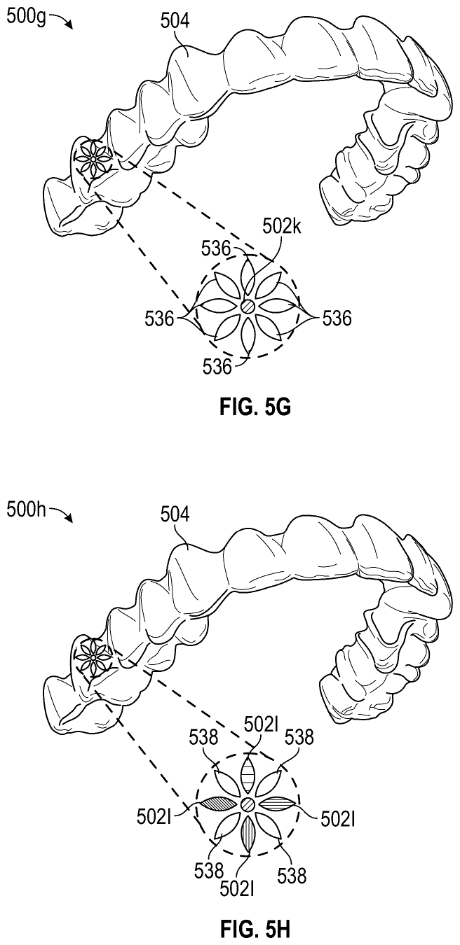

FIGS. 5A-5H illustrate dental appliances with various configurations of intraoral sensors and color reference markers, in accordance with embodiments of the present technology. Any of the features of the embodiments of FIGS. 5A-5H can be combined with each other and/or with any of the other embodiments of intraoral sensors described herein.

FIG. 5A is a perspective view of a dental appliance 500a including an intraoral sensor 502a and a separate color reference marker 524, in accordance with embodiments of the present technology. The intraoral sensor 502a and the color reference marker 524 can be positioned sufficiently close to each other so these components are exposed to the same lighting conditions and/or can be captured in the same field of view of an optical sensing device. In the illustrated embodiment, the intraoral sensor 502a and the color reference marker 524 are coupled to the same surface of the appliance 500a (e.g., the buccal surface) on adjacent tooth-receiving cavities of the shell 504. In other embodiments, however, the intraoral sensor 502a and the color reference marker 524 can be located on the same tooth-receiving cavity or can be located on non-adjacent tooth-receiving cavities. Moreover, although FIG. 5A shows a single color reference marker 524, the appliance 500a can include any suitable number of color reference markers 524 (e.g., two, three, four, five, or more color reference markers 524), each of which can be independently located at any suitable position on the appliance 500a relative to the intraoral sensor 502a.

FIG. 5B is a perspective view of a dental appliance 500b including an intraoral sensor 502b and a color reference marker 526 that are concentric with each other, in accordance with embodiments of the present technology. In the illustrated embodiment, the color reference marker 526 surrounds and/or overlaps the intraoral sensor 502b, e.g., similar to the embodiment of FIGS. 3A-3C. The intraoral sensor 502b may be positioned in the center of the color reference marker 526 or may be slightly offset from the center. The configuration of the intraoral sensor 502b and the color reference marker 526 may be advantageous for distinguishing and segmenting the intraoral sensor 502b and color reference marker 526 from each other in image data, since these two components have different shapes (e.g., the intraoral sensor 502b is circular while the color reference marker 526 is annular).

FIG. 5C is a perspective view of a dental appliance 500c including an intraoral sensor 502c and a color reference marker 528 that are concentric with each other, in accordance with embodiments of the present technology. In the illustrated embodiment, the intraoral sensor 502c surrounds and/or overlaps the color reference marker 528, e.g., the reverse of the arrangement shown in FIG. 5B. The color reference marker 528 may be positioned in the center of the intraoral sensor 502c or may be slightly offset from the center. The configuration of the intraoral sensor 502c and the color reference marker 528 may be advantageous for distinguishing and segmenting the intraoral sensor 502c and color reference marker 527 from each other in image data, since these two components have different shapes (e.g., the intraoral sensor 502c is annular while the color reference marker 528 is circular).

FIG. 5D is a perspective view of a dental appliance 500d including an intraoral sensor 502d and a plurality of color reference markers 530a-530c, in accordance with embodiments of the present technology. The intraoral sensor 502a and the color reference markers 530a-530c can be positioned sufficiently close to each other so these components are exposed to the same lighting conditions and/or can be captured in the same field of view of an optical sensing device. Some or all of the color reference markers 530a-530c can have different colors, which may provide more precise color correction for the intraoral sensor 502d. Alternatively or in combination, some or all of the color reference markers 530a-530c can have the same color, which may provide redundancy for more consistent color correction. Although FIG. 5D depicts three color reference markers 530a-530c, in other embodiments the dental appliance 500d can include a different number of color reference markers, such as two, four, five, or more color reference markers. Moreover, although the intraoral sensor 502d and the color reference markers 530a-530c are depicted as being in a diamond or square arrangement, other types of arrangements can also be used, such as a linear arrangement, circular arrangement, triangular arrangement, etc.

FIG. 5E is a perspective view of a dental appliance 500e including a plurality of intraoral sensors 502e-502g and a color reference marker 532, in accordance with embodiments of the present technology. The intraoral sensors 502e-502g and the color reference marker 532 can be positioned sufficiently close to each other so these components are exposed to the same lighting conditions and/or can be captured in the same field of view of an optical sensing device. Some or all of the intraoral sensors 502e-502g can include different pH-sensitive molecules for detection of different pH ranges, which may provide a larger range of pH sensing. Alternatively or in combination, some or all of the intraoral sensors 502e-502g can include the same pH-sensitive molecular, which may improve measurement reliability by reducing sensor variation and enhancing consistency. Moreover, the use of multiple intraoral sensors 502e-502g at different locations can diminish the dependency on specific locations and allow for the measurement of overall pH in the mouth. Although FIG. 5E depicts three intraoral sensors 502e-502g, in other embodiments the dental appliance 500e can include a different number of intraoral sensors, such as two, four, five, or more intraoral sensors. Moreover, although the intraoral sensors 502e-502g and the color reference marker 532 are depicted as being adjacent to each other in a square grid arrangement, in other embodiments, the intraoral sensors 502e-502g and the color reference marker 532 may be separated by gaps and/or may be positioned in a different arrangement (e.g., a linear grid arrangement, a circular arrangement, a triangular arrangement).

FIG. 5F is a perspective view of a dental appliance 500f including a plurality of intraoral sensors 502h-502j and a plurality of color reference markers 534a-534c, in accordance with embodiments of the present technology. The intraoral sensors 502h-502j and the color reference markers 534a-534c can be positioned sufficiently close to each other so these components are exposed to the same lighting conditions and/or can be captured in the same field of view of an optical sensing device. Some or all of the intraoral sensors 502h-502j can include different pH-sensitive molecules for detection of different pH ranges, and/or some or all of the intraoral sensors 502h-502j can include the same pH-sensitive molecular. Similarly, some or all of the color reference markers 534a-534c can have different colors, and/or some or all of the color reference markers 534a-534c can have the same color. Although FIG. 5F depicts three intraoral sensors 502h-502j and three color reference markers 534a-534c, in other embodiments the dental appliance 500f can include a different number of intraoral sensors and/or a different number of color reference markers. Moreover, although the intraoral sensors 502h-502j and the color reference markers 534a-534c are depicted as being adjacent to each other in a rectangular grid arrangement, in other embodiments, the intraoral sensors 502h-502j and the color reference markers 534a-534c may be separated by gaps and/or may be positioned in a different arrangement (e.g., a linear grid arrangement, a circular arrangement, a triangular arrangement).

FIG. 5G is a perspective view of a dental appliance 500g including an intraoral sensor 502k and a plurality of color reference markers 536 arranged in an ornamental design, in accordance with embodiments of the present technology. In the illustrated embodiment, the ornamental design is a flower shape, with the intraoral sensor 502k serving as the center of the flower and the color reference markers 536 serving as the petals of the flower.

FIG. 5H is a perspective view of a dental appliance 500h including a plurality of intraoral sensors 502l and a plurality of color reference markers 538 arranged in an ornamental design, in accordance with embodiments of the present technology. In the illustrated embodiment, the ornamental design is a flower shape, with the intraoral sensors 502l serving as the center of the and the petals of the flower, and the color reference markers 538 serving as the remaining petals of the flower.

Although FIGS. 5G and 5H illustrate dental appliances with a flower-shaped ornamental design, it will be appreciated that any desired ornamental design can be created using one or more intraoral sensors and one or more color reference markers, such as symbols, logos, text, pictures, etc. The ornamental design may be a preset design or may be customized for the particular subject, e.g., the subject may choose the shape and/or colors for the ornamental design.

In some embodiments, the sensor substrate of an intraoral sensor is directly exposed to the intraoral environment, e.g., intraoral fluids within the subject's mouth can directly contact the sensor substrate without having to pass through any other materials. In other embodiments, however, the sensor substrate can be partially or completely covered by a barrier layer. The barrier layer can be a film, membrane, or other covering that is positioned over at least one surface of the sensor substrate to separate the sensor substrate from the intraoral environment. For instance, the barrier layer can cover a portion of or the entirety of the upper surface of the sensor substrate that faces away from the dental appliance. The barrier layer can serve various functions in the intraoral sensor. For example, the barrier layer can protect the sensor substrate from mechanical forces that might damage the sensor substrate and/or cause the sensor substrate to detach from the dental appliance. Alternatively or in combination, the barrier layer can control the transport of chemical species into the sensor substrate and/or out from the sensor substrate (e.g., the barrier layer can be a mesh or other porous structure including openings sized to permit diffusion of chemical species into and/or out from the sensor substrate). The barrier layer can be made from a biocompatible material (e.g., a biocompatible polymer) that provides the desired mechanical properties and/or transport control properties. The barrier layer can be made of a material that is transparent or at least translucent to allow the color of the sensor substrate to be detected through the barrier layer. In some embodiments, for example, the barrier layer is composed of a thin, transparent polymer material including a plurality of pores to allow for diffusion of selected chemical species through the barrier layer. The barrier layer can have any suitable shape to conform to the shape of the underlying sensor substrate, depending on the extent of coverage desired. For instance, the barrier layer can have a circular shape, an oval shape, square shape, rectangular shape, diamond shape, triangular shape, cross shape, star shape, annular shape, etc.

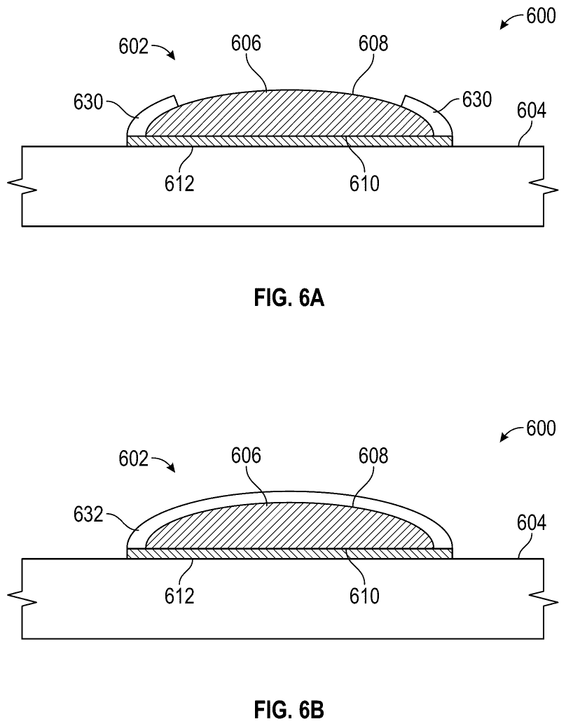

FIG. 6A is a side cross-sectional view of a portion of a dental appliance 600 including an intraoral sensor 602 with a barrier layer 630, in accordance with embodiments of the present technology. The barrier layer 630 can be coupled to the first surface 608 of the sensor substrate 606 using any of the attachment techniques described herein (e.g., adhesives, fasteners, mechanical fit). In the illustrated embodiment, the barrier layer 630 is an annular-shaped structure (e.g., an O-ring) that covers the edges of the of the sensor substrate 606 but leaves the central portion of the sensor substrate 606 exposed. The barrier layer 630 can protect the edges of the sensor substrate 606 from forces that might otherwise cause the sensor substrate 606 to detach from the appliance 600. The barrier layer 630 may permit diffusion of intraoral fluids into the sensor substrate 606 or may be impermeable to intraoral fluids, as desired. The sensor substrate 606 and barrier layer 630 can be attached to the surface of the underlying appliance 600 (e.g., to the polymeric shell 604 of the appliance 600) using any suitable attachment technique, such as via an adhesive 612. Optionally, the intraoral sensor 602 can also include a color reference marker (not shown), which can be positioned below the sensor substrate 606 and barrier layer 630, and above the adhesive 612.

FIG. 6B is a side cross-sectional view of a portion of a dental appliance 600 including an intraoral sensor 602 with a barrier layer 632, in accordance with embodiments of the present technology. The barrier layer 630 can be coupled to the first surface 608 of the sensor substrate 606 using any of the attachment techniques described herein (e.g., adhesives, fasteners, mechanical fit). In the illustrated embodiment, the barrier layer 632 is a circular-shaped structure (e.g., a circular film, membrane, sheet) that covers the entire first surface 608 of the sensor substrate 606. The barrier layer 632 can protect the first surface 608 of the sensor substrate 606 from forces that might damage and/or detach the sensor substrate 606. Alternatively or in combination, the barrier layer 632 can be used to control diffusion of chemical species into and/or out of the sensor substrate 606. For instance, the barrier layer 632 can be permeable to intraoral fluids, but can prevent the pH-sensitive molecule of the sensor substrate 606 from diffusing out of the sensor substrate 606. This approach can be used, for example, in embodiments where the pH-sensitive molecule is not covalently conjugated to the material of the sensor substrate 606 and thus may migrate out of the sensor substrate 606 in the absence of the barrier layer 632. The sensor substrate 606 and barrier layer 632 can be attached to the surface of the underlying appliance 600 (e.g., to the polymeric shell 604 of the appliance 600) using any suitable attachment technique, such as via an adhesive 612. Optionally, the intraoral sensor 602 can also include a color reference marker (not shown), which can be positioned below the sensor substrate 606 and barrier layer 632, and above the adhesive 612.

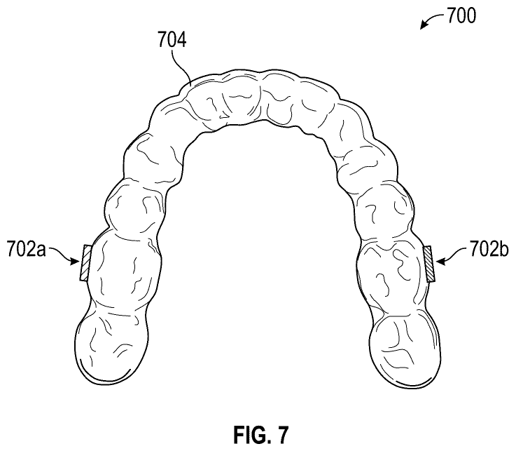

FIG. 7 is a top view of a dental appliance 700 including a plurality of intraoral sensors 702a, 702b, in accordance with embodiments of the present technology. The appliance 700 can include at least a first intraoral sensor 702a and a second intraoral sensor 702b. In some embodiments, the first intraoral sensor 702a is the same as the second intraoral sensor 702b (e.g., includes the same pH-sensitive molecule(s), changes in color over the same pH range, and has the same shape). In such embodiments, the second intraoral sensor 702b may be used to provide additional pH measurements of the same portion or a different portion of the subject's intraoral cavity to improve measurement accuracy. Alternatively, the second intraoral sensor 702b can be different than the first intraoral sensor 702a (e.g., can include a different pH-sensitive molecule, change in color over a different pH range, and/or have a different shape). In such embodiments, the second intraoral sensor 702b may be used to monitor the subject for a different oral disease or condition than the first intraoral sensor 702a, and/or may be used to extend the range of detectable pH values.

In the illustrated embodiment, the first intraoral sensor 702a and the second intraoral sensor 702b are located at opposite sides (e.g., left and right sides) of the dental appliance 700. In other embodiments, the first intraoral sensor 702a and the second intraoral sensor 702b can be located at the same side of the appliance 700, e.g., on the same tooth-receiving cavity of the shell 704 of the appliance 700 or on different tooth-receiving cavities. Moreover, although FIG. 7 depicts the first intraoral sensor 702a and the second intraoral sensor 702b as both being located on a buccal surface of the appliance 700, in other embodiments, the first intraoral sensor 702a and/or the second intraoral sensor 702b can be located on any other surface of the appliance 700, such as a lingual surface, an exterior surface, an interior surface, etc. Optionally, the appliance 700 can include three, four, five, or more intraoral sensors, each of which can be independently located at any suitable position on the appliance 700. In some embodiments, multiple intraoral sensors are independently located at different positions to allow for more localized monitoring (e.g., localized pH monitoring). For example, referencing FIG. 7, the pH measured by the first intraoral sensor 702a and the second intraoral sensor 702b may be the respective local pH. This configuration may be advantageous in that it provides more granular data. For example, a pH outside the range of a normal oral health state at the first intraoral sensor 702a but a pH within a normal range at the second intraoral sensor 702b may allow for a determination that there is a potential problem with teeth near the first intraoral sensor 702a. Consequently, additional attention (e.g., treatment, additional care in brushing) may be paid to those teeth.

Although FIG. 7 depicts the intraoral sensors 702a, 702b as being located on the exterior surface of the appliance 700, in other embodiments, one or both of the intraoral sensors 702a, 702b can instead be located on the interior surface of the appliance 700 (e.g., within one or more tooth-receiving cavities of the appliance 700). In such embodiments, the interior surface of the appliance 700 can include a recessed portion to receive the intraoral sensor therein, such that when the appliance 700 is worn, the intraoral sensor is placed proximate to (e.g., in direct contact with) one or more teeth. Intraoral sensors mounted within the interior of the appliance 700 can be used to measure pH values at or near the surfaces of the subject's teeth, thereby allowing for monitoring of pH conditions of particular teeth (e.g., for detection of dental caries, demineralization, and/or other dental diseases or conditions).

Although the embodiments of FIGS. 1A-7 are described herein with respect to intraoral sensors that are coupled to dental appliances, in other embodiments, an intraoral sensor of the present technology can instead be coupled to a tooth of the subject (e.g., a molar, premolar, canine, or incisor) or to the subject's gingiva. In such embodiments, the subject may or may not be concurrently treated using one or more dental appliances. The use of a tooth-mounted or gingiva-mounted intraoral sensor may be advantageous, for example, if the subject is not currently receiving appliance-based therapy, if the dental appliances that are being used are not capable of accommodating an intraoral sensor at the desired location in the subject's mouth, and/or if it is otherwise desirable to provide intraoral monitoring independently of any dental appliances.

In some embodiments, a tooth-mounted or gingiva-mounted intraoral sensor is provided in the form of a sticker or similar adhesive device that can be applied directly to a tooth or gingiva simply by pressing the sensor against the tooth or gingiva. In such embodiments, multiple intraoral sensors can be provided as part of a kit (e.g., a sticker pack). A user can apply one or more intraoral sensors of the kit to one or more locations on the teeth and/or gingiva for monitoring oral health, tooth decay progression, and/or other oral diseases or conditions as described herein.

In embodiments where the intraoral sensor is a tooth-mounted sensor, the intraoral sensor can be positioned at any suitable location on the tooth, such as a buccal surface or lingual surface of a tooth. The intraoral sensor can be coupled to the tooth using any suitable attachment technique. For example, the intraoral sensor can be attached to the tooth via a curable adhesive (e.g., a UV-curable adhesive). As another example, the intraoral sensor can be coupled to or integrally formed with another device that is mounted to the subject's tooth, such as a ring or band that extends around one or more teeth, a cap that fits over a crown of one or more teeth, etc.

A tooth-mounted or gingiva-mounted intraoral sensor can be imaged directly while on the tooth or gingiva. Imaging can be performed using a mobile device (e.g., a smartphone), which may be used alone or coupled to a retractor that retracts the patient's lips and/or cheeks to facilitate imaging. Examples of imaging apparatuses that may be used with the present technology are provided in U.S. Patent Publication No. 2022/0338723, the disclosure of which is incorporated by reference herein in its entirety. Alternatively, the user can remove the intraoral sensor from the tooth or gingiva before imaging the intraoral sensor. Additional details and examples of systems and devices for imaging an intraoral sensor are provided in, e.g., Section I.C below.

### B. Compositions for Intraoral Sensing and Associated Methods

The intraoral sensors of the present technology can include at least one pH-sensitive molecule that exhibits a color change in response to changes in the pH of the intraoral cavity. The pH-sensitive molecule can be a dye, pigment, or other colored compound that includes at least one chromophore. The chromophore can be a halochromic moiety that exhibits a reversible color change in response to a change in pH. The pH-sensitive molecule can be a synthetic molecule, or can be a naturally occurring molecule (e.g., an anthocyanin) or a derivative thereof. Examples of pH-sensitive molecules include alizarin red S, alizarin yellow R, anthocyanins and derivatives thereof (e.g., a cyanidin such as cyanidin 3-glucoside, a delphinidin such as delphinidin 3-glucoside, a malvidin such as malvidin 3-glucoside, a pelargonidin such as pelargonidin 3-glucoside, a pconidin such as peonidin 3-glucoside, a petunidin such as petunidin 3-glucoside), bromocresol green, bromocresol purple, bromophenol blue, bromothymol blue, chlorophenol red, congo red, cresolphthalein, cresol purple, cresol red, dichlorofluorescein, gentian violet, indigo carmine, litmus, malachite green, methyl orange, methyl red, methyl yellow, naphtholphthalein, neutral red, phenol red, phenolphthalein, thymol blue, thymolphthalein, and xylene cyanol, as well as other pH indicators known to those of skill in the art.

In some embodiments, the intraoral sensors herein include a pH-sensitive molecule that exhibits a color change at a transition pH value and/or over a transition pH range. The transition pH value can be 0.5, 1, 1.5, 2, 2.5, 3, 3.5, 4, 4.5, 5, 5.2, 5.4, 5.5, 5.6, 5.8, 6, 6.2, 6.4, 6.5, 6.6, 6.8, 7, 7.2, 7.4, 7.5, 7.6, 7.8, 8, 8.5, 9, 9.5, 10, 10.5, 11, 11.5, 12, 12.5, 13, 13.5, or 14. In some embodiments, the pH-sensitive molecule exhibits a first color when the pH is greater than or equal to the transition pH value, and a second, different color when the pH is less than the transition pH value. The transition pH range can be from 0 to 2, 2 to 4, 2 to 5, 2 to 6, 3 to 5, 3 to 6, 3 to 7, 4 to 6, 4 to 7, 4 to 8, 4 to 9, 5 to 7, 5 to 8, 5 to 9, 5.5 to 7.5, 6 to 7, 6 to 8, 6 to 9, 6 to 10, 6.5 to 7.5, 7 to 7.5, 7 to 8, 7 to 9, 7 to 10, 8 to 10, 8 to 11, 8 to 12, 9 to 11, 9 to 12, 9 to 13, 10 to 12, 10 to 13, 10 to 14, 11 to 13, 11 to 14, or 12 to 14. In some embodiments, the pH-sensitive molecule exhibits a first color when the pH is greater than or equal to the upper bound of the transition pH range, and a second, different color when the pH is less than or equal to the lower bound of the transition pH value. The pH-sensitive molecule can exhibit an intermediate color (e.g., a blend of the first and second colors) when the pH is within the transition pH range.

In some embodiments, the pH-sensitive molecule is a compound having a transition pH value of 5.5 and/or a transition pH range from 5 to 7, such as chlorophenol red, methyl red, bromocresol purple, or an anthocyanin (e.g., pelargonidin 3-glucoside, peonidin 3-glucoside, malvidin 3-glucoside). This transition pH value and range can be used for example, to detect oral diseases or conditions associated with bacteria that proliferate under acidic conditions, such as dental decay, halitosis, and/or periodontitis.

In some embodiments, an intraoral sensor includes a single type of pH-sensitive molecule. In other embodiments, an intraoral sensor can include a plurality of different types of pH-sensitive molecules, such as two, three, four, five, or more different types of pH-sensitive molecules. Different pH-sensitive molecules can differ from each other with respect to color, transition pH value and/or transition pH range, reaction speed, reaction kinetics, sensitivity, stability, etc. For instance, the intraoral sensor can include a plurality of sensor substrates that each include a different respective pH molecule and thus are responsive to different pH conditions, such as a first sensor substrate including a first pH-sensitive molecule, a second sensor substrate including a second pH-sensitive molecule, etc. The multiple sensor substrates can be positioned proximate to each other in any suitable arrangement, such as a line, grid, array, circle, etc.

Alternatively or in combination, a single sensor substrate of an intraoral sensor can include two or more pH-sensitive molecules that are combined with each other to provide a more complex pH response profile (e.g., the sensor substrate can have multiple pH transition values and/or ranges). In some instances, the use of multiple pH-sensitive molecules can extend the detection range and/or increase the detection resolution of the intraoral sensor. For instance, an intraoral sensor can include a first pH-sensitive molecule having a first transition pH value and/or transition pH range, a second pH-sensitive molecule having a second transition pH value and/or range that is different (e.g., higher or lower) than the first transition pH value and/or transition range, and so on. As an illustrative example, a first pH-sensitive molecule can have a transition pH range from 3 to 5, and a pH-sensitive molecule can have a transition pH range from 5 to 7. The first and second pH-sensitive molecules can be blended to produce a combined pH range from 3 to 5. The blend may have a unique color profile, where particular pH values correspond to particular colors and/or shades for the blend. The color profile of the blend may be determined experimentally. In some embodiments, a calibration step may be performed for each intraoral sensor to increase accuracy of the pH measurement.

Optionally, the intraoral sensor can include an additive that enhances the color and/or stability of a pH-sensitive molecule. For instance, the brightness and color stability of an anthocyanin can be enhanced via copigmentation with other chemicals. Examples of additives that can be used include acetic acid, alginate, caffeic acid, catechin, ferulic acid, gallic acid, gum arabic, maltodextrin, pectin, phenolic, proteins, rutin, and combinations thereof.

The pH-sensitive molecule(s) can be combined with at least one biocompatible material to form a sensor substrate, which can be a film, membrane, sheet, tape, or other component that provides the colorimetric properties of the intraoral sensor as described herein. A biocompatible material can be a material that is (along with any metabolites or degradation products thereof) generally non-toxic to the subject, does not cause any significant adverse effects to the subject, and/or does not elicit a significant inflammatory or immune response when administered to a subject. For example, the biocompatible material can be a biocompatible polymer, such as a synthetic polymer or a naturally occurring polymer. Examples of biocompatible polymers include agarose, cellulose and derivatives thereof (e.g., carboxymethyl cellulose, hydroxyethyl cellulose), chitosan, gelatin, pectin, poly(2-hydroxyethyl methacrylate) (pHEMA), polyacrylamide, polyurethane, poly(vinyl alcohol) (PVA), poly(ethylene glycol) (PEG), polystyrene, polyvinylpyrrolidone (PVP), poly(lactic-co-glycolic acid) (PLGA), starch, and combinations (e.g., copolymers, mixtures) thereof. In some embodiments, the intraoral sensor includes a single biocompatible polymer, while in other embodiments, the intraoral sensor can include a combination of two or more different biocompatible polymers. The pH-sensitive molecule can interact with the biocompatible polymer(s) via covalent bonding, non-covalent bonding (e.g., ionic bonding, hydrogen bonding, hydrophobic interactions, Van der Waals interactions), physical entrapment within a polymer network formed by the biocompatible polymer(s), or suitable combinations thereof.

In some embodiments, the pH-sensitive molecule is covalently conjugated to the biocompatible polymer. Covalent conjugation can improve the stability of the pH-sensitive molecule and produce faster responses to changes in pH. The pH-sensitive molecule can include a first reactive group that forms a covalent bond with a second reactive group of the biocompatible polymer. Optionally, the pH-sensitive molecule can be activated with another chemical to form a reactive intermediate having a first reactive group that forms a covalent bond with the second reactive group of the biocompatible polymer, and/or the biocompatible polymer can be activated with another chemical to form a reactive intermediate having a second reactive group that forms a covalent bond with the first reactive group of the pH-sensitive molecule or the reactive intermediate thereof. Examples of reactive groups that can be used for the first and/or second reactive groups include acrylates, aldehydes, ally ethers, amines, epoxides, hydroxyls, methacrylates, and thiols.

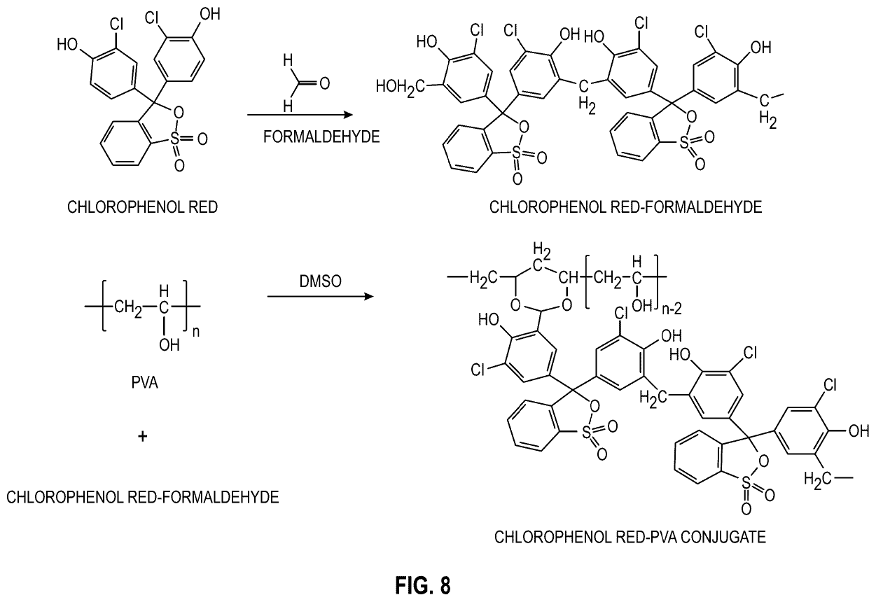

FIG. 8 illustrates a reaction scheme for preparing a chlorophenol red-PVA conjugate, in accordance with embodiments of the present technology. As shown in FIG. 8, chlorophenol red includes phenol groups that can be activated using formaldehyde to form a chlorophenol red-formaldehyde conjugate. The formaldehyde groups in the chlorophenol red-formaldehyde conjugate can subsequently react with the hydroxyl groups of PVA to form covalent linkages, thereby producing a chlorophenol red-PVA conjugate.

In some embodiments, the sensor substrate is prepared from a composition including at least one pH-sensitive molecule and at least one biocompatible polymer (e.g., a composition in which the pH-sensitive molecule is covalently conjugated to the biocompatible polymer). The sensor substrate can be prepared from the composition using any suitable technique, such as casting, dip coating, spraying coating, fabrication on a porous medium (e.g., filter paper), or combinations thereof. In some embodiments, for example, the sensor substrate is formed by a casting process using a mold having a size and shape corresponding to the desired size and shape of the sensor substrate. The mold can optionally be coupled to a fabrication substrate that serves as the bottom wall of the mold. The composition can be deposited into the mold in a liquid form and dried (e.g., at 120° C. for 10 to 12 hours) to form a film. Optionally, before use, the film can be immersed in a solution (e.g., 0.1 M NaOH) for a sufficiently long incubation period (e.g., at least 1.5 hours) to leach out undesired components (e.g., pH-sensitive molecules and/or reactive intermediates thereof that have not been conjugated to the biocompatible polymer). In such embodiments, the film can subsequently be removed from the mold, washed, and dried before use. The fabrication conditions (e.g., characteristics of the materials used for the mold and/or fabrication substrate, drying temperature, drying time, solution used in the leach step, and/or incubation time in the leach solution) can be used to control the final properties of the sensor substrate (e.g., film thickness, homogeneity), which in turn may affect the color intensity and/or response time of the sensor substrate to changes in pH. For instance, the fabrication substrate can be made out of a hydrophobic polymer having a low surface roughness, such as polyether ether ketone (PEEK).

In some embodiments, the biocompatible polymer (e.g., PVA) may be crosslinked or otherwise combined with other agents to further enhance durability and reduce water solubility of the sensor substrate. In some embodiments, polymers other than PVA, such as agarose, cellulose and derivatives thereof (e.g., carboxymethyl cellulose, hydroxyethyl cellulose), chitosan, gelatin, pectin, pHEMA, polyacrylamide, polyurethane, PEG, polystyrene, PVP, PLGA, starch, and combinations (e.g., copolymers, mixtures) thereof may be used, e.g., at least in part to further reduce water solubility and enhance durability.

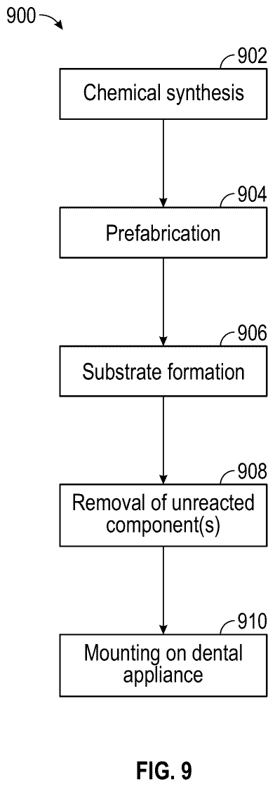

FIG. 9 illustrates a process 900 for preparing a dental appliance with an intraoral sensor, in accordance with embodiments of the present technology. The process 900 can be used to fabricate any of the intraoral sensors described herein. The process 900 can begin at block 902 with chemical synthesis of a formulation including a pH-sensitive molecule. The formulation can be a pH-sensitive molecule-polymer conjugate, as described elsewhere herein. In such embodiments, the chemical synthesis can include preparing a pH-sensitive molecule with a first reactive group (“reactive intermediate”). For example, chlorophenol red can be activated with formaldehyde, as discussed elsewhere herein. Optionally, the reactive intermediate can be isolated via precipitation, phase separation, distillation, rotary evaporation, etc. Subsequently, the reactive intermediate with a biocompatible polymer having a second reactive group, thereby conjugating the pH-sensitive molecule to the biocompatible polymer. For example, PVA can be dissolved in a solvent (e.g., DMSO) and mixed with a chlorophenol red-formaldehyde conjugate to produce a chlorophenol red-PVA conjugate, as described elsewhere herein.

At block 904, the process 900 can optionally include a prefabrication step in preparation for forming a sensor substrate of the intraoral sensor. In some embodiments, for example, the sensor substrate is formed by a casting process with a mold having a size and shape corresponding to the desired size and shape of the sensor substrate (e.g., a single cylinder or an array of cylinders). In such embodiments, the prefabrication step can include preparing the mold for the sensor substrate, e.g., by washing and drying the mold. Optionally the mold can be coupled to a fabrication substrate that serves as the bottom wall of the mold. The fabrication substrate may be composed of a hydrophobic material (e.g., polyetheretherketone (PEEK), polyimide (PI), fluorinated ethylene propylene (FEP), polypropylene (PP)), which may be advantageous for forming a more uniform sensor substrate and/or facilitating detachment of the sensor substrate from the mold.

At block 906, the process 900 can include forming the sensor substrate. For instance, in embodiments where a casting process is used, the formulation synthesized in block 902 can be deposited into the mold, e.g., via drop coating, spraying coating, spin coating, etc. The volume of the formulation can be selected to produce a desired thickness for the sensor substrate. The formulation can then be dried in the mold to form a solid material (e.g., a film, membrane, etc.) that serves as the sensor substrate. The drying process can be performed at a constant temperature or at a variable temperature (e.g., a gradually increasing temperature). The conditions for the drying process (e.g., duration, temperature profile) can be selected to produce a sensor substrate of a desired, uniform thickness.

At block 908, the process 900 can optionally include removing unreacted component(s) from the sensor substrate. For example, the formulation of block 902 may include unreacted pH-sensitive molecules (e.g., reactive intermediates that did not react with the polymer and thus remain unconjugated). The unreacted component(s) may be removed by washing the sensor substrate with a suitable solvent one or more times so that the unreacted component(s) leach out of the sensor substrate. Subsequently, the sensor substrate can be dried to remove any residual solvent.

At block 910, the process 900 can include mounting the sensor substrate on a dental appliance. For instance, in embodiments where the sensor substrate is formed using a mold, the substrate can be removed from the mold. The sensor substrate can be used as is or can be adjusted (e.g., cut) to a desired shape. The sensor substrate can then be attached to a surface of a dental appliance using any of the techniques described herein, such as adhesives, fasteners, mechanical fit, etc.

### C. Intraoral Sensing Systems and Associated Devices and Methods

As described herein, the intraoral sensors of the present technology can provide a colorimetric indication of the pH of a subject's intraoral cavity. For instance, the intraoral sensor can exhibit a color corresponding to the current pH of the intraoral cavity within 10 minutes, 5 minutes, 2 minutes, 1 minutes, or 30 seconds of being exposed to intraoral fluids in the subject's mouth. When removed from the subject's mouth, the intraoral sensor can maintain its color for at least 1 minute, 2 minutes, 5 minutes, 10 minutes, 30 minutes, 1 hour, 2 hours, or more (e.g., indefinitely until exposed to another fluid having a different pH). Optionally, the color of the intraoral sensor can be stable over very brief changes in pH conditions, e.g., the color may be maintained even if the dental appliance with the intraoral sensor is rinsed in water for a limited time (e.g., a few seconds, 30 seconds, 1 minute).

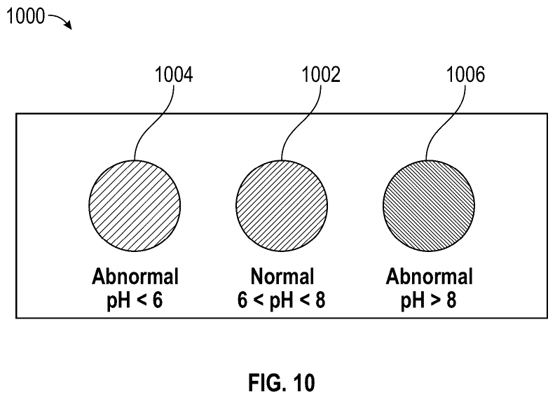

The intraoral sensor can be viewed by a subject and/or by a healthcare provider of the subject (e.g., dentist, orthodontist, clinician) to evaluate the subject's oral health (e.g., whether the subject has or is likely to develop an oral disease or condition). The color of the intraoral sensor can be compared to one or more color references that indicate how different colors correspond to different health states. For example, FIG. 10 illustrates a color reference chart 1000 that can be used with an intraoral sensor, in accordance with embodiments of the present technology. The chart 1000 can be provided as a physical object (e.g., printed on a card or instruction sheet, and/or printed on the packaging for the intraoral sensor), and/or can be provided digitally (e.g., displayed on a user interface of a mobile application or other software application). In the illustrated embodiment, the chart 1000 includes a first color 1002 corresponding to a first pH range indicative of a normal oral health state (e.g., a pH within a range from 6 to 8), a second color 1004 corresponding to a second pH range indicative of an abnormal oral health state (e.g., a pH less than 6), and a third color 1006 corresponding to a third pH range indicative of an abnormal health state (e.g., a pH greater than 8). In other embodiments, the colors and pH ranges shown on the chart 1000 can be varied as appropriate, based on the type of intraoral sensor used and/or the oral health conditions of interest.

In some embodiments, an optical sensing device is used to generate data indicative of the color of the intraoral sensor, and the data is analyzed by one or more processors of a computing device to determine the subject's intraoral pH. This computer-implemented approach can provide a more accurate, quantitative measurement of the intraoral pH. Moreover, this approach allows for integration of intraoral sensing with automated treatment planning software that can generate alerts, notifications, recommendations, etc., for the subject and/or the subject's healthcare provider based on the measured pH, as described further below.

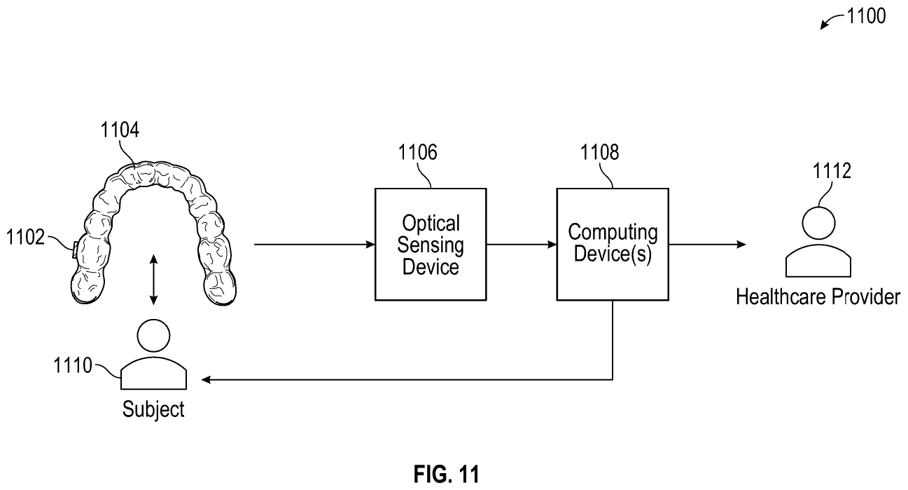

FIG. 11 is a schematic diagram of an ecosystem 1100 for monitoring a subject's intraoral health, in accordance with embodiments of the present technology. The ecosystem 1100 includes at least one intraoral sensor 1102, which can be coupled to a dental appliance 1104 worn by a subject 1110 or to a tooth of the subject 1110. The intraoral sensor 1102 and appliance 1104 can be any of the embodiments described herein (e.g., in Sections I.A, I.B, and II).

The ecosystem 1100 also includes at least one optical sensing device 1106 configured to generate data indicative of the color of the intraoral sensor 1102, after the intraoral sensor 1102 has been exposed to the intraoral cavity of the subject 1110 (e.g., after the appliance 1104 has been worn by the subject 1110 for at least 30 seconds, 1 minute, 2 minutes, 5 minutes, or 10 minutes). The optical sensing device 1106 can be any device capable of detecting the color of the intraoral sensor 1102. For example, the optical sensing device 1106 can be an imaging device (e.g., a camera of a mobile device, a web camera, a DSLR camera) that generates image data (e.g., photographs, video) of the intraoral sensor 1102. Each location (e.g., pixel) within the image data can be associated with color data (e.g., a RGB value) corresponding to the detected color of a particular portion of the intraoral sensor 1102. The color data can be used to determine the pH measurement produced by the intraoral sensor 1102, as described further below.

As another example, the optical sensing device 1106 can be a spectrophotometer (e.g., a UV-vis spectrophotometer) that generates spectrophotometric data (e.g., transmittance data, absorbance data, reflectance data) of the intraoral sensor 1102. In some embodiments, the spectrophotometer includes a light source that outputs one or more wavelengths of light toward the intraoral sensor 1102, and a detector that measures the light transmitted through, absorbed by, and/or reflected by intraoral sensor 1102. The color of the intraoral sensor at the measurement location can then be determined based on the transmittance, absorbance, and/or reflectance data, and can be used to determine the pH measurement produced by the intraoral sensor 1102, as described further below.

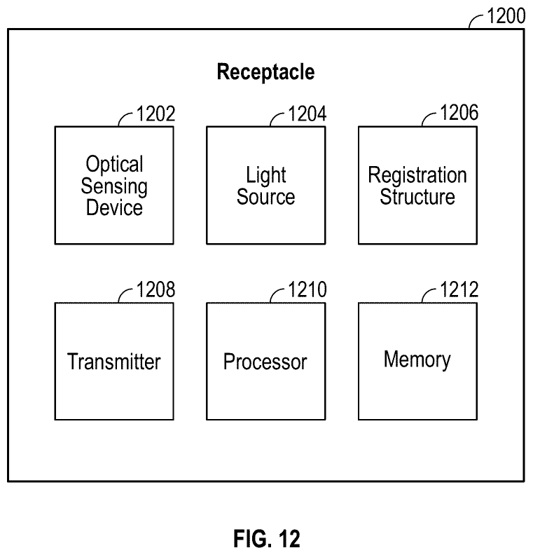

In some embodiments, the optical sensing device 1106 is a standalone device. Alternatively, the optical sensing device 1106 can be integrated into another device. For example, the optical sensing device 1106 can be part of a computing device 1108 of the ecosystem 1100, such as a mobile device (e.g., a smartphone), desktop computer, laptop, etc. As another example, the optical sensing device 1106 can be part of a receptacle for the appliance 1104 (e.g., as described further below in connection with FIGS. 12-15B).

The data produced by the optical sensing device 1106 (e.g., image data, spectrophotometric data) can be received by at least one computing devices 1108 of the ecosystem 1100. The computing device 1108 can be or include a mobile device (e.g., a smartphone, tablet, smartwatch), a desktop computer, laptop, workstation, server, etc. In embodiments where the optical sensing device 1106 is not part of a computing device 1108, the data can be transmitted from the optical sensing device 1106 to a separate computing device 1108, using any suitable wired or wireless communication technique (e.g., Bluetooth).

The computing device 1108 can access and process the data to detect the color of the intraoral sensor 1102, which can then be used to determine the pH of the subject's intraoral cavity. For example, in embodiments where the data includes image data of the intraoral sensor 1102, the computing device 1108 can process the image data to identify the image portions (e.g., pixel coordinates) corresponding to the intraoral sensor 1102 (versus image portions corresponding to the appliance 1104 and/or other background objects). The computing device 1108 can optionally identify specific components of the intraoral sensor 1102 (e.g., a sensor substrate versus a color reference marker). The identification can be performed using computer vision algorithms, machine learning algorithms, and/or any other suitable technique. Subsequently, the computing device 1108 can determine the color data (e.g., RGB values) at the identified image portions. The color data can then be correlated to a corresponding pH value, such as using a calibration curve, lookup table, mapping function, or other data structure that indicates the relationship between color and pH for the particular intraoral sensor 1102. In some embodiments, the color data and/or pH values over a plurality of locations in the image data are averaged or otherwise combined to generate a single pH value representing the overall pH measurement produced by the intraoral sensor 1102.

Optionally, in embodiments where a color reference marker is used, the computing device 1108 can identify the image portions corresponding to the color reference marker and determine the color data at those image portions. The color data of the color reference marker can be used to adjust the image data, e.g., the color balance and/or brightness of the image data can be modified so that the color data of the color reference marker matches the fixed color of the color reference marker. The color data of the intraoral sensor 1102 can then be determined from the modified image data and used to determine the pH measurement. Alternatively or in combination, the color data of the color reference marker can be used to directly adjust the color data of the intraoral sensor 1102. For instance, the computing device 1108 can determine a difference between the fixed color of the color reference marker and the color data of the color reference marker, and can modify the color data of the intraoral sensor 1102 based on the determined difference. The modified color data can then be used to determine the pH measurement.

As another example, in embodiments where the data includes spectrophotometric data of the intraoral sensor 1102 for one or more measurement locations, the computing device 1108 can use the spectrophotometric data to determine the color of the intraoral sensor 1102 at the measurement location(s). The color can then be correlated to a corresponding pH value using a calibration curve, lookup table, mapping function, or other data structure indicating the relationship between color and pH for the particular intraoral sensor. In some embodiments, the color data and/or pH values over a plurality of measurement locations are averaged or otherwise combined to generate a single pH value representing the overall pH measurement produced by the intraoral sensor 1102.

In embodiments where multiple intraoral sensors 1102 are present, the computing device 1108 can receive data for each intraoral sensor 1102 and determine a pH value for each intraoral sensor 1102 based on the respective data. The computing device 1108 can average or otherwise combine the pH values for each intraoral sensor 1102 to generate a single pH measurement representing the overall pH of the intraoral cavity. Optionally, pH values for different intraoral sensors 1102 can be weighted differently, e.g., depending on the location of the intraoral sensor 1102, type of pH-sensitive molecule used in the intraoral sensor 1102, and/or other relevant considerations. In other embodiments, however, the pH values from different intraoral sensors 1102 can be kept as separate pH measurements.

The computing device 1108 can generate an output indicative of the determined pH of the intraoral cavity. For instance, the computing device 1108 can display the determined pH on a screen, monitor, or other display hardware of the computing device 1108. In some embodiments, the pH can be determined and displayed by the same computing device 1108 (e.g., a local client device such as the subject's smartphone). Alternatively, the pH can be determined using a first computing device 1108, and can be transmitted to and displayed by a second computing device 1108. For instance, data from the optical sensing device 1106 can be transmitted to a remote server (e.g., directly or using a local client device as an intermediary), the remote server can determine the pH measurement, and the pH measurement can be transmitted to a local client device for display (e.g., subject's smartphone and/or the healthcare provider's computer). As another example, a first local client device can determine the pH measurement (e.g., the subject's smartphone), and can transmit the pH measurement to a second local client device for display (e.g., the healthcare provider's computer), either directly or using a remote server as an intermediary.

In some embodiments, the computing device 1108 generates other outputs, in addition to the pH measurement. For example, in embodiments where the intraoral sensor 1102 is used to monitor the pH of the intraoral cavity over time, the computing device 1108 can display one or more previous pH values together with the most current pH value, e.g., as a graph, chart, list, etc. This approach can assist a user (e.g., the subject 1110 and/or the healthcare provider 1112) in evaluating the subject's oral health over time, e.g., to identify trends that could be indicative of improving or deteriorating oral health.

As another example, the computing device 1108 can generate alerts, notifications, recommendations, etc., based on the determined pH. In some embodiments, the computing device 1108 compares the determined pH to one or more pH ranges, such as a pH range indicative of normal oral health (“normal pH range”) and/or a pH range associated with an oral disease or condition (“abnormal pH range”). If the determined pH falls within the normal pH range and/or outside the abnormal pH range, the computing device 1108 can output a notification that the subject 1110 has normal oral health and/or a recommendation that the subject 1110 should continue their current oral hygiene practices.

If the determined pH falls within the abnormal pH range and/or outside the normal pH range, the computing device 1108 can output an alert that the subject 1110 may have an oral disease or condition, or may be at risk of developing an oral disease or condition. Optionally, the computing device 1108 can determine one or more recommendations for preventing, remedying, treating, or otherwise addressing the oral disease or condition. Such recommendations can include increasing brushing frequency, increasing flossing frequency, increasing water intake, decreasing intake of sugary food, receiving fluoride treatment, receiving treatment for dental decay, receiving treatment for periodontitis, and/or scheduling an appointment with a healthcare provider 1112 for further evaluation.

The alerts, notifications, recommendations, etc., can be generated and displayed by the same computing device 1108 that performed the pH determination, or can be generated and displayed by one or more different computing devices 1108. For example, a remote server can receive a pH value generated by a local client device (e.g., the subject's smartphone), and can determine one or more corresponding outputs (e.g., alerts, notifications, recommendations, etc.) based on the pH value. The outputs can be transmitted to and displayed by one or more local client devices (e.g., the subject's smartphone and/or the healthcare provider's computer). As another example, the remote server can determine the pH value and a corresponding output, and can provide the outputs to one or more local client devices for display. In a further example, a single local client device (e.g., the subject's smartphone) can determine the pH value, and can also generate and display a corresponding output. In yet another example, a first local client device can determine the pH value and generate a corresponding output, and can transmit the output to a second local client device for display (e.g., the healthcare provider's computer), either directly or via an intermediary (e.g., a remote server).

The computing device(s) 1108 of the ecosystem 1100 can be configured in many different ways. A computing device 1108 can include hardware components (e.g., processors, memory, displays, communication modules) and software component (e.g., a mobile application, web application, or other software application) configured to perform the various operations described herein. In embodiments where multiple computing devices 1108 are used, the computing devices 1108 can communicate with each other via one or more communication networks, such as a wired network, a wireless network, a metropolitan area network (MAN), a local area network (LAN), a wide area network (WAN), a virtual local area network (VLAN), an internet, an extranet, an intranet, or any other suitable type of network, or combinations thereof.

In some embodiments, the ecosystem 1100 includes one or more local client devices (e.g., mobile device, desktop computer, laptop) and a remote server. The local client devices can include a first local client device associated with the subject 1110 (e.g., the subject's smartphone) and a second local client device associated with the healthcare provider 1112 (e.g., the healthcare provider's computer). Any of the operations described herein can be performed by a local client device (e.g., by the first local client device or the second local client device), by the remote server, or suitable combinations thereof.

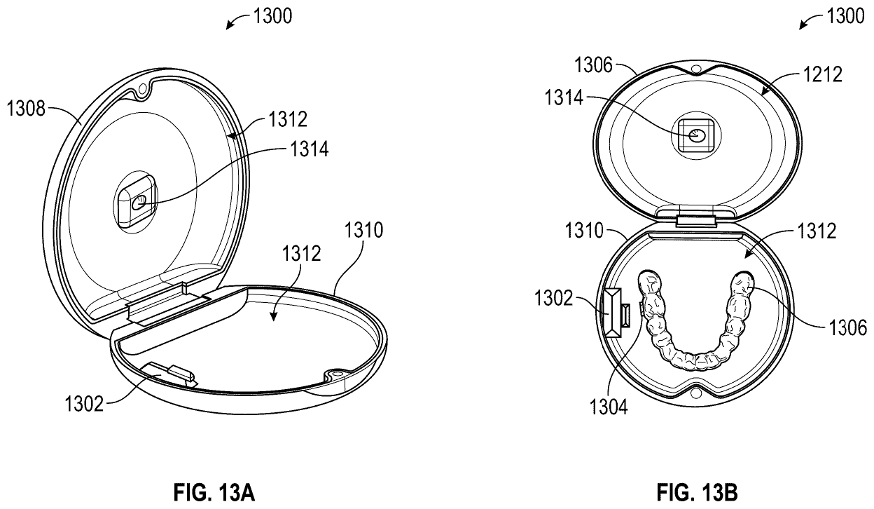

FIG. 12 is a block diagram illustrating a general overview of a receptacle for use with an intraoral sensor, and FIGS. 13A-15B illustrate representative examples of receptacles, in accordance with embodiments of the present technology. Any of the features of the embodiments of FIGS. 12-15B can be combined with each other and/or with any of the other embodiments described herein (e.g., the optical sensing device 1106 of the ecosystem 1100 of FIG. 11).

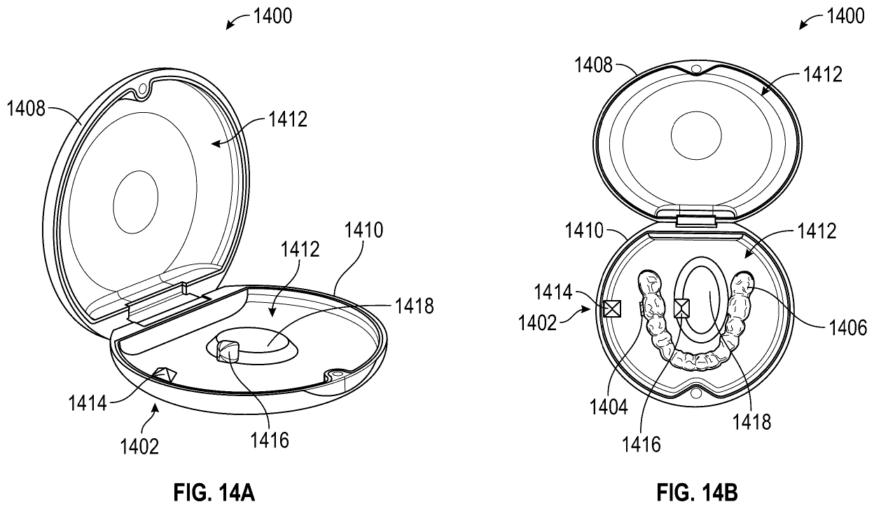

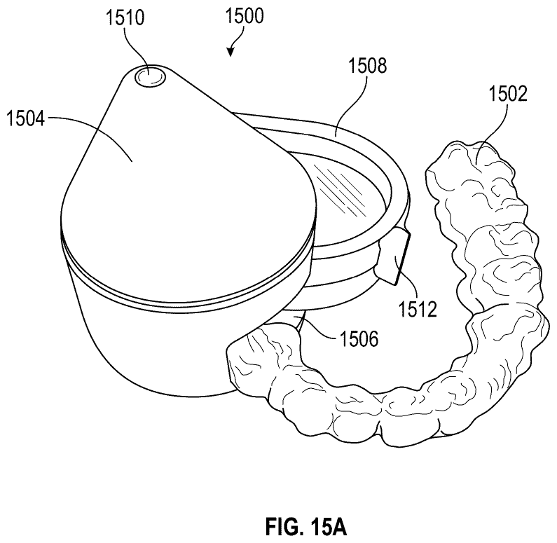

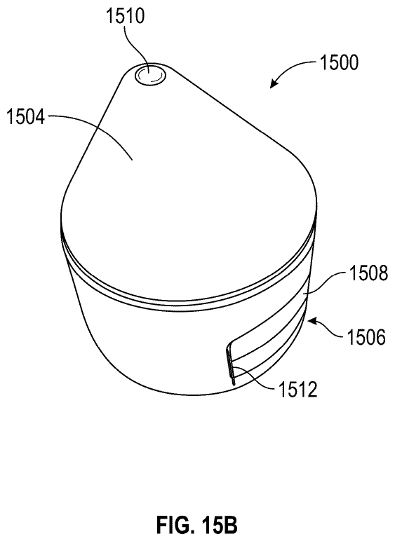

Referring first to FIG. 12, the receptacle 1200 is configured to receive at least a portion of a dental appliance to which the intraoral sensor is mounted. For example, the receptacle 1200 can be a case for storing the dental appliance (e.g., as described below in connection with FIGS. 13A-14B). As another example, the receptacle 1200 can be a container used specifically for purposes of generating data of the intraoral sensor (e.g., as described below in connection with FIGS. 15A and 15B).

The receptacle 1200 includes an optical sensing device 1202 for generating image data, spectrophotometric data, and/or other data indicative of the color of the intraoral sensor, as described herein. The use of an optical sensing device 1202 within a receptacle 1200 can provide more consistent and accurate data, since the environmental conditions (e.g., lighting, background) within the receptacle 1200 can be controlled to reduce fluctuations in the detected color due to factors other than pH. The receptacle 1200 can also include a light source 1204 that outputs light toward the intraoral sensor. The light source 1204 can be used to illuminate the intraoral sensor to provide consistent, controlled lighting conditions for imaging the intraoral sensor, or can serve as the light source for spectrophotometric measurements. In other embodiments, however, the light source 1204 is optional and can be omitted.

The receptacle 1200 can include at least one registration structure 1206 that engages the dental appliance so the intraoral sensor is positioned in a predetermined spatial relationship with the optical sensing device 1202. In some embodiments, the optical sensing device 1202 is at a fixed position and/or orientation within the receptacle 1200, and the registration structure 1206 constrains the position and/or orientation of the appliance relative to the receptacle 1200 so that the intraoral sensor is at a predetermined position and/or orientation relative to the optical sensing device 1202. For instance, the registration structure 1206 can ensure that the intraoral sensor is within the field of view of the optical sensing device 1202, and/or is not too close to or too far from the optical sensing device 1202 for generating accurate data.

The registration structure 1206 can be configured in many ways. For instance, the registration structure 1206 can be an indentation, recess, hole, etc., that the appliance fits into to position the intraoral sensor at the appropriate location. Alternatively or in combination, the registration structure 1206 can include structural projections such as posts, blocks, protrusions, walls, etc., that contact certain portions of the appliance to constrain how the appliance can be placed within the receptacle 1200. Optionally, the registration structure 1206 can include visual markers (e.g., dots, arrows, lines) that show the user how the appliance should be positioned within the receptacle 1200. In other embodiments, however, the registration structure 1206 is optional and can be omitted.

The receptacle 1200 can include a transmitter 1208 for sending data from the optical sensing device 1202 to another device separate from the receptacle 1200. For example, the other device can be a computing device, such as any of the computing devices 1108 described in connection with FIG. 11. The transmitter 1208 can be wireless transmitter, such as a Bluetooth transmitter or other transmitter suitable for short-range wireless communications, a transmitter for a wireless communication network, etc. Alternatively or in combination, the receptacle 1200 can include components for wired data transmission (e.g., a USB port).

The receptacle 1200 can also include a processor 1210 and a memory 1212 storing instructions that are executable by the processor 1210 to perform various operations. For example, the processor 1210 can control the operation of the optical sensing device 1202 and/or light source 1204 to generate data of the intraoral sensor. As another example, the processor 1210 can perform pre-processing of the data produced by the optical sensing device 1202, e.g., to remove noise and/or artifacts, add relevant metadata, etc. In yet another example, the processor 1210 can control the operation of the transmitter 1208 to send data to another device. Optionally, the color detection and/or pH determination processes described herein can be performed onboard the receptacle 1200 by the processor 1210, and the transmitter 1208 can send the color and/or pH data to another device.

FIGS. 13A and 13B are side and front perspective views, respectively, of a dental appliance case 1300 with an imaging device 1302, in accordance with embodiments of the present technology. The imaging device 1302 (e.g., a camera) is configured to generate image data of an intraoral sensor 1304 coupled to a dental appliance 1306 (FIG. 13B). The image data can be used to detect the color of the intraoral sensor 1304 in order to determine the pH of a subject's intraoral cavity, as described herein. The case 1300 can be used to reduce or eliminate inconsistencies in the detected color of the intraoral sensor 1304 that may otherwise be present due to different environmental conditions.

The case 1300 can include a lid 1308 and a base 1310 that collectively form a chamber 1312 sized to receive and accommodate the entire appliance 1306. In the illustrated embodiment, the imaging device 1302 is positioned at one side of the base 1310 and is oriented toward the interior of the chamber 1312, such that when the appliance 1306 is placed on the base 1310, the intraoral sensor 1304 on the appliance 1306 is within the field of view of the imaging device 1302. Optionally, the base 1310 can include one or more registration structures (not shown) that constrain the placement of the appliance 1306 so the intraoral sensor 1304 is properly positioned and aligned relative to the imaging device 1302, as discussed herein. The interior surfaces of the base 1310 and/or the lid 1308 can have a uniform, neutral color (e.g., black or white) that provides a consistent, unobtrusive background for imaging the intraoral sensor 1304.

When obtaining image data of the intraoral sensor 1304 with the imaging device 1302, the lid 1308 of the case 1300 can be closed and coupled to the base 1310 so that the intraoral sensor 1304 and appliance 1306 are entirely enclosed within the case 1300. The case 1300 can include a light source 1314 that outputs light toward the intraoral sensor 1304 and appliance 1306 to illuminate the intraoral sensor 1304 for imaging. For example, the light source 1314 can be positioned on the lid 1308 and can be oriented downward toward the base 1310. The characteristics of the light produced by the light source 1314 (e.g., wavelength(s), intensity) can be selected to illuminate the intraoral sensor 1304 in a manner that facilitates detection of the color of the intraoral sensor 1304 from image data, and can be remain consistent across different time points. The imaging device 1302 can then be used to take one or more images (e.g., color photographs) of the intraoral sensor 1304. The image(s) can be transmitted to another device (e.g., a mobile device or other computing device) for pH determination and other downstream applications, as described herein.

The configuration of the case 1300 can be varied in many ways. For instance, the imaging device 1302 and/or light source 1314 can be placed at other locations within the case 1300, e.g., the imaging device 1302 can be located on the lid 1308 and the light source 1314 can be located on the base 1310. The locations of the imaging device 1302 and/or light source 1314 can be selected based on the placement of the intraoral sensor 1304 on the appliance 1306. Moreover, the case 1300 can include a plurality of imaging devices 1302 (e.g., two, three, four, five, or more imaging devices 1302), which can be used to obtain images of the intraoral sensor 1304 from different points of view and/or can be used to obtain images of intraoral sensors 1304 located at different portions of the appliance 1306. Optionally, the case 1300 can include a plurality of light sources 1314 (e.g., two, three, four, five, or more light sources 1314), which can provide more even illumination of the intraoral sensor 1304 and/or can be used to illuminate intraoral sensors 1304 located at different portions of the appliance 1306. Furthermore, the imaging device 1302 can alternatively or additionally obtain image data of the intraoral sensor 1304 while the lid 1308 is open, in which case the light source 1314 may be omitted. The case 1300 can also include additional components not shown in FIGS. 13A and 13B, such as any of the components described in connection with FIG. 12 (e.g., transmitter, processor, memory).

FIGS. 14A and 14B are side and front perspective views, respectively, of a dental appliance case 1400 with a spectrophotometer 1402, in accordance with embodiments of the present technology. The spectrophotometer 1402 is configured to generate spectrophotometric data (e.g., transmittance data, absorbance data, and/or reflectance data) of an intraoral sensor 1404 coupled to a dental appliance 1406 (FIG. 14B). The spectrophotometric data can be used to detect the color of the intraoral sensor 1404 in order to determine the pH of a subject's intraoral cavity, as described herein.

The case 1400 can include a lid 1408 and a base 1410 that collectively form a chamber 1412 sized to receive and accommodate the entire appliance 1406. In some embodiments, the spectrophotometer 1402 includes a light source 1414 and a detector 1416 that are both positioned on the base 1410 of the case 1200. The light source 1414 can be positioned at one side of the base 1410 and can be oriented toward the interior of the chamber 1412, such that when the appliance 1406 is placed on the base 1410, the light from the light source 1414 is directed onto the intraoral sensor 1404. In the illustrated embodiment, the detector 1416 is configured to measure the light transmitted through and/or absorbed by the intraoral sensor 1404, and thus is positioned on the opposite side of the intraoral sensor 1404 as the light source 1414 (e.g., at or near the central portion of the base 1410) and is oriented toward the light source 1414 so as to receive light from the light source 1414 that passes through the intraoral sensor 1404. Optionally, the detector 1416 can be mounted on a support 1418 that protrudes upward from surface the base 1410. The support 1418 can alternatively or additionally serve as a registration structure for constraining the placement of the appliance 1406 so the intraoral sensor 1404 is properly positioned and aligned relative to the light source 1414 and detector 1416, as discussed herein.

In other embodiments, however, the detector 1416 can be configured to measure the light reflected by the intraoral sensor 1404, in which case the detector 1416 can be positioned on the same side of the intraoral sensor 1404 as the light source 1414 (e.g., at the side of the base 1410) and can be oriented toward the intraoral sensor 1404 so as to receive light that is reflected off the intraoral sensor 1404. Optionally, the spectrophotometer 1402 can include a first detector 1416 configured to measure transmittance and/or absorbance of the intraoral sensor 1404, and a second detector 1416 configured to measure reflectance of the intraoral sensor 1404.

When obtaining spectrophotometric data of the intraoral sensor 1404 with the spectrophotometer 1402, the lid 1408 of the case 1400 can be closed and coupled to the base 1410 so that the intraoral sensor 1404 and appliance 1406 are entirely enclosed within the case 1400. The light source 1414 can then output one or more wavelengths of light toward the intraoral sensor 1404. The detector 1416 can measure the amount of light at each wavelength that passes through and/or is reflected by the intraoral sensor 1404, which can be used to determine the transmittance/absorbance and/or reflectance of the intraoral sensor 1404 at one or more wavelengths. This spectrophotometric data can be transmitted to another device (e.g., a mobile device or other computing device) for pH determination and other downstream applications, as described herein.

The configuration of the case 1400 can be varied in many ways. For instance, the light source 1414 and/or detector 1416 can be placed at other locations within the case 1400, such as on the lid 1408. The locations of the light source 1414 and/or detector 1416 can be selected based on the placement of the intraoral sensor 1404 on the appliance 1406, as well as the desired measurement type (e.g., transmittance/absorbance versus reflectance). Moreover, the case 1200 can include a plurality of spectrophotometers 1402 (e.g., two, three, four, five, or more spectrophotometers 1402), which can be used to obtain spectrophotometric data of different locations of the intraoral sensor 1404 and/or can be used to obtain spectrophotometric data of intraoral sensors 1404 located at different portions of the appliance 1406. Furthermore, the spectrophotometer 1402 can alternatively or additionally obtain spectrophotometric data of the intraoral sensor 1404 while the lid 1408. The case 1400 can also include additional components not shown in FIGS. 14A and 14B, such as any of the components described in connection with FIG. 12 (e.g., transmitter, processor, memory).

FIGS. 15A and 15B are perspective views of a receptacle 1500 for optical sensing, in accordance with embodiments of the present technology. The receptacle 1500 is used to generate optical sensing data (e.g., image data, spectrophotometric data) of an intraoral sensor on a dental appliance 1502 (the intraoral sensor is obscured in FIGS. 15A and 15B). Referring first to FIG. 15A, the receptacle 1500 includes a housing 1504 defining a chamber that is sized to receive only a portion of the appliance 1502 including the intraoral sensor. In the illustrated embodiment, the receptacle 1500 receives a first distal portion of the appliance 1502 with the intraoral sensor, while the mesial portion and second distal portion of the appliance 1502 remain outside of the housing 1504. The housing 1504 includes an aperture 1506 (e.g., a slot, perforation, opening) that allows the portion of the appliance 1502 to be inserted into the chamber.

The receptacle 1500 includes at least one optical sensing device (obscured in FIGS. 15A and 15B) within the chamber of the housing 1504. For example, the optical sensing device can include at least one imaging device (e.g., a camera) configured to generate image data of the intraoral sensor, similar to the imaging device 1302 of FIGS. 13A and 13B. Optionally, the receptacle 1500 can include one or more light sources within the housing to illuminate the intraoral sensor during imaging. As another example, the optical sensing device can include at least one spectrophotometer configured to generate spectrophotometric data of the intraoral sensor, similar to the spectrophotometer 1402 of FIGS. 14A and 14B. The receptacle 1500 can also include additional components, such as any of the components described in connection with FIG. 12 (e.g., registration structure, transmitter, processor, memory).

Optionally, the receptacle 1500 can include a door 1508 that is configured to open and close the aperture 1506. In the illustrated embodiment, for example, the door 1508 is coupled to the housing 1504 of the receptacle 1500 via a hinge 1510, thereby allowing the door 1508 to pivot between open and closed configurations. Other types of door mechanisms can also be used, e.g., the door 1508 can be a sliding door, a detachable door, etc. The door 1508 can include a tab 1512 or similar projecting structure to facilitate opening and closing of the door 1508, e.g., the user can press against the tab 1512 with a finger to swing the door 1508 open or closed. In some embodiments, when the door 1508 is in the open configuration (FIG. 15A), the door 1508 is displaced away from the aperture 1506, thus allowing the portion of the appliance 1502 including the intraoral sensor to be inserted into the aperture 1506. Optionally, the door 1506 can also serve as a guide for positioning the appliance 1502 so the sensor is aligned properly with the optical sensing device within the housing 1504. When the door 1508 is in the closed configuration (FIG. 15B), the door 1508 can fit at least partially into the housing 1504 to cover the aperture 1506, thereby protecting the optical sensing device when not in use.

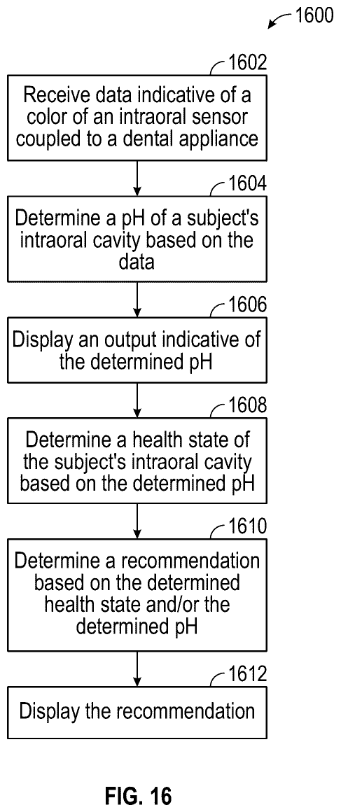

FIG. 16 is a flow diagram illustrating a method 1600 for monitoring a subject's intraoral cavity, in accordance with embodiments of the present technology. The method 1600 can be performed using any of the systems and devices described herein, such as any of the embodiments of FIGS. 1A-15B. In some embodiments, some or all of the processes of the method 1600 are implemented as computer-readable instructions (e.g., program code) that are configured to be executed by one or more processors of a computing device, such as any of the computing devices 1108 described in connection with FIG. 11.

The method 1600 can begin at block 1602 with receiving data indicative of a color of an intraoral sensor coupled to a dental appliance. The intraoral sensor can be any of the embodiments described in Sections I.A and I.B. For example, the intraoral sensor can include a sensor substrate (e.g., a film) including a pH-sensitive molecule that changes in color based on the pH of the subject's intraoral cavity, thereby providing a colorimetric pH indication. The pH-sensitive molecule can be immobilized within the sensor substrate, e.g., the sensor substrate can include a biocompatible polymer that serves as a scaffold for covalent conjugation of the pH-sensitive molecule.

The intraoral sensor can be coupled to a dental appliance (e.g., an aligner, a palatal expander, a mouth guard, a night guard, a retainer) using any suitable attachment technique. For instance, the intraoral sensor can include an adhesive that attaches the sensor substrate to a surface of the dental appliance. The intraoral sensor can be coupled to any suitable portion of the appliance, such as a buccal surface, lingual surface, exterior surface, interior surface, etc. The intraoral sensor can be positioned such that when the appliance is worn on the subject's teeth, the intraoral sensor is located on or proximate to a molar, premolar, canine, or incisor.

The data can be any data type that can be processed to detect the color of the intraoral sensor (e.g., the color of the pH-sensitive molecule of the intraoral sensor). For example, the data can be or include image data including one or more color images (e.g., photographs) of the intraoral sensor. Alternatively or in combination, the data can be or include spectrophotometric data including transmittance, absorbance, and/or reflectance measurements of the intraoral sensor at one or more wavelengths of light. The data can be obtained using an optical sensing device, such as a camera or spectrophotometer. The optical sensing device can be a standalone device or can be part of another device. In some embodiments, the optical sensing device is a camera of a mobile device (e.g., smartphone) or other computing device). Alternatively, the optical sensing device can be part of a receptacle that receives a portion of or the entirety of the dental appliance, such as any of the embodiments described in connection with FIGS. 12-15B.

Optionally, the optical sensing device can include or be operably coupled to a display device (e.g., a screen, monitor, touchscreen) that displays a user interface to guide a user (e.g., a subject, clinician, technician) in obtaining accurate and reliable data of the intraoral sensor. For example, the user interface can include a visual indicator (e.g., a square, rectangle, circle, star, point, brackets, crosshairs) to assist the user in aiming the optical sensing device at the intraoral sensor or a region of interest thereof (e.g., a sensor substrate and/or color reference marker). The visual indicator may alternatively or additionally assist the user in positioning the optical sensing device at a suitable distance away from the intraoral sensor to ensure proper focus and resolution. Moreover, the visual indicator can assist the user in positioning the intraoral sensor or region thereof at a specific location in an image of the intraoral sensor to facilitate accurate identification and segmentation of the intraoral sensor in subsequent image analysis.

At block 1604, the method 1600 can include determining a pH of a subject's intraoral cavity based on the data. In some embodiments, the pH determination includes processing the data to detect the color of the intraoral sensor, and correlating the detected color to a pH value. For example, in embodiments where the data is or includes image data, the color of the intraoral sensor can be detected by identifying one or more image portions (e.g., pixels) corresponding to the intraoral sensor, and determining the color information (e.g., RGB values) at the identified image portion(s). As another example, in embodiments where the data is or includes spectrophotometric data, the color can be detected based on the transmittance, absorbance, and/or reflectance characteristics of the intraoral sensor. The detected color can then be correlated to a corresponding pH value, such as using a calibration curve, lookup table, mapping function, etc., that represents the relationship between the color of the pH-sensitive molecule and pH conditions.

At block 1606, the method 1600 can include displaying an output indicative of the determined pH. The output can be a numerical value, text, graph, image, and/or other indication of the determined pH that is displayed to a user (e.g., to the subject and/or to a healthcare provider of the subject). For example, the output can be shown on a monitor, touchscreen, monitor, or other display or output device that is accessible by the user. In embodiments where previous pH data is available, the determined pH can be displayed together with one or more previous pH values (e.g., as a graph, chart, list) to show trends in intraoral pH over time.

At block 1608, the method 1600 can include determining a health state of the subject's intraoral cavity based on the determined pH. The process of block 1608 can include evaluating whether the determined pH falls within an abnormal pH range associated with an oral disease or condition (e.g., dental decay, halitosis, periodontitis), such as a pH range less than or equal to 7, 6.5, 6, 5.5, or 5; and/or a pH range greater than 7.5, 8, 8.5, 9, or 9.5. The subject can be determined to have the oral disease or condition (e.g., dental caries), or to be at an elevated risk of developing the oral disease or condition, if the determined pH falls within the abnormal pH range. Alternatively or in combination, the process of block 1608 can include evaluating whether the pH falls within a normal pH range associated with normal oral health, such as a pH range from 5 to 7, or 6 to 8; and/or a pH greater than or equal to 5.5, 6, 6.5, 7, or 7.5. The subject can be determined to have normal oral health and/or to be at a decreased risk of developing the oral disease or condition, if the determined pH falls within the normal pH range.

At block 1610 the method 1600 can include determining a recommendation based on the determined pH and/or health state. For instance, if the subject is determined to have an abnormal intraoral pH, and/or to have or be at an increased risk at developing an oral disease or condition, the recommendation can be to increase brushing frequency, increase flossing frequency, decrease intake of sugary food, receive fluoride treatment, receive treatment for dental decay, receive treatment for periodontitis, schedule an appointment with a healthcare provider for further evaluation, or suitable combinations thereof. If the subject is determined to have a normal intraoral pH and/or to be at a decreased risk of developing an oral disease or condition, the recommendation can be to continue current oral hygiene practices. Optionally, the recommendation can be determined based on other considerations, such as characteristics of the subject (e.g., age), characteristics of the subject's teeth (e.g., number of teeth, any missing teeth, any unerupted teeth), medical history (e.g., previous instances of dental decay, periodontitis, and/or other oral disease or conditions), current dental treatments (e.g., orthodontic treatment procedures, implants), etc.

At block 1612, the method 1600 can include displaying the recommendation. The recommendation can be provided as text, images, and/or any other output that is displayed to a user (e.g., to the subject and/or to a healthcare provider of the subject). For example, the output can be shown on a monitor, touchscreen, monitor, or other display or output device that is accessible by the user.

The method 1600 illustrated in FIG. 16 can be modified in many different ways. For example, some of the processes of the method 1600 can be omitted, such as any of the processes of blocks 1608, 1610, and/or 1612. The method 1600 can include additional processes not shown in FIG. 16. In some embodiments, for instance, the method 1600 can include receiving data indicative of a color of a color reference marker (e.g., as described in connection with FIGS. 3A-5H), such that the pH of the subject's intraoral cavity is determined based on the color of the intraoral sensor and the color of the color reference marker. Moreover, the ordering of the processes of the method 1600 can be varied, e.g., the process of block 1606 can be performed after the processes of blocks 1608 and 1610, and concurrently with the process of block 1612.

In some embodiments, all of the processes of the method 1600 are performed by a single computing device, such as a single local client device (e.g., a mobile device of the subject) or a remote server. In other embodiments, however, at least some of the processes of the method 1600 can be performed by two or more different computing devices. For instance, the processes of blocks 1602-1606 can be performed by a first computing device; and the processes of blocks 1608-1612 can be performed by a second computing device. As another example, the “determination” processes of blocks 1602, 1604, 1608, and/or 1610 can be performed by a first computing device, which can then send instructions to a second computing device to perform the “display” processes of blocks 1606 and/or 1612.

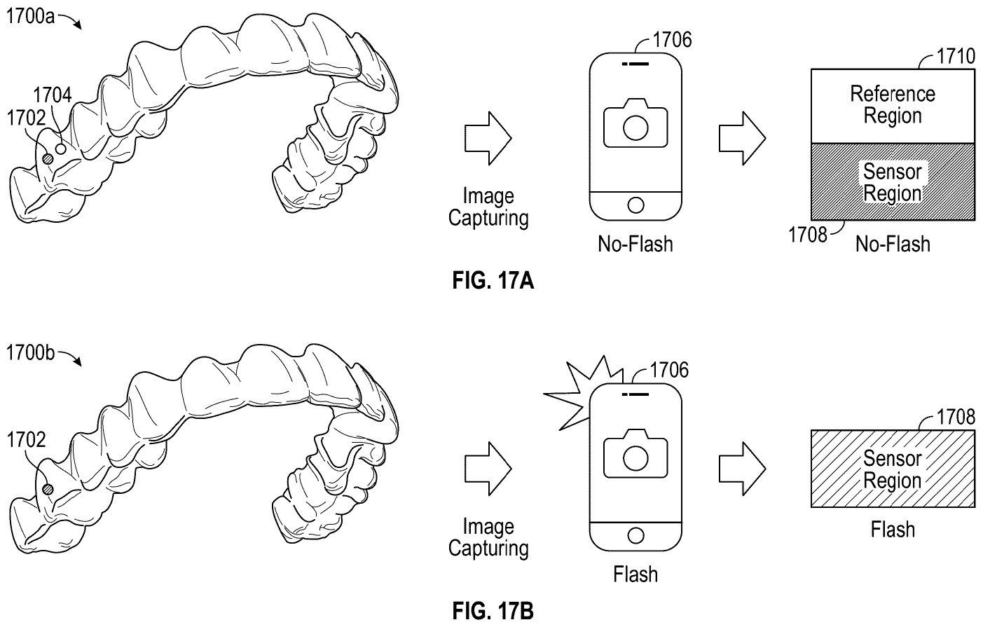

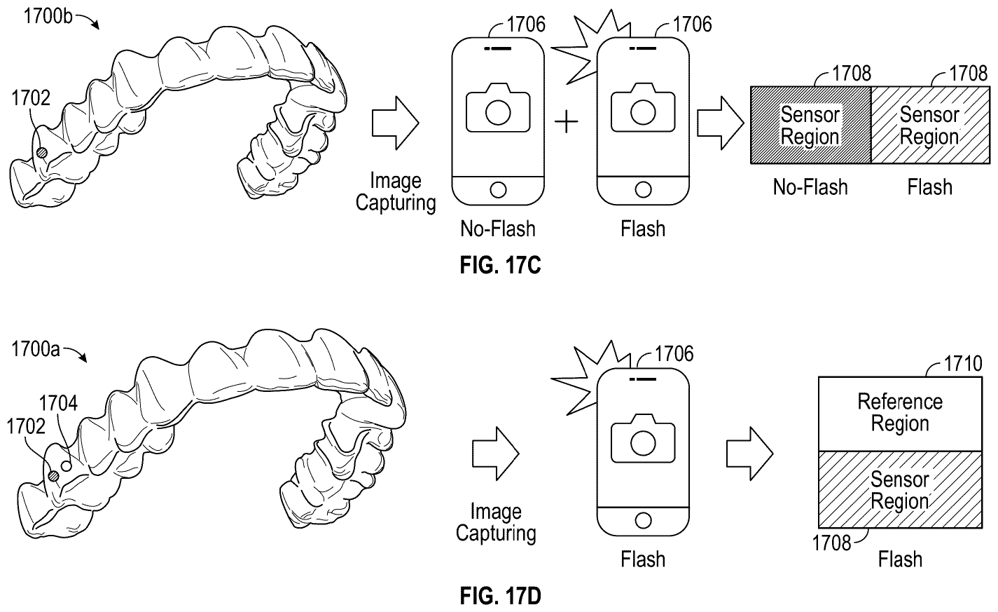

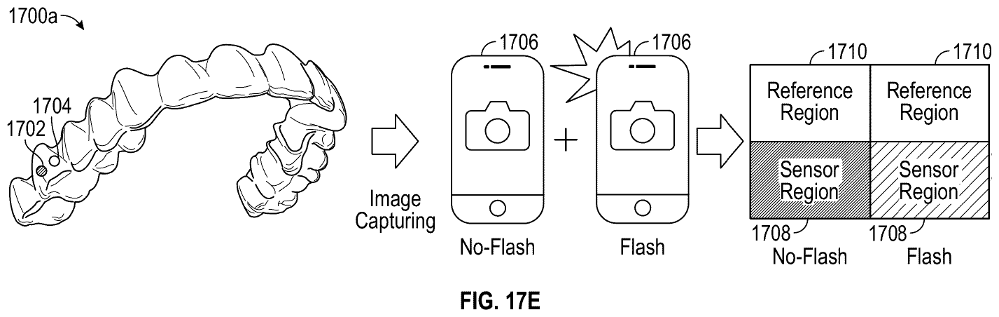

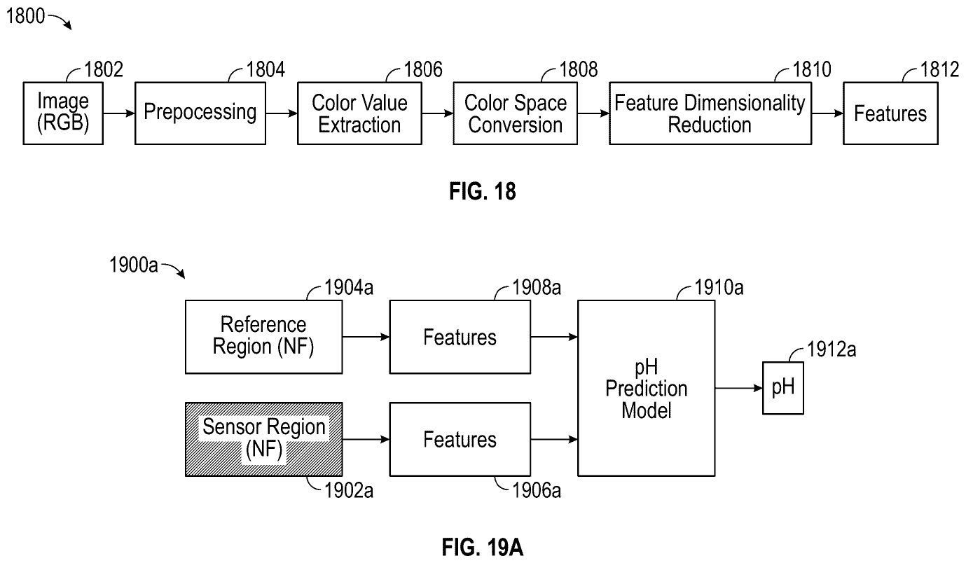

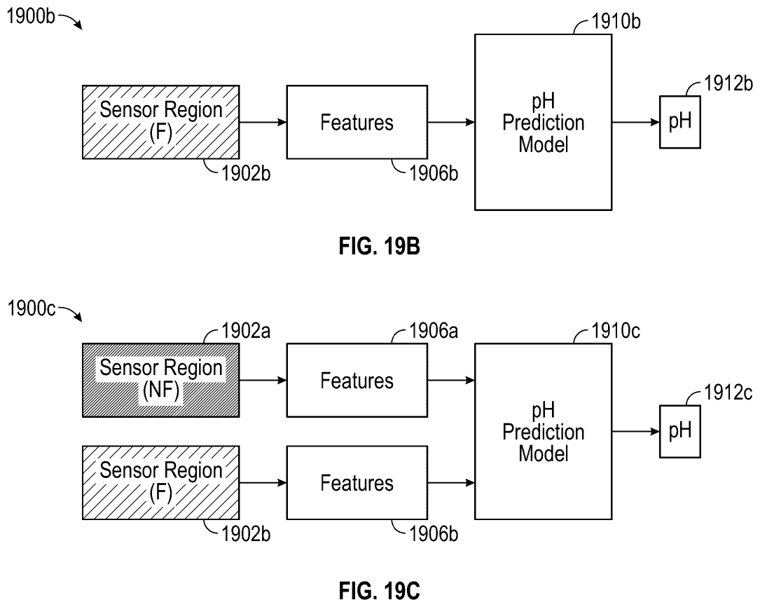

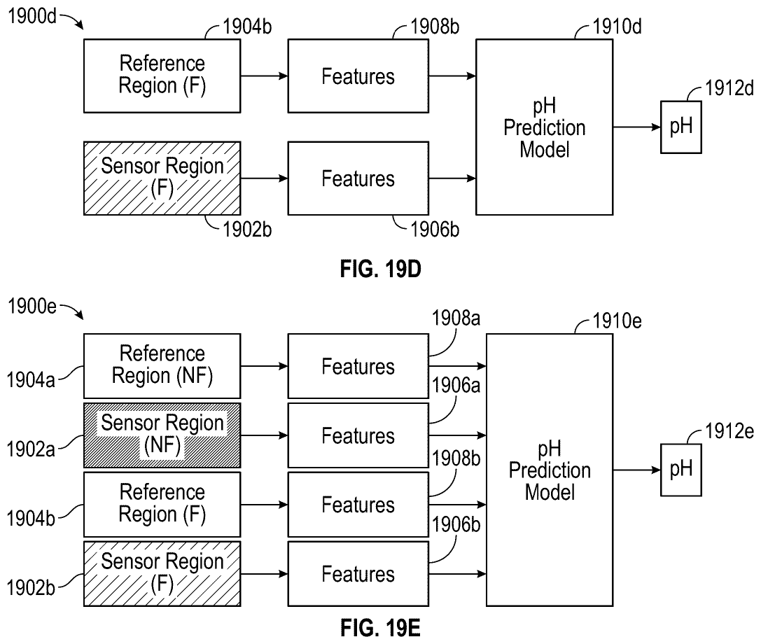

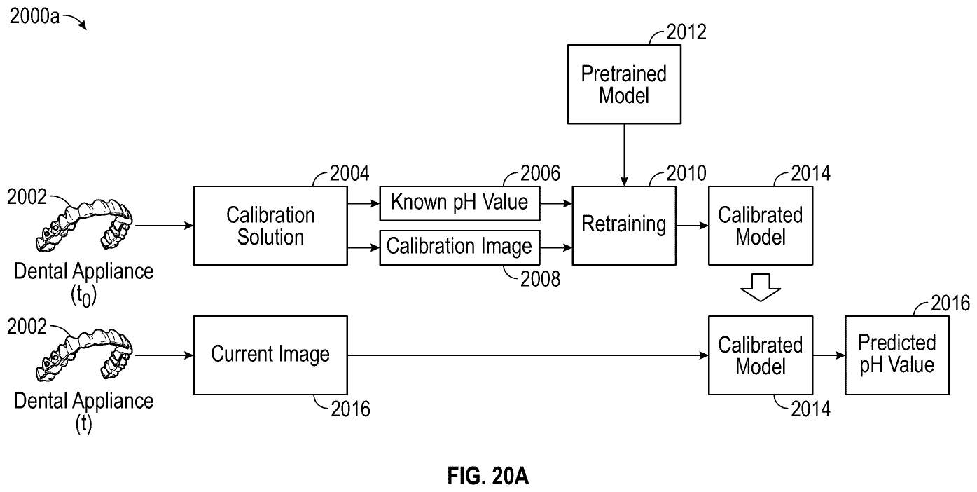

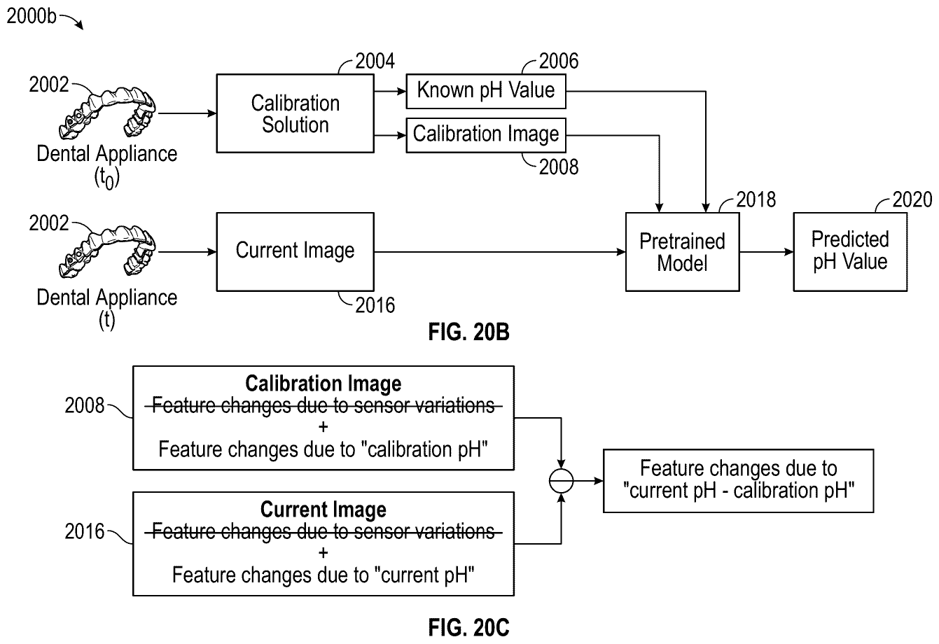

FIGS. 17A-20C illustrate techniques for obtaining and analyzing color data of an intraoral sensor, in accordance with embodiments of the present technology. Specifically, FIGS. 17A-17E illustrate various techniques for obtaining image data of an intraoral sensor, FIG. 18 illustrates a workflow for extracting features from image data of an intraoral sensor, FIGS. 19A-19E illustrate techniques for determining pH values using a pH prediction model, and FIGS. 20A-20C illustrate techniques for calibrating a pH prediction model. The techniques of FIGS. 17A-20C can be implemented with any of the systems and methods described herein, such as the method 1600 of FIG. 16.

The embodiments of FIGS. 17A-20C can be used to address the challenge of accurately capturing and analyzing color data of an intraoral sensor while mitigating the impact of ambient light. As discussed elsewhere herein, variable environment lighting conditions may affect how the color of a colorimetric sensor appears in image data, which may make it difficult to accurately determine the actual color of the sensor. The present technology can overcome these and other concerns through the use of image capture techniques that utilize camera flash to reduce the effects of environmental lighting on sensor color. Moreover, color reference markers may be imaged in combination with the intraoral sensor to provide a known reference for color adjustments to the image data. Other techniques that may be used to improve accuracy include region of interest extraction, feature extraction, color space conversion, feature dimensionality reduction, pH prediction modeling, and/or sensor calibration.

FIGS. 17A-17E schematically illustrate various techniques for obtaining image data of an intraoral sensor, in accordance with embodiments of the present technology. The embodiments of FIGS. 17A-17E can be used to mitigate and/or compensate for the effects of variations in environmental lighting conditions, thus producing more consistent and accurate color data for downstream analysis.

Referring first to FIG. 17A, in some embodiments, at least one image of a dental appliance 1700a including an intraoral sensor 1702 and a color reference marker 1704 is captured. The intraoral sensor 1702 and color reference marker 1704 can be any of the embodiments described herein, e.g., in Section I above. The image may be obtained using any suitable optical sensing device 1706, such as a camera of a mobile device, a web camera, a DSLR camera, etc. In the illustrated embodiment, the image is captured without using camera flash (“no-flash image”). The resulting image can include a first region depicting the color of the intraoral sensor 1702 (“sensor region 1708”) and a second region depicting the color of the color reference marker 1704 (“reference region 1710”). Since the color of the color reference marker 1704 is known and does not change with varying pH conditions, the color of the reference region 1710 can thus be used to correct the color of the sensor region 1708 to compensate for variations in lighting conditions.

Referring next to FIG. 17B, in some embodiments, at least one image of a dental appliance 1700b including an intraoral sensor 1702 is captured. In the illustrated embodiment, the dental appliance 1700b does not include any color reference markers. Instead, the image is obtained using an optical sensing device 1706 that has camera flash capabilities that are sufficiently bright to reduce and/or minimize the impact of environmental lighting conditions on the color of the intraoral sensor 1702. Thus, the color of the sensor region 1708 in the image with camera flash on (“flash image”) can be relatively consistent even if there are variations in the ambient light.

Referring next to FIG. 17C, in some embodiments, at least two images of the dental appliance 1700b are captured: a no-flash and a flash image. The colors of the sensor regions 1708 in the no-flash image and the flash image can be compared and utilized in the subsequent color analysis. This approach may be beneficial, for example, in situations where effects of environmental lighting are still present in the flash image due to excessive distance between the optical sensing device 1706 and the intraoral sensor 1702.

Referring next to FIG. 17D, in some embodiments, at least one flash image of the dental appliance 1700a with the intraoral sensor 1702 and the color reference marker 1704 is captured. This approach combines the use of flash to reduce the effect of environmental lighting conditions, and the use of the reference region 1710 to inform color adjustments to the sensor region 1708, which may provide additional enhancements in the accuracy of color measurements.

Referring next to FIG. 17E, in some embodiments, at least two images of the dental appliance 1700a arc captured: a no-flash image and a flash image. This approach provides additional information that may be utilized in the color measurement process: the color of the sensor region 1708 in the no-flash image, the color of the sensor region 1708 in the flash image, the color of the reference region 1710 in the no-flash image, and the color of the reference region 1710 in the flash image.

FIG. 18 is a flow diagram illustrating a workflow 1800 for extracting features from image data of an intraoral sensor, in accordance with embodiments of the present technology. The workflow 1800 can be performed using any of the systems and devices described herein, such as any of the embodiments of FIGS. 1A-15B. In some embodiments, some or all of the processes of the workflow 1800 are implemented as computer-readable instructions (e.g., program code) that are configured to be executed by one or more processors of a computing device, such as any of the computing devices 1108 described in connection with FIG. 11.

The workflow 1800 can begin at block 1802 with receiving at least one image depicting an intraoral sensor on a dental appliance. The image can be a color image (e.g., RGB image) obtained using a camera of a mobile device, a web camera, a DSLR camera, etc. The image may be obtained with or without flash, e.g., as previously discussed with respect to FIGS. 17A-17E. Optionally, the image can also depict a color reference marker proximate to the intraoral sensor.

At block 1804, the workflow 1800 can include preprocessing the image. Image preprocessing can be performed, for example, to improve the accuracy of color values by removing portions of the image affected by noise, camera glare, and/or other artifacts that may interfere with color analysis. In some embodiments, the preprocessing involves applying one or more filters and/or transforms to the image, such as a Gaussian blur, median filter, bilateral filter, wavelet transform, etc. Alternatively or in combination, other types of preprocessing can be performed, such as size adjustments (e.g., cropping, enlarging) and/or orientation adjustments (e.g., rotating).

At block 1806, the workflow 1800 can continue with extracting one or more color values from the image. The color values can be extracted from one or more regions of interest (ROIs) in the image, e.g., a sensor region corresponding to the intraoral sensor and/or a reference region corresponding to the color reference marker (if present). In some embodiments, the process of block 1806 includes identifying and/or segmenting the ROI from the image using a software algorithm, such as one or more computer vision algorithms (e.g., shape detection algorithms) and/or machine learning algorithms (e.g., convolutional neural networks and/or other types of deep learning models). Alternatively or in combination, the identifying and/or segmenting can be performed based on user input, e.g., a user manually identifies the ROI in the image.

The process of block 1806 can include calculating a representative color value for each ROI. The representative color value can be, for example, the mean or median color value across the entire ROI. Alternatively, the representative color value can be the mean or median color value across a portion of the ROI only, such as the center of the ROI, the portion of the ROI with the most uniform and/or reliable color information, etc. Optionally, multiple representative color values can be calculated for a single ROI, e.g., by sampling color values at different quadrants, randomly selected locations, etc. Alternatively, the color values for all locations in the ROI may be kept and used in the subsequent processes of the workflow 1800.

At block 1808, the workflow 1800 can include converting the color value into a different color space. This process can be advantageous, for example, in embodiments where the initial color values obtained in block 1806 are in an RGB color space, since the values of the R, G, and B channels may vary according to the luminance of the image. To provide more consistent features that are robust to different lighting conditions, the RGB color values may be converted into a different color space such as LAB, YCrCb, or HSV. For instance, the LAB color space separates luminance (L) and chrominance (A and B) into separate channels, thus allowing color information that is less affected or not affected by lighting conditions to be extracted. Similar, the YCrCb color space includes separate luminance (Y), chroma red (Cr), and chroma blue (Cb) channels, thus allowing for extraction of luminance-independent color information. The particular color space can be selected based on the desired color features for the subsequent analysis (e.g., if there are certain colors that are more likely to be present than other colors) and/or to facilitate dimensionality reduction in subsequent processing.

At block 1810, the workflow 1800 can continue with reducing the dimensionality of features resulting from the color space conversion. In some embodiments, conversion into a different color space results in features (e.g., channels) that do not need to be used in the color analysis and/or may affect the accuracy of the color analysis. For instance, features that are significantly influenced by environmental lighting conditions (e.g., luminance channels) can be removed. As another example, features that are not important to the color analysis (e.g., channels for colors that are not exhibited by the sensor) can be removed. Optionally, in some embodiments, the color space conversion process of block 1808 can involve converting color values into multiple different color spaces, and some or all of the channels of the different color spaces can be combined (e.g., via summing, averaging, and/or other mathematical operations).

At block 1812, the workflow 1800 can output one or more features for subsequent color analysis. The features can include the values of one or more color channels (e.g., the color channels remaining after feature dimensionality reduction). Alternatively or in combination, the features can include statistics calculated from the values of one or more color channels, such as mean, median, standard deviation, etc.

FIGS. 19A-19E illustrate workflows for determining pH values from image data using a pH prediction model, in accordance with embodiments of the present technology. Referring first to FIG. 19A, a workflow 1900a can include obtaining at least one non-flash image including a sensor region 1902a depicting an intraoral sensor and a reference region 1904a depicting a color reference marker. The image can be obtained as previously described, e.g., in connection with FIG. 17A. A feature extraction process can be performed on the sensor region 1902a and the reference region 1904a to extract features 1906a and 1908a, respectively, e.g., as discussed above with respect to FIG. 18. For example, the features 1906a and 1908a can each include color values from one or more luminance-independent channels of a color space (e.g., a LAB, YCrCb, or HSV color space).

The features 1906a, 1908a can be input into a pH prediction model 1910a, and the pH prediction model 1910a can determine a corresponding pH value 1912a based on the features 1906a, 1908a. The pH prediction model 1910a can be or include any suitable type of software-based model, such as a mathematical model, a rule-based model, a machine learning model, or a combination thereof. In some embodiments, the pH prediction model 1910a uses the features 1908a from the reference region 1904a to adjust the features 1906a from the sensor region 1902a (e.g., to compensate for environmental lighting), and can then use the adjusted features 1906a to determine the pH value 1912a. For instance, the pH prediction model 1910a can determine the pH value 1912a using a calibration curve, lookup table, mapping function, etc., that represents the relationship between color features and pH conditions. As another example, the pH prediction model 1910a can be a machine learning model (e.g., a regression model) that predicts the pH value 1912a from the features 1906a, 1908a together, where the machine learning model is trained to use the features 1908a from the reference region 1904a to compensate for variable lighting that may affect the features 1906a from the sensor region 1902a.

Referring next to FIG. 19B, in some embodiments, a workflow 1900b includes obtaining at least one flash image including a sensor region 1902b depicting an intraoral sensor. The image can be obtained as previously described, e.g., in connection with FIG. 17B. A feature extraction process can be performed on the sensor region 1902b to extract features 1906b, e.g., as discussed above with respect to FIG. 18. The features 1906b can be input into a pH prediction model 1910b, and the pH prediction model 1910b can determine a corresponding pH value 1912b based on the features 1906b. The pH prediction model 1910b can be or include any suitable type of software-based model, such as a mathematical model, a rule-based model, a machine learning model, or a combination thereof. The pH prediction model 1910b can assume that the camera flash eliminates most or all of the effects of environmental lighting conditions on the color of the sensor region 1902b, such that a reference region is not needed.

Referring next to FIG. 19C, in some embodiments, a workflow 1900c includes obtaining at least one non-flash image including a sensor region 1902a depicting an intraoral sensor, and at least one flash image including a sensor region 1902b depicting the intraoral sensor. The images can be obtained as previously described, e.g., in connection with FIG. 17C. A feature extraction process can be performed on the sensor regions 1902a, 1902b to extract features 1906a, 1906b, respectively, e.g., as discussed above with respect to FIG. 18. The features 1906a, 1906b can be input into a pH prediction model 1910c, and the pH prediction model 1910c can determine a corresponding pH value 1912c based on the features 1906a, 1906b. The pH prediction model 1910c can be or include any suitable type of software-based model, such as a mathematical model, a rule-based model, a machine learning model, or a combination thereof. In some embodiments, the pH prediction model 1910c uses the features 1906a from the non-flash image and the features 1906b from the flash image to identify and isolate the effects of environmental lighting on the color of the sensor regions 1902a, 1902b.

Referring next to FIG. 19D, in some embodiments, a workflow 1900d includes obtaining at least one flash image including a sensor region 1902b depicting an intraoral sensor and a reference region 1904b depicting a color reference marker. The image can be obtained as previously described, e.g., in connection with FIG. 17D. A feature extraction process can be performed on the sensor region 1902b and reference region 1904b to extract features 1906b, 1908b, respectively, e.g., as discussed above with respect to FIG. 18. The features 1906b, 1908b can be input into a pH prediction model 1910d, and the pH prediction model 1910d can determine a corresponding pH value 1912d based on the features 1906b, 1908b. The pH prediction model 1910d can be or include any suitable type of software-based model, such as a mathematical model, a rule-based model, a machine learning model, or a combination thereof. In some embodiments, the pH prediction model 1910d uses the features 1908b from the reference region 1904b to adjust the features 1906b from the sensor region 1902b (e.g., to compensate for environmental lighting), and can then use the adjusted features 1906b to determine the pH value 1912d. Optionally, the pH prediction model 1910d can be a machine learning model that predicts the pH value 1912d from the features 1906b, 1908b together, where the machine learning model is trained to use the features 1908b from the reference region 1904b to compensate for variable lighting that may affect the features 1906b from the sensor region 1902b.

Referring next to FIG. 19E, in some embodiments, a workflow 1900e includes obtaining at least one non-flash image including a sensor region 1902a depicting an intraoral sensor and a reference region 1904a depicting a color reference marker, and at least one flash image including a sensor region 1902b depicting the intraoral sensor and a reference region 1904b depicting the color reference marker. The image can be obtained as previously described, e.g., in connection with FIG. 17E. A feature extraction process can be performed on the sensor regions 1902a, 1902b and reference regions 1904a, 1904b to extract features 1906a, 1906b, 1908a, 1908b, respectively, e.g., as discussed above with respect to FIG. 18. The features 1906a, 1906b, 1908a, 1908b can be input into a pH prediction model 1910c, and the pH prediction model 1910c can determine a corresponding pH value 1912e based on the features 1906a, 1906b, 1908a, 1908b. The pH prediction model 1910e can be or include any suitable type of software-based model, such as a mathematical model, a rule-based model, a machine learning model, or a combination thereof. The pH prediction model 1910e can use the features 1908a, 1908b from the reference regions 1904a, 1904b to compensate for variable lighting that may affect the features 1906a, 1906b from the sensor regions 1902a, 1902b. Alternatively or in combination, the features 1906b, 1908b from the flash images can be used to identify and isolate the effect of the environmental lighting on the features 1906a, 1908a from the non-flash images.

Although certain embodiments of FIGS. 19A-19E are described with respect to pH prediction models that determine a pH value based on features extracted from image data, in other embodiments, the pH prediction models herein may determine the pH value from the image data directly, without requiring a feature extraction step. For instance, a machine learning model that operates on image data, such as a convolutional neural network or other deep learning model, may be trained to analyze images (e.g., flash and/or non-flash images) or regions thereof (e.g., sensor regions and/or reference regions), and to output a pH value corresponding to the color of the intraoral sensor. In such embodiments, the training data for the machine learning model can include a plurality of images of intraoral sensors and/or reference markers at various pH and/or lighting conditions, with each image being labeled with the actual pH value. Training may be conducted using supervised learning techniques, e.g., using backpropagation.

Additional types of machine learning algorithms that may be used in the pH prediction models described herein include any of the following: a regression algorithm (e.g., ordinary least squares regression, linear regression, logistic regression, stepwise regression, multivariate adaptive regression splines, locally estimated scatterplot smoothing), an instance-based algorithm (e.g., k-nearest neighbor, learning vector quantization, self-organizing map, locally weighted learning), regularization algorithms (e.g., ridge regression, least absolute shrinkage and selection operator, elastic net, least-angle regression), a decision tree algorithm (e.g., Iterative Dichotomiser 3 (ID3), C4.5, C5.0, classification and regression trees, chi-squared automatic interaction detection, decision stump, M5), a Bayesian algorithm (e.g., naïve Bayes, Gaussian naïve Bayes, multinomial naïve Bayes, averaged one-dependence estimators, Bayesian belief networks, Bayesian networks, hidden Markov models, conditional random fields), a clustering algorithm (e.g., k-means, single-linkage clustering, k-medians, expectation maximization, hierarchical clustering, fuzzy clustering, density-based spatial clustering of applications with noise (DBSCAN), ordering points to identify cluster structure (OPTICS), non-negative matrix factorization (NMF), latent Dirichlet allocation (LDA), Gaussian mixture model (GMM)), an association rule learning algorithm (e.g., apriori algorithm, equivalent class transformation (Eclat) algorithm, frequent pattern (FP) growth), an artificial neural network algorithm (e.g., perceptrons, neural networks, back-propagation, Hopfield networks, autoencoders, Boltzmann machines, restricted Boltzmann machines, spiking neural nets, radial basis function networks), a deep learning algorithm (e.g., deep Boltzmann machines, deep belief networks, convolutional neural networks, stacked auto-encoders), a dimensionality reduction algorithm (e.g., PCA, independent component analysis (ICA), principle component regression (PCR), partial least squares regression (PLSR), Sammon mapping, multidimensional scaling, projection pursuit, linear discriminant analysis, mixture discriminant analysis, quadratic discriminant analysis, flexible discriminant analysis), an ensemble algorithm (e.g., boosting, bootstrapped aggregation, AdaBoost, blending, gradient boosting machines, gradient boosted regression trees, random forest), or suitable combinations thereof. The type of machine learning algorithm and algorithm architecture can be selected based on the type of input data (e.g., images versus extracted features, data from a single time point versus data from multiple time points), type of output data (e.g., a quantitative value, a qualitative assessment, a classification), etc.

FIGS. 20A-20C illustrate workflows for calibrating a pH prediction model, in accordance with embodiments of the present technology. Calibration may be beneficial for improving the accuracy of the pH prediction model to compensate for sensor-to-sensor variations, e.g., due to variability in manufacturing, storage duration and/or conditions, user handling, etc. The calibration techniques of FIGS. 20A-20C may be used with any embodiment of the dental appliances and intraoral sensors described herein, and may be applied to any of the pH prediction models described herein.

FIG. 20A illustrates a workflow 2000a for calibrating a pH prediction model for a dental appliance 2002 with an intraoral sensor, in accordance with embodiments of the present technology. At an initial time point (to), the dental appliance 2002 with the intraoral sensor is exposed to a calibration solution 2004, e.g., by immersing the dental appliance 2002 and intraoral sensor to the calibration solution 2004, applying the calibration solution 2004 directly to the intraoral sensor (e.g., via a dropper), etc. The calibration solution 2004 can be a buffer solution having a known pH value 2006. The calibration solution 2004 may be provided as a part of a kit including the intraoral sensor or may be provided separately from the intraoral sensor. After exposure to the calibration solution 2004, at least one calibration image 2008 of the intraoral sensor can be obtained, e.g., in accordance with the imaging techniques described herein.

The known pH value 2006 and image 2008 can then be used in a retraining process 2010 for a pretrained model 2012 to produce a calibrated model 2014. In some embodiments, the pretrained model 2012 is a machine learning model (e.g., a regression model, a convolutional neural network) that has previously been trained to predict pH values based on image data of intraoral sensors and/or features extracted from image data, as discussed elsewhere herein. The pretrained model 2012 may be considered a “generic” or “non-calibrated” model in that the model has not been trained specifically on data for the particular intraoral sensor and dental appliance 2002, and thus may not account for the particular properties, behavior, variability, etc., exhibited by the intraoral sensor. Accordingly, the retraining process 2010 can adjust the parameters of the pretrained model 2012 (e.g., regression parameters, neural network weights) to customize the pretrained model 2012 to the particular intraoral sensor and dental appliance 2002. The retraining process 2010 can include fine-tuning model parameters via transfer learning and/or other techniques known to those of skill in the art.

The calibrated model 2014 can be saved and used to determine the pH of a subject's intraoral cavity. For example, at a subsequent time point (t), a current image 2016 of the dental appliance 2002 and intraoral sensor can be obtained and input into the calibrated model 2014 to determine a predicted pH value 2018, in accordance with the methods described herein.

The calibration workflow 2000a can be performed one or more times while the subject is using the dental appliance 2002 and intraoral sensor. For example, the calibration workflow 2000a can be performed before the subject begins wearing the dental appliance 2002 and intraoral sensor, e.g., at the manufacturer's facility, at the clinician's office, or at the subject's home when the subject initially receives the dental appliance 2002 and intraoral sensor. Optionally, the calibration workflow 2000a can also be performed after the subject has already begun wearing the dental appliance 2002 and intraoral sensor, e.g., at predetermined time intervals recommended by the manufacturer or clinician, if there is reason to believe that the calibrated model 2014 is no longer sufficiently accurate, etc. The calibration workflow 2000a may be performed by the subject, by the subject's clinician, by the manufacturer of the dental appliance 2002 and intraoral sensor, or suitable combinations thereof.

The calibration workflow 2000a can be performed by any suitable computing device or combination of computing devices. In some embodiments, for example, the images 2008, 2016 are obtained by a local client device (e.g., a computing device of the subject or the subject's clinician), the pretrained model 2012 is stored on a remote server (e.g., a cloud computing server), and the retraining process 2010 is performed by the remote server. As another example, the images 2008, 2016 can be obtained by a local client device (e.g., a computing device of the subject or the subject's clinician), the pretrained model 2012 is stored on a remote server (e.g., a cloud computing server), and the retraining process 2010 is performed by the local client device. In yet another example, the images 2008, 2016 can be obtained by a local client device (e.g., a computing device of the subject or the subject's clinician), the pretrained model 2012 is stored on the local client device, and the retraining process 2010 is performed by the local client device.

The calibration workflow 2000a may be optional, e.g., subjects who do not wish to perform calibration can still obtain reasonably accurate pH predictions with the pretrained model 2012, while subjects who wish to have more accurate pH predictions can perform calibration to produce a customized calibrated model 2014.

FIGS. 20B and 20C illustrate another workflow 2000b for calibrating a pH prediction model for a dental appliance 2002 with an intraoral sensor, in accordance with embodiments of the present technology. Referring first to FIG. 20B, the workflow 2000b can include exposing the dental appliance 2002 with the intraoral sensor to a calibration solution 2004 having a known pH value 2006 at an initial time point (to) and then obtaining least one calibration image 2008 of the intraoral sensor, e.g., as discussed above in connection with FIG. 20A. At a subsequent time point (t), a current image 2016 of the dental appliance 2002 and intraoral sensor can be obtained.

The known pH value 2006, the calibration image 2008, and the current image 2016 can be input into a pretrained model 2018. In some embodiments, the pretrained model 2018 is a machine learning model (e.g., a regression model, a convolutional neural network) that has previously been trained to predict pH values based on image data of intraoral sensors and/or features extracted from image data, as discussed elsewhere herein. The pretrained model 2018 can also be trained to customize the prediction to a particular intraoral sensor based on sensor-specific calibration data, e.g., the known pH value 2006 and calibration image 2008. For instance, as shown in FIG. 20C, by comparing the calibration image 2008 to the current image 2016, feature changes due to sensor variations may be eliminated, thus isolating the effects of feature changes due to pH conditions (e.g., the different between the current pH and the calibration pH). Thus, the predicted pH value 2020 produced by the pretrained model 2018 can account for the particular properties, behavior, variability, etc., exhibited by the intraoral sensor, without requiring retraining of the pretrained model 2018.

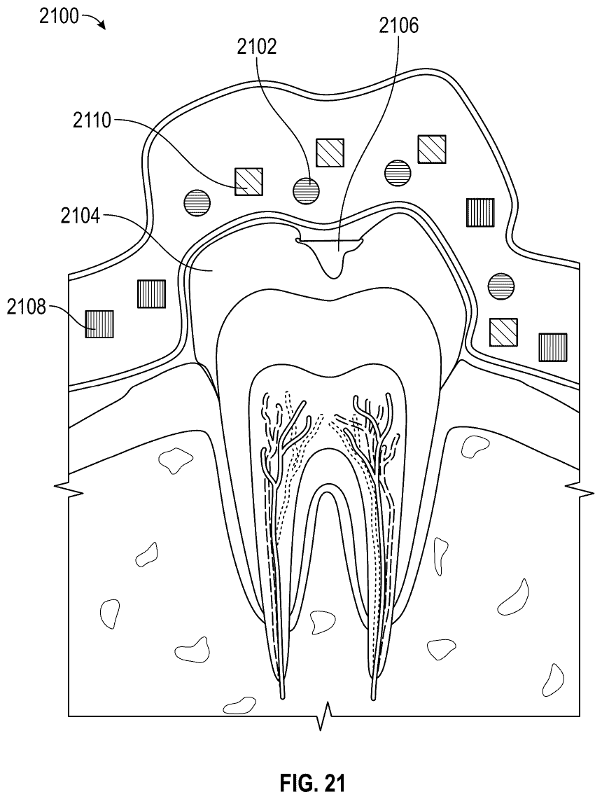

Although certain embodiments of the present technology are described in connection with sensing of a subject's intraoral pH, this is not intended to be limiting. It will be appreciated that the devices, systems, and methods described herein may alternatively or additionally be used for sensing of other parameters that may be relevant to a subject's intraoral health. For example, FIGS. 21-23B illustrate devices and compositions for colorimetric detection of dental caries. The embodiments of FIGS. 21-23B may be combined with the any of the other embodiments described herein, such as the intraoral sensors and associated devices, systems, and methods of FIGS. 1A-20C.

FIG. 21 is a partially schematic illustration of a portion of a dental appliance 2100 configured for detection of dental caries, in accordance with embodiments of the present technology. Bacterial species that are associated with dental decay may produce chemical species 2102 (e.g., volatile sulfur compounds (VSCs)) as metabolites as they proliferate. For instance, Streptococcus mutans produces various VSCs such as hydrogen sulfide, methylmercaptan, methanthiol, etc. Thus, the presence of chemical species 2102 on or proximate to a tooth 2104 can indicate the location of dental caries 2106 on the tooth 2014.

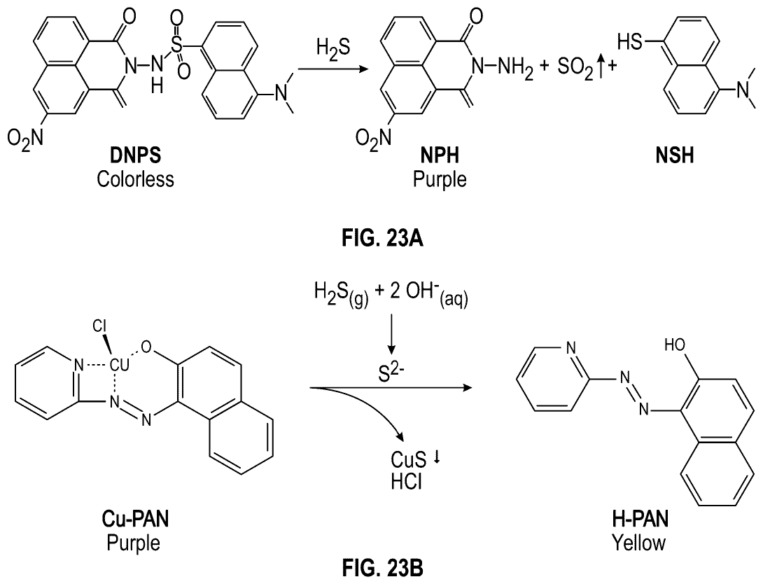

The dental appliance 2100 can include at least one colorimetric molecule (e.g., a dye) that reacts with the chemical species 2012, thereby providing a visual indication of the location of dental caries 2016. In the illustrated embodiment, for example, the dental appliance 2100 includes a colorimetric molecule having a first form 2108 with a first color, and a second form 2110 with a second, different color. The first form 2108 can be an unreacted form of the colorimetric molecule, and the second form 2110 can be a reacted form that is generated when the colorimetric molecule is exposed to the chemical species 2102. Accordingly, the color change of the colorimetric molecule can correlate to the presence of the chemical species 2102, and thus, the presence of bacteria associated with dental decay. The type and/or intensity of the color change can be adjusted based on the type of colorimetric molecule(s) used, e.g., as discussed further below in connection with FIGS. 23A and 23B.

The colorimetric molecule can be incorporated on or within the dental appliance 2100 (e.g., via covalent conjugation, physical encapsulation, and/or other immobilization techniques), such that the locations where the colorimetric molecule changes in color correspond to the locations of the dental caries 2106 on the tooth 2104. For instance, in embodiments where the dental appliance 2100 includes a shell with a cavity for receiving the tooth 2014, the colorimetric molecule can be localized primarily or entirely to the internal surface of the shell adjacent to the cavity, e.g., to prevent unintentional reactions with chemical species originating from other locations in the intraoral cavity. The dental appliance 2100 can thus provide accurate identification of the locations of dental caries 2016, as well as early detection of dental caries 2016 that are hidden or otherwise difficult to detect through conventional techniques (e.g., visual-tactile inspection). Moreover, detection of dental caries 2106 can be performed without requiring an in-person appointment, thereby improving convenience and allowing for self-monitoring and management of intraoral health.

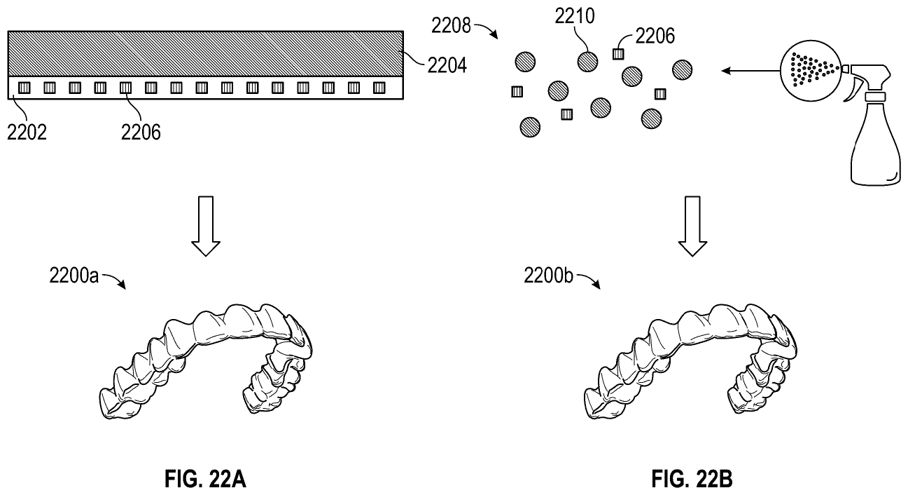

FIGS. 22A and 22B are partially schematic illustration of various techniques for fabricating dental appliances with colorimetric molecules for detection of dental caries, in accordance with embodiments of the present technology. Referring first to FIG. 22A, a dental appliance 2200a for detection of dental caries may be fabricated by applying a sensor layer 2202 onto a portion 2204 of the dental appliance 2200a. For example, in embodiments where the dental appliance 2200a include a shell having a plurality of teeth-receiving cavities, the sensor layer 2202 can be coupled to a surface of the shell, e.g., an interior surface adjacent to the teeth-receiving cavities. The sensor layer 2202 can be a prefabricated material layer including a plurality of colorimetric molecules 2206 that react with chemical species indicative of dental caries. In some embodiments, the prefabricated material layer includes a base material (e.g., a polymer matrix) and the colorimetric molecules 2206 are covalently conjugated to and/or physically entrapped within the base material. The sensor layer 2202 can be fabricated using various techniques, e.g., casting, molding, extrusion, additive manufacturing, etc.

Referring next to FIG. 22B, a dental appliance 2200b for detection of dental caries may be fabricated by applying a sensor coating 2208 to a portion of the dental appliance 2100b. For example, in embodiments where the dental appliance 2200a include a shell having a plurality of teeth-receiving cavities, the sensor coating 2208 can be applied to a surface of the shell, e.g., an interior surface adjacent to the teeth-receiving cavities. The sensor coating 2208 can be applied using various coating techniques, such as spray coating, dip coating, spin coating, etc.

The sensor coating 2208 can include a plurality of colorimetric molecules 2206 that react with chemical species indicative of dental caries, and a base material 2210 (e.g., a polymeric coating material in colloidal form). The colorimetric molecules 2206 may be physically mixed with the base material 2210 or may be covalently coupled to the base material 2210. Optionally, the colorimetric molecules 2206 may form a colloidal phase in the base material 2210, and may become immobilized within the coating material 2210 after application to the dental appliance 2100b.

Various types of colorimetric molecules may be used for detection of chemical species associated with dental caries. The colorimetric molecules can be any biocompatible molecule that exhibits a color change upon exposure to a chemical species of interest and is sufficiently stable under use conditions (e.g., high temperature, pH changes, exposure to light, exposure to moisture, physical abrasion). For example, as shown in FIG. 23A, 5-(dimethylamino)-N-(5-nitro-1,3-dioxo-1H-benzo[de] isoquinolin-2 (3H)-yl) naphthalene-1-sulfonamide (DNPS) (colorless) reacts with hydrogen sulfide to produce naphthalimide hydrazone (NPH) (purple) and dansyl thiol (NSH). As another example, as shown in FIG. 23B, copper 1-(2-pyridylazo)-2-naphtol (PAN) (Cu-PAN, purple) reacts with hydrogen sulfide to produce H-PAN (yellow). In a further example, Au@Ag nanorods change in color from colorless to black when reacted with sulfur compounds.

In some embodiments, the color change of the colorimetric molecules is irreversible, e.g., the colorimetric molecule does not revert back to its initial color even after the chemical species are no longer present. This approach may be beneficial, for example, for ensuring stability of the color change. Alternatively, the color change may be reversible, e.g., the colorimetric molecule may revert back to its initial color when the dental caries are no longer present. The reversibility or irreversibility of the reaction can be selected to provide flexibility on how monitoring is performed and/or to account for recovery from dental caries.

In embodiments where the colorimetric molecule is combined with a base material (e.g., a polymeric matrix or coating material), the base material can be selected to immobilize the colorimetric molecule without interfering with the chemical reaction between the colorimetric molecule and the chemical species of interest. Moreover, the base material can allow chemical species from an external location to diffuse into the base material and access the chemical species. Such properties can be controlled by tuning material parameters such as chemical composition, crosslinking density, porosity, etc. Examples of base materials that may be used include biocompatible polymers, such as agarose, cellulose and derivatives thereof (e.g., carboxymethylcellulose), chitosan, gelatin, pectin, polydimethylsiloxane (PDMS), pHEMA, polyacrylamide, polyurethane, PVA, starch, and combinations (e.g., copolymers, mixtures) thereof.

Although the embodiments of FIGS. 21-23B are described herein in connection with detection of chemical species associated with dental caries, it will be appreciated that the techniques of FIGS. 21-23B may be used to produce dental appliances with colorimetric molecules for detection of chemical species associated with other types of oral diseases or conditions and/or other types of parameters relevant to oral health.

In some embodiments, the present technology provides devices, systems, and methods for monitoring compliance of a subject with a dental treatment plan (“compliance monitoring”). Compliance monitoring may include determining whether a subject has worn a dental appliance for a length of time prescribed by the dental treatment plan, e.g., in embodiments where insufficient wear time may reduce the efficacy of appliance-based therapy. In some embodiments, compliance monitoring is performed based on an indicator coupled to a dental appliance (referred to herein as a “compliance indicator”), where the indicator exhibits a color change that is correlated to the wear time of the dental appliance. The change may be triggered by exposure to intraoral conditions, such as pH, temperature, humidity, intraoral chemical species, etc. Compliance monitoring and sensors are further discussed in U.S. Patent Publication No. 2024/0206740 and U.S. patent application Ser. No. 18/820,196, which are incorporated by reference herein in their entirety.

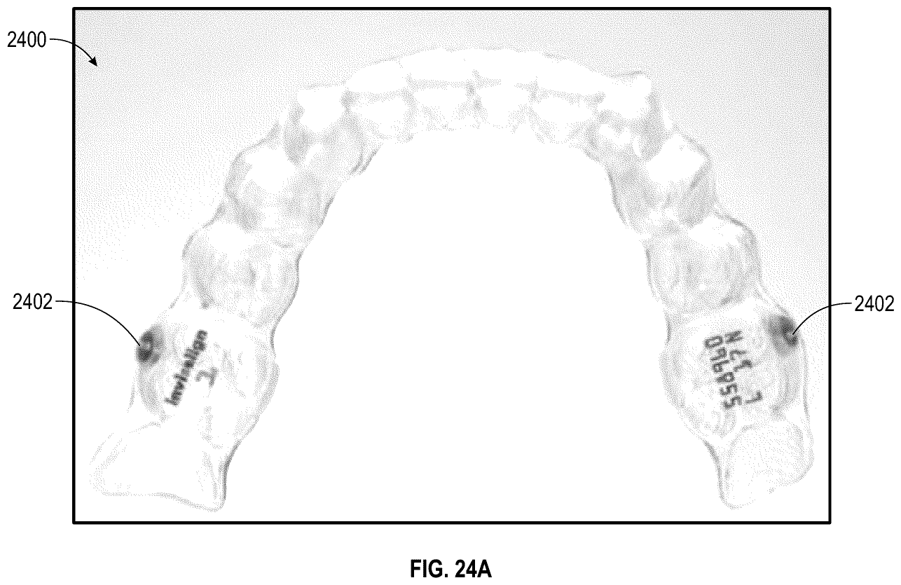

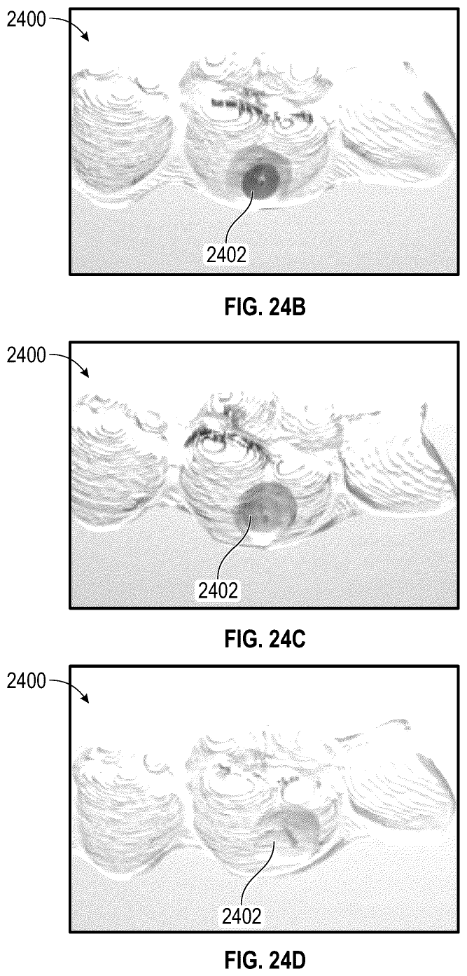

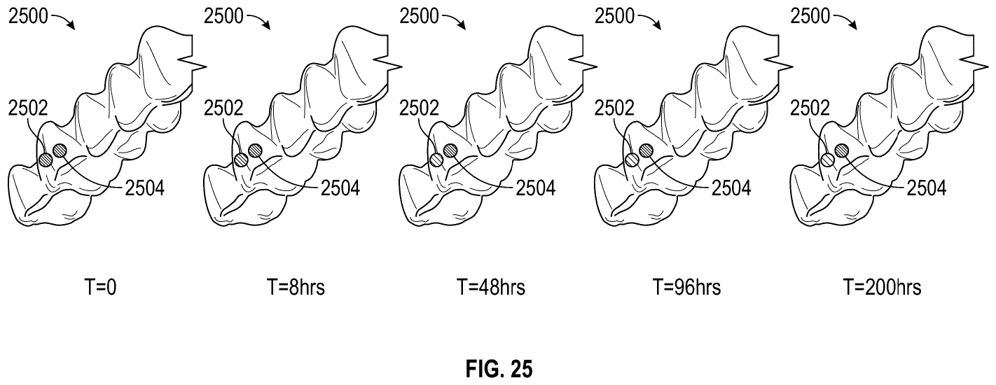

FIGS. 24A-25 illustrate examples of dental appliances with compliance indicators, in accordance with embodiments of the present technology. The embodiments of FIGS. 24A-25 may be combined with the any of the other embodiments described herein, such as the intraoral sensors and associated devices, systems, and methods of FIGS. 1A-23B.

FIG. 24A is a photograph of a dental appliance 2400 including compliance indicators 2402, and FIGS. 24B-24D illustrate color changes in a compliance indicator 2402 based on wear time, in accordance with embodiments of the present technology. Referring first to FIG. 24A, the dental appliance 2400 can include a shell having a plurality of cavities for receiving a patient's teeth, and one or more compliance indicators 2402 coupled to or otherwise incorporated into the shell. In the illustrated embodiment, for example, the dental appliance 2400 includes two compliance indicators 2402 at the buccal surfaces of the distal portions of the dental appliance 2400. In other embodiments, the dental appliance 2400 can include a different number of compliance indicators 2402 and/or the compliance indicators 2402 can be positioned at other locations on the shell.

Referring next to FIGS. 24B-24D, the color of the compliance indicator 2402 can change from a first color (e.g., blue) to a second color (e.g., colorless) over time as the subject wears the dental appliance and the compliance indicator 2402 is exposed to intraoral conditions. The rate of the color change reaction can vary according to the prescribed wear time for the dental appliance 2400, e.g., the color change can occur relatively fast if the dental appliance 2400 is intended to be worn for a short period of time (e.g., a few days), and can occur more slowly if the dental appliance 2400 is intended to be worn for a longer period of time (e.g., weeks or months).

The color of the compliance indicator 2402 can be assessed in various ways, such as by direct visual inspection and/or by obtaining images or other data via an optical sensing device (e.g., a camera or spectrophotometer, such as the embodiments of FIGS. 11-15B). In embodiments where data of the compliance indicator 2402 is obtained using an optical sensing device, the data can be processed to detect the color of the compliance indicator 2402, and the color can then be correlated to a wear time, e.g., similar to the techniques for correlating color and pH value described above with respect to FIGS. 16-20C.

FIG. 25 illustrates a dental appliance 2500 including a compliance indicator 2502 and a color reference marker 2504, in accordance with embodiments of the present technology. The dental appliance 2500 can be identical or generally similar to the dental appliance 2400 of FIGS. 24A-24C, except that the dental appliance 2500 also includes a color reference marker 2504 having a fixed color that does not change based on wear time of the dental appliance 2500. The fixed color of the color reference marker 2504 can be used to account for differences in environmental conditions that may affect the detected color of the compliance indicator 2502, e.g., similar to the color reference markers for intraoral sensors described herein with respect to FIGS. 3A-5H.

The color of the compliance indicator 2502 and color reference marker 2504 can be assessed in various ways, such as by direct visual inspection and/or by obtaining images or other data via an optical sensing device (e.g., a camera or spectrophotometer, such as the embodiments of FIGS. 11-15B). In embodiments where data of the compliance indicator 2502 and color reference marker 2504 is obtained using an optical sensing device, the data can be processed to detect the color of the compliance indicator 2502 and color reference marker 2504, and the color can then be correlated to a wear time, e.g., similar to the techniques for correlating color and pH value described above with respect to FIGS. 16-20C.

In some embodiments, the color of a compliance indicator may be affected not only by wear time, but also by other conditions in the subject's intraoral cavity such as temperature and/or intraoral pH. Such conditions may vary based on subject-specific factors, such as body mass (e.g., individuals with higher body mass may have lower mean oral temperatures), sex (e.g., women may have higher oral temperatures than men), ethnicity (e.g., certain ethnic groups may have higher oral temperatures than others), age (e.g., older adults may experience changes in salivary pH and oral temperature), oral volume, health condition (e.g., diabetic patients may have lower salivary pH), medication, surface area to volume (e.g., surface area to volume may be negatively correlated with oral temperature), etc. Thus, the process for determining wear time based on compliance indicator color may need to account for the specific conditions in the subject's intraoral cavity. Accordingly, the present technology provides dental appliances including a compliance indicator configured to change in color based on wear time, and at least one intraoral sensor configured to sense conditions that affect the color of the compliance indicator.

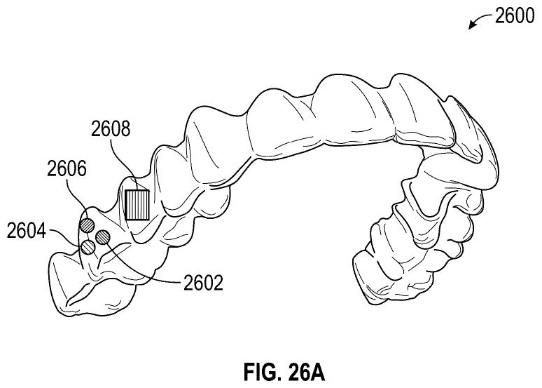

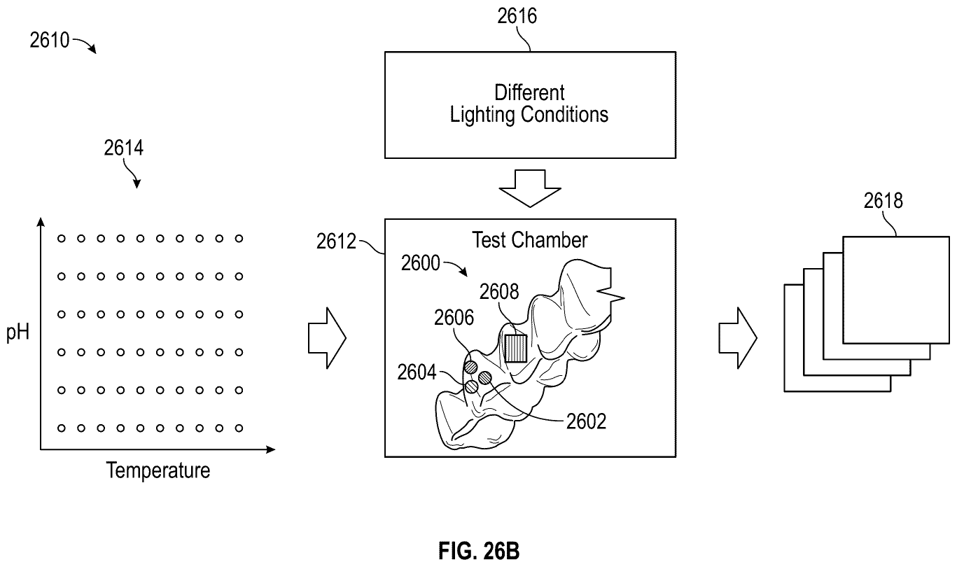

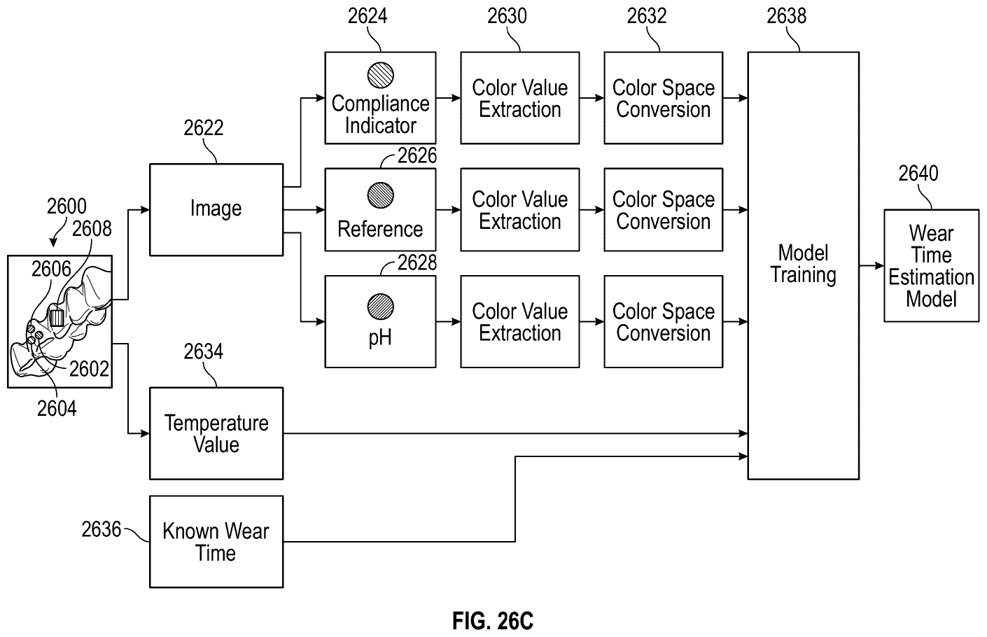

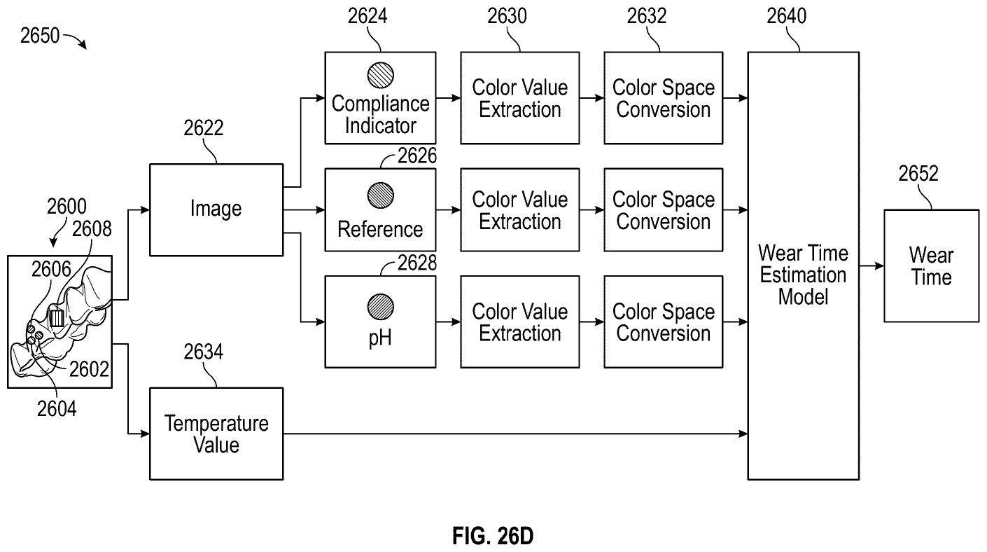

FIG. 26A is a perspective view of a dental appliance 2600 including a compliance indicator 2602, a color reference marker 2604, a pH sensor 2606, and a temperature sensor 2608, in accordance with embodiments of the present technology. The dental appliance 2600 can be worn by a subject as part of a dental treatment for the subject. The compliance indicator 2602 can be configured to change in color when exposed to intraoral conditions to provide an indication of the wear time of the dental appliance 2600, and can be identical or generally similar to the embodiments of FIGS. 24A-25 discussed above. The color reference marker 2604 can have a fixed color that does not change when exposed to intraoral conditions, and can be identical or generally similar to the embodiments of FIGS. 3A-5H and 25 discussed above.

In some embodiments, the pH sensor 2606 is used to provide a visual indication of the subject's intraoral pH, which may affect the color of the compliance indicator 2602 as previously described. For example, the pH sensor 2606 can include at least one pH-sensitive molecule that changes in color based on the pH of the subject's intraoral cavity. The pH sensor 2606 can include any of the embodiments described herein, e.g., in Sections I.A and I.B above.

In some embodiments, the temperature sensor 2608 is used to measure the temperature of the subject's intraoral cavity, which may affect the color of the compliance indicator 2606 as previously described. Any suitable type of temperature sensor 2608 may be used, such as a thermistor, thermocouple, resistance temperature detector, or semiconductor-based temperature sensor, for example. The temperature sensor 2608 may measure a series of temperature values over time, and the measurements may be stored for later use (e.g., on a datastore on the dental appliance 2600 and/or on a separate device).

As shown in FIG. 26A, the compliance indicator 2602, color reference marker 2604, pH sensor 2606, and temperature sensor 2608 can be positioned sufficiently close to each other so that these components are exposed to the same or similar intraoral conditions (e.g., the same pH and temperature). Accordingly, the pH sensor 2606 and temperature sensor 2608 can provide accurate measurements of the pH and temperature conditions that the compliance indicator 2602 is exposed to. This approach can be beneficial in situations where such conditions may vary across different locations in the intraoral cavity. Moreover, by placing the color reference marker 2604 in close proximity to the compliance indicator 2602 and the pH sensor 2606, the fixed color of the color reference marker 2604 can serve as a reference for both the compliance indicator 2602 and the pH sensor 2606, e.g., to account for differences in environmental lighting conditions that may affect the color of the compliance indicator 2606 and the pH sensor 2606 in image data.

The dental appliance 2600 may be configured in many different ways. For instance, in other embodiments, the color reference marker 2604 may be omitted, the pH sensor 2606 may be omitted, and/or the temperature sensor 2608 may be omitted. Moreover, the dental appliance 2600 may include other components not shown in FIG. 26A, such as additional compliance indicators 2602, color reference markers 2604, pH sensors 2602, and/or temperature sensors 2608 at different locations to provide measurement redundancy; and/or other types of sensors for measuring other intraoral conditions that may affect the color of the compliance indicator 2602.

FIG. 26B is a flow diagram illustrating a workflow 2610 for obtaining training data for a wear time estimation model, in accordance with embodiments of the present technology. The workflow 2610 can be implemented using the dental appliance 2600 of FIG. 26A, for example. In some embodiments, the workflow 2610 includes placing the dental appliance 2600 in a test chamber 2612 or other testing apparatus that simulates the intraoral environment with controlled pH, temperature, and/or lighting. The pH and temperature of the test chamber 2612 can be set to a plurality of different values (represented by graph 2614) to capture the effects of varying pH and temperature conditions on the color of the compliance indicator 2602. Alternatively or in combination, different lighting conditions 2616 can be applied to the dental appliance 2600 to assess the effects on the color of the compliance indicator 2602, color reference marker 2604, and/or pH sensor 2606.

A plurality of images 2618 (e.g., photographs) can be obtained of the dental appliance 2600 while the dental appliance 2600 is exposed to different pH, temperature, and/or lighting conditions. The images 2618 can depict the portion of the dental appliance 2600 including the compliance indicator 2602, color reference marker 2604 and/or pH sensor 2606, and can subsequently be processed to identify the color of each of these components, as discussed in greater detail below. Additionally, a temperature value associated with each image 2618 can be obtained from the temperature sensor 2608 and stored. A wear time for each image 2618 can also be obtained and stored, where the wear time corresponds to the duration of time the dental appliance 2600 was exposed to the simulated intraoral environment of the test chamber 2612. The images 2618 and corresponding temperature values can subsequently be used as the training data for the wear time estimation model.

FIG. 26C is a flow diagram illustrating a workflow 2620 for training a wear time estimation model, in accordance with embodiments of the present technology. The wear time estimation model can be used to predict wear time of the dental appliance 2600 of FIG. 26A, for example. In some embodiments, the workflow 2620 includes accessing training data, where the training data includes one or more images 2622 of the dental appliance 2600 and/or one or more corresponding temperature values 2634. The images 2622 can depict the compliance indicator 2602, color reference marker 2604 and/or pH sensor 2606 of the dental appliance 2600 under various pH, temperature, and/or lighting conditions. The temperature values 2634 can be generated by the temperature sensor 2608 and can be associated with the images 2622. The images 2622 and temperature values 2634 may be generated, for example, using the workflow 2610 of FIG. 26B.

In some embodiments, the workflow 2620 includes processing the images 2622 to identify features corresponding to the color of the compliance indicator 2602, color reference marker 2604 and/or pH sensor 2606. The processing may be identical or generally similar to the processing discussed above, e.g., in connection with FIG. 18. For instance, as shown in FIG. 26C, each image 2622 can be analyzed to identify and segment a first region 2624 depicting the compliance indicator 2602, a second region 2626 depicting the color reference marker 2604, and a third region 2628 depicting the pH sensor 2606. The identification and segmentation can be performed using computer vision algorithms, machine learning algorithms, and/or user input. Subsequently, a color value extraction process 2630 can be performed to determine at least one representative color value for each region 2624-2628. The representative color value can, for example, the mean or median color value across the entirety of the region 2624-2628 or only a portion of the region 2624-2628. A color space conversion process 2632 can then be performed to convert the color value for each region 2624-2628 to into a desired color space, e.g., to extract features that are robust to different light conditions. For instance, the color space conversion process 2632 can convert the color values from an RGB color space to a LAB, YCrCb, or HSV color space.

The converted color values and the temperature values 2634 can be labeled with associated known wear times 2636 and provided to a model training process 2638 to train a wear time estimation model 2640. In some embodiments, the wear time estimation model 2640 is a machine learning model, such a regression model, and the training can be performed using supervised learning and/or other techniques known to those of skill in the art. Based on the converted color values, temperature values 2634, and known wear times 2636, the wear time estimation model 2640 can be trained to determine a wear time for the dental appliance 2600 that accounts for the effects of different pH, temperature, and lighting conditions on the color of the compliance indicator 2602. Stated differently, the wear time estimation model 2640 can be trained to use information from the color reference marker 2604, pH sensor 2606, and temperature sensor 2608 in combination with the color from the compliance indicator 2602 to accurately predict how long the dental appliance 2600 has been exposed to intraoral conditions.

FIG. 26D is a flow diagram illustrating a workflow 2650 for determining wear time using a wear time estimation model 2640, in accordance with embodiments of the present technology. The wear time estimation model 2640 can be trained to determine wear time of the dental appliance 2600 as discussed in, e.g., FIG. 26C above. The dental appliance 2600 can be worn by a subject as part of a dental treatment plan. During the treatment plan, one or more images 2622 of the dental appliance 2600 and/or one or more corresponding temperature values 2634 can be obtained. The images 2622 can depict the compliance indicator 2602, color reference marker 2604 and/or pH sensor 2606 of the dental appliance 2600. The temperature values 2634 can be generated by the temperature sensor 2608 and can be associated with the images 2622.

In some embodiments, the workflow 2650 includes processing the images 2622 to identify features corresponding to the color of the compliance indicator 2602, color reference marker 2604 and/or pH sensor 2606. The processing may be identical or generally similar to the processing of FIG. 26B. For instance, each image 2622 can be analyzed to identify and segment a first region 2624 depicting the compliance indicator 2602, a second region 2626 depicting the color reference marker 2604, and a third region 2628 depicting the pH sensor 2606. A color value extraction process 2630 can be performed to determine at least one representative color value for each region 2624-2628, and a color space conversion process 2632 can then be performed to convert the color value for each region 2624-2628 to into a desired color space. The converted color values and the temperature values 2634 can then be input into the wear time estimation model 2640, and the wear time estimation model 2640 can determine a wear time 2652 of the dental appliance 2600. Accordingly, the wear time estimation model 2640 can provide a highly accurate and personalized prediction of wear time, and can allow for immediate adjustments based on the specific conditions within the subject's oral environment for enhanced precision.

The workflows described with respect to FIGS. 26B-26D can be varied in many different ways. In some embodiments, for example, the temperature sensor 2608 can be omitted, such that the training and prediction processes are performed without requiring temperature data. Similarly, the pH sensor 2606 may be omitted, such that the training and prediction processes are performed without requiring pH data. Moreover, the wear time estimation model 2640 can be a machine learning model that is configured to operate directly on the images (e.g., a convolutional neural network), such that color value extraction and color space conversion are optional.

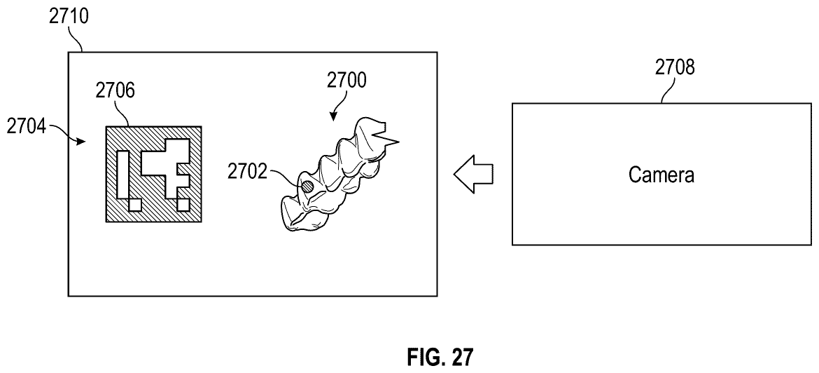

FIG. 27 illustrates a dental appliance 2700 including a compliance indicator 2702 and a color reference marker 2704 separate from the dental appliance 2700, in accordance with embodiments of the present technology. The dental appliance 2700 can be worn by a subject as part of a dental treatment for the subject. The compliance indicator 2702 can be configured to change in color when exposed to intraoral conditions to provide an indication of the wear time of the dental appliance 2700, and can be identical or generally similar to the embodiments of FIGS. 24A-26D discussed above.

In some embodiments, the color reference marker 2704 may not be on the dental appliance 2700, and may instead be on a separate object (e.g., a card, a sticker or printed tag on the interior of the storage case for the dental appliance 2700). In some embodiments, the color reference marker 2704 may be a tag 2706, such as an AR tag. Such a tag may make it easier for a computing device to locate the color reference marker 2704 (e.g., in an image) and identify it as such. This may be especially useful in an embodiment where the color reference marker 2704 is not placed at a known location on the dental appliance 2700 (e.g., instead being placed on a separate object). In such embodiments, a camera 2708 can be used to obtain one or more images 2710 of the compliance indicator 2702 and the tag 2706 under the same or similar environmental (e.g., lighting) conditions. For example, the compliance indicator 2702 and the tag 2706 (which may be present, e.g., on a card or an interior of a dental appliance storage case) may be captured together in a single image 2710. The image 2710 can then be analyzed and the tag 2706 can be identified based on its pattern, and the compliance indicator 2702 can also be identified (e.g., based on its location on the dental appliance 2700 and/or its shape).

In some embodiments, the present technology provides methods for determining wear time of a dental appliance that may be used in addition or alternatively to the sensor-based techniques of FIGS. 26A-27. For example, wear time of a dental appliance may be estimated based on demographic information of the subject, such as body mass index, height, weight, sex, race/ethnicity, age, surface area to volume ratio, oral volume, health condition (e.g., diabetes status), medications, etc. This approach can involve two models: an intraoral condition prediction model that uses demographic information to predict the temperature and pH of a subject's intraoral cavity, and a wear time estimation model that uses the predicted temperature and pH along with images of a compliance indicator to estimate dental appliance wear time.

The intraoral condition prediction model can be developed based on data of intraoral temperature and pH for a plurality of subjects with different demographic factors. The data can be generated experimentally (e.g., by measuring intraoral temperature and pH from multiple subjects), based on preexisting data (e.g., literature values, clinical databases), or suitable combinations thereof. The data can then be used to train the intraoral condition prediction model to predict a particular subject's intraoral temperature and pH based on the demographic information for the subject. In some embodiments, the intraoral condition prediction model is a machine learning model, such as a regression model (e.g., multivariate linear regression model). Optionally, two separate models can be developed-one for predicting intraoral temperature based on demographic information, and one for predicting intraoral pH based on demographic information.

The wear time estimation model can be trained to predict dental appliance wear time for a particular subject, based on the predicted intraoral temperature and pH values produced by the intraoral condition prediction model and based on one or more images of the compliance indicator on the dental appliance worn by the subject. The training data and training process for the wear time estimation model can be generally similar to the embodiments of FIGS. 26B and 26C, except that the dental appliance does not need to have pH and temperature sensors and the workflow processes related to such components can be omitted. The process for determining wear time using the wear time estimation model can be generally similar to the embodiment of FIG. 26D, except that the dental appliance does not need to have pH and temperature sensors and the workflow processes related to such components can be omitted. Instead, the inputs to the wear time estimation model can include the temperature and pH values provided by the intraoral condition prediction model and the image(s) of the compliance indicator. This approach can provide more accurate predictions that account for both the chemical and physical changes the dental appliance undergoes in the subject's mouth, influenced by individual biological factors and/or external conditions, thereby providing a personalized and accurate assessment of wear time.

### II. Dental Appliances and Associated Methods

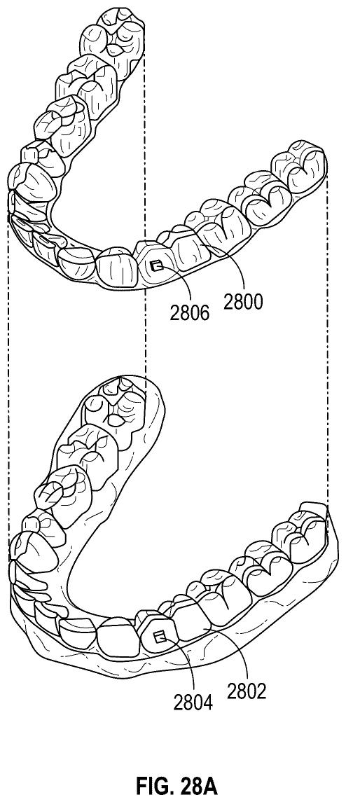

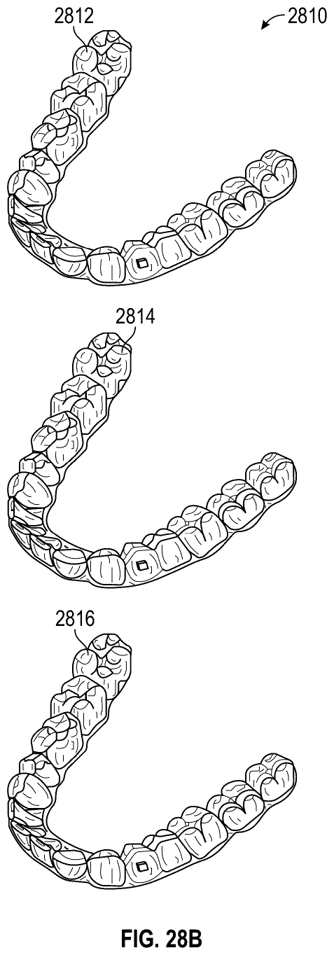

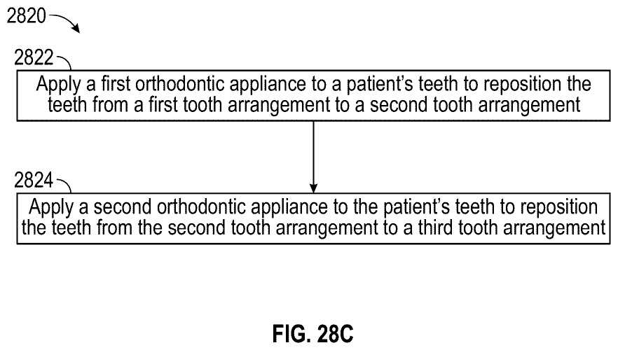

FIG. 28A illustrates a representative example of a tooth repositioning appliance 2800 configured in accordance with embodiments of the present technology. The appliance 2800 can be used in combination with any of the systems, methods, and devices described herein. The appliance 2800 (also referred to herein as an “aligner”) can be worn by a patient in order to achieve an incremental repositioning of individual teeth 2802 in the jaw. The appliance 2800 can include a shell (e.g., a continuous polymeric shell or a segmented shell) having teeth-receiving cavities that receive and resiliently reposition the teeth. The appliance 2800 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 2800 can fit over all teeth present in an upper or lower jaw, or less than all of the teeth. The appliance 2800 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 2800 can be a generic appliance configured to receive the teeth, but not necessarily shaped to match the topography of the patient's teeth. In some cases, only certain teeth received by the appliance 2800 are repositioned by the appliance 2800 while other teeth can provide a base or anchor region for holding the appliance 2800 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 2800 in place over the teeth. In some cases, however, it may be desirable or necessary to provide individual attachments 2804 or other anchoring elements on teeth 2802 with corresponding receptacles 2806 or apertures in the appliance 2800 so that the appliance 2800 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 28B illustrates a tooth repositioning system 2810 including a plurality of appliances 2812, 2814, 2816, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 2810 can include a first appliance 2812 corresponding to an initial tooth arrangement, one or more intermediate appliances 2814 corresponding to one or more intermediate arrangements, and a final appliance 2816 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 28C illustrates a method 2820 of orthodontic treatment using a plurality of appliances, in accordance with embodiments of the present technology. The method 2820 can be practiced using any of the appliances or appliance sets described herein. In block 2822, a first orthodontic appliance is applied to a patient's teeth in order to reposition the teeth from a first tooth arrangement to a second tooth arrangement. In block 2824, a second orthodontic appliance is applied to the patient's teeth in order to reposition the teeth from the second tooth arrangement to a third tooth arrangement. The method 2820 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

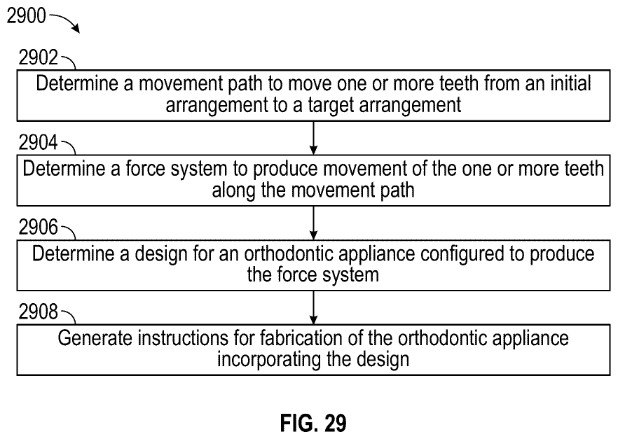

FIG. 29 illustrates a method 2900 for designing an orthodontic appliance, in accordance with embodiments of the present technology. The method 2900 can be applied to any embodiment of the orthodontic appliances described herein. Some or all of the steps of the method 2900 can be performed by any suitable data processing system or device, e.g., one or more processors configured with suitable instructions.

In block 2902, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 2904, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 2904 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 2906, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 2908, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 2900 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 2900 may be performed with any suitable fabrication system or device, such as the embodiments described herein. Some of the steps may be optional, e.g., the process of block 2904 can be omitted, such that the orthodontic appliance is designed based on the desired tooth movements and/or determined tooth movement path, rather than based on a force system. Moreover, the order of the steps can be varied as desired.

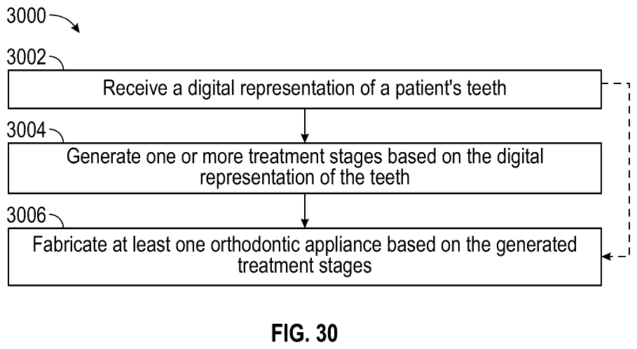

FIG. 30 illustrates a method 3000 for digitally planning an orthodontic treatment and/or design or fabrication of an appliance, in accordance with embodiments. The method 3000 can be applied to any of the treatment procedures described herein and can be performed by any suitable data processing system.

In block 3002 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 3004, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 3006, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 30, design and/or fabrication of an orthodontic appliance, and perhaps a particular orthodontic treatment, may include use of a representation of the patient's teeth (e.g., including receiving a digital representation of the patient's teeth (block 3002)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

In some embodiments, the dental appliances described herein are fabricated partially or entirely using an additive manufacturing technique. Examples of additive manufacturing techniques include, but are not limited to, the following: (1) vat photopolymerization, in which an object is constructed from a vat of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

### EXAMPLES

The present technology is further illustrated by the following non-limiting examples.

### Example 1: Chlorophenol Red-PVA Conjugates for Intraoral Sensing

This example describes the preparation and characterization of intraoral sensors using a chlorophenol red-PVA conjugate.

Chlorophenol red was covalently immobilized onto PVA using the reaction scheme of FIG. 8. Chlorophenol red was activated with an excess amount of formaldehyde, and formed a conjugate with formaldehyde. Specifically, 0.71 g of chlorophenol red, 2 mL of 37% formaldehyde, 0.5 g of NaOH and 6 mL of water were combined in a 3-neck flask with a stir bar. The mixture was purged with nitrogen and refluxing was performed via a condenser. The mixture was then reacted for 4 hours at 95° C. with nitrogen purging to form a chlorophenol red-formaldehyde complex. The chlorophenol red-formaldehyde complex was then crystallized via pH adjustment. Specifically, concentrated HCl was gradually added to the reaction mixture to form a precipitate containing the chlorophenol red-formaldehyde complex. The precipitate was dried at room temperature for one day in a vacuum oven, then dried at 40° C. for a subsequent day in the vacuum oven. Chlorophenol red-PVA conjugates were then prepared by reacting the formaldehyde functional group in the chlorophenol red-formaldehyde complex with the hydroxyl group in PVA to form a covalent bond. Specifically, 10 g of PVA was dissolved in 110 mL of DMSO at 100° C. with nitrogen purging. 0.05 g of the precipitated chlorophenol red-formaldehyde complex was then added, and the mixture was reacted for 3 hours with stirring.

The resulting chlorophenol red-PVA solution was used to prepare sensor films, and unreacted chlorophenol red-formaldehyde complexes were removed through a further washing step. Specifically, a hydrophobic mold was assembled on a fabrication substrate, and a volume of the chlorophenol red-PVA conjugate (approximately 25 μL to 60 μL) was dropped inside the mold to cover the whole confined area. The mold was transferred to an oven at 120° C. and dried overnight. The resulting film included some unreacted chlorophenol red-formaldehyde complexes that leached out upon exposure to a liquid. To remove the unreacted complexes, the dried film was immersed and incubated in a 0.1 M NaOH solution for 1.5 hours. Afterwards, the mold was removed, and the film was washed with DI water and dried in the oven for 30 minutes. The film was then detached from the fabrication substrate, cut into circular pieces, and attached to an aligner using a UV-curable biocompatible adhesive.

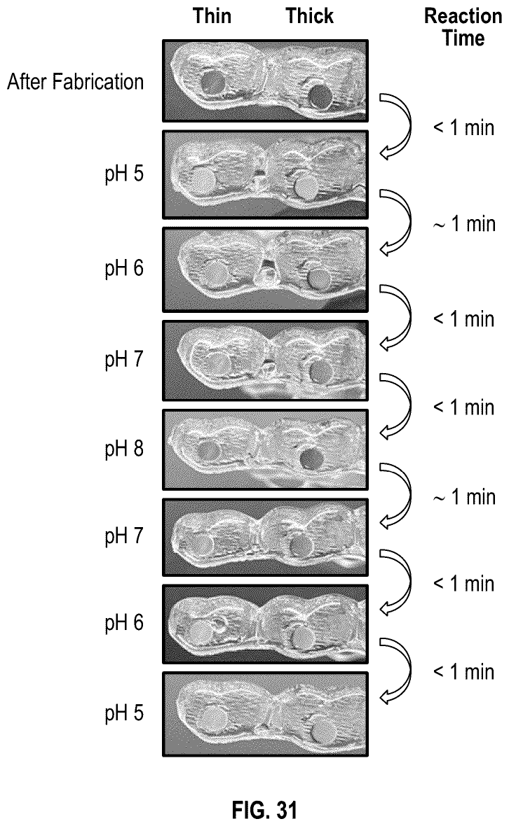

FIG. 31 is a series of photographs illustrating pH testing of chlorophenol red-PVA sensors with two different film thicknesses (“thin”=10 μm to 20 μm, “thick”=40 μm to 60 μm). Aligners with attached sensors were immersed into buffer solutions with different pH values. As shown in FIG. 31, the sensors showed clear, reversible, and rapid color changes (less than 2 minutes) at different pH values. The color was yellow at acidic pH values, orange at neutral pH values, and purple at basic pH values.

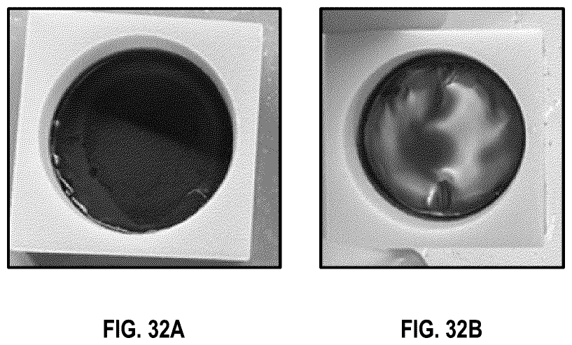

FIGS. 32A and 32B are photographs illustrating the effects of the fabrication substrate on film quality. The properties of the fabrication substrate, such as hydrophobicity and roughness, were found to have a significant impact on the final characteristics of the sensor film, such thickness and homogeneity. A PEEK substrate produced thin homogenous films (FIG. 32A), whereas a poly(vinylidene fluoride) (PVDF) substrate produced uneven films (FIG. 32B). Through the optimization of various fabrication steps such as the mold and fabrication substrate material, drying temperature and duration, NaOH concentration, and incubation time, sensor films with a thickness variability of less than 10% were achieved, and batch-to-batch variations in the film thickness of less than 5% were achieved. The consistency of the sensor thickness impacts the final color intensity and reaction time.

### Example 2: Quantitative pH Measurements Using a Smartphone Application

This example describes pH quantification using a smartphone application that analyzes the color of an intraoral sensor.

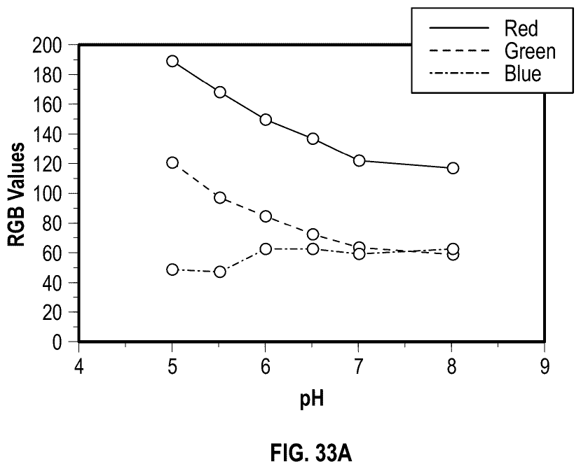

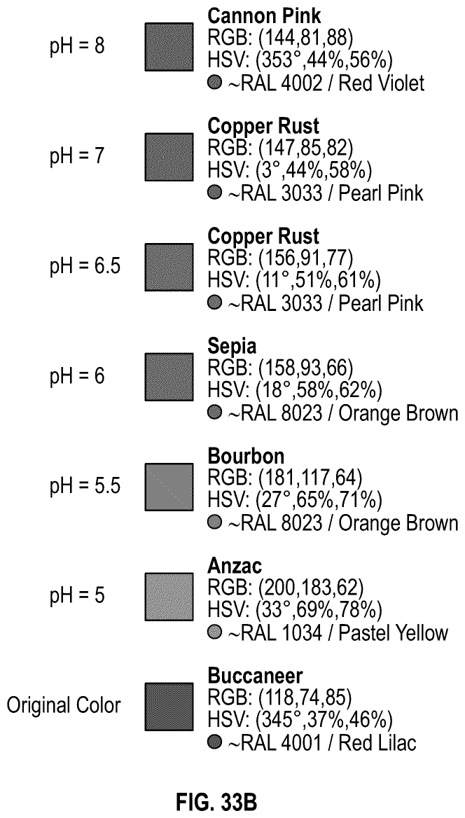

Chlorophenol red-PVA sensors were prepared and tested according to the protocol of Example 1. The sensors were immersed into buffer solutions with different pH values. Images of the sensors were taken using a smartphone camera. The sensors were fixed at the same location for all images to control the environment lighting and background. The RGB values of the images were analyzed via an image processing mobile application. FIG. 33A illustrates the RGB value versus pH value calibration curves used by the mobile application, and FIG. 33B illustrates the detected colors (RGB, HSV, and RAL color information) of the intraoral sensors along with the corresponding pH values. These results indicate that the RGB value of the color of the intraoral sensor can be used to quantify salivary pH levels.

### Example 3: Biocompatible Polymers for Intraoral Sensing

This example describes preparation and characterization of intraoral sensors using biocompatible polymers. The sensors were prepared by combining an anthocyanin dye, delphinidin chloride, with pHEMA or gelatin. For pHEMA-based sensors, a sensor substrate was prepared by dropping 10 μL of a 5% pHEMA solution containing 2.5 mg/mL delphinidin chloride onto a hydrophobic substrate. For gelatin-based sensors, a sensor substrate was prepared by dropping 10 μL of a 10% gelatin solution containing 2.5 mg/mL delphinidin chloride onto a hydrophobic substrate. The sensor substrate was dried at 70° C. for 30 minutes. 5 μL of 2.5% gelatin or 2.5% pHEMA was then dropped onto the sensor substrate to form a barrier layer, and the sensor was dried at 70° C. for 30 minutes.

The pH testing protocol was as follows. Sensors were incubated in a pH 3 solution for 30 minutes, and the color change was measured. The sensors were then washed with DI water. The sensors were then incubated in a pH 10 solution for 30 minutes, and the color change was measured.

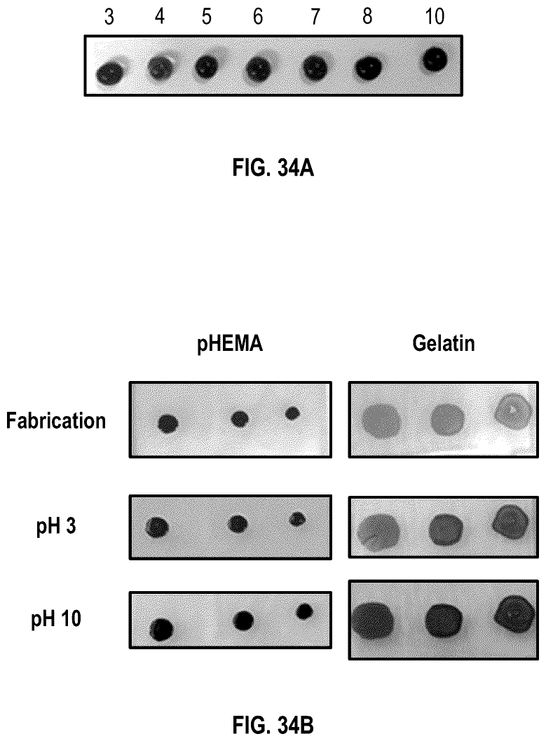

FIG. 34A is a photograph illustrating the different colors of delphinidin chloride at different pH values. FIG. 34B illustrates sensors formed with delphinidin chloride and pHEMA (left images) or gelatin (right images). As shown in FIG. 34B, the sensor exhibited reversible color changes at different pH values.

### Additional Examples

The following examples are included to further describe some aspects of the present technology, and should not be used to limit the scope of the technology.
Clause 1. An intraoral sensor for sensing pH within an intraoral cavity of a subject, the intraoral sensor comprising:
   a film comprising a biocompatible polymer and a pH-sensitive molecule, wherein the pH-sensitive molecule is configured to change in color based on a pH within a subject's intraoral cavity, and wherein the pH-sensitive molecule is immobilized in the film; and
   an adhesive configured to couple the film to a surface of a dental appliance or a tooth of the subject.
Clause 2. The intraoral sensor of Clause 1, wherein the pH-sensitive molecule is covalently conjugated to the biocompatible polymer.
Clause 3. The intraoral sensor of Clause 1 or 2, wherein the pH-sensitive molecule is configured to change in color when the pH of the subject's intraoral cavity is within a range from 5 to 7.
Clause 4. The intraoral sensor of any one of Clauses 1 to 3, wherein the pH-sensitive molecule is configured to have a first color when the pH of the subject's intraoral cavity is greater than 5.5, and to have a second color different from the first color when the pH of the subject's intraoral cavity is less than 5.5.
Clause 5. The intraoral sensor of any one of Clauses 1 to 4, wherein the change in color of the pH-sensitive molecule is reversible.
Clause 6. The intraoral sensor of any one of Clauses 1 to 5, wherein the pH-sensitive molecule comprises one or more of chlorophenol red, methyl red, or bromocresol purple.
Clause 7. The intraoral sensor of any one of Clauses 1 to 6, wherein the biocompatible polymer comprises one or more of agarose, cellulose, carboxymethyl cellulose, hydroxyethyl cellulose, chitosan, gelatin, pectin, poly(2-hydroxyethyl methacrylate) (pHEMA), polyacrylamide, polyurethane, poly(vinyl alcohol) (PVA), poly(ethylene glycol) (PEG), polystyrene, polyvinylpyrrolidone (PVP), poly(lactic-co-glycolic acid) (PLGA), or starch.
Clause 8. The intraoral sensor of any one of Clauses 1 to 7, wherein the biocompatible polymer comprises poly(vinyl alcohol) (PVA) and the pH-sensitive molecule comprises chlorophenol red.
Clause 9. The intraoral sensor of Clause 8, wherein the pH-sensitive molecule comprises a chlorophenol red-formaldehyde complex that is conjugated to the PVA via a covalent bond between a formaldehyde group of the chlorophenol red-formaldehyde complex and a hydroxyl group of the PVA.
Clause 10. The intraoral sensor of any one of Clauses 1 to 9, wherein the film has a thickness within a range from 10 μm to 100 μm.
Clause 11. The intraoral sensor of any one of Clauses 1 to 10, wherein the film comprises:
   a first surface configured to be coupled to a buccal surface of the dental appliance or a buccal surface of the tooth, and
   a second surface configured to be directly exposed to the subject's intraoral cavity.
Clause 12. The intraoral sensor of Clause 11, wherein the first surface is configured to be coupled to the buccal surface of the dental appliance or the buccal surface of the tooth via the adhesive.
Clause 13. The intraoral sensor of any one of Clauses 1 to 12, further comprising a color reference marker.
Clause 14. The intraoral sensor of Clause 13, wherein the color reference marker is part of the film.
Clause 15. The intraoral sensor of Clause 13, wherein the color reference marker is coupled to the film.
Clause 16. The intraoral sensor of any one of Clauses 13 to 15, wherein the color reference marker has a fixed color.
Clause 17. A dental appliance comprising:
   a polymeric shell comprising a plurality of cavities configured to receive a subject's teeth; and
   an intraoral sensor coupled to the polymeric shell, wherein the intraoral sensor comprises a pH-sensitive molecule that is configured to change in color based on a pH of the subject's intraoral cavity, and wherein the pH-sensitive molecule is immobilized in the intraoral sensor.
Clause 18. The dental appliance of Clause 17, wherein the dental appliance is an aligner, a palatal expander, a mouth guard, a night guard, or a retainer.
Clause 19. The dental appliance of Clause 17 or 18, wherein the pH-sensitive molecule is configured to change in color when the pH of the subject's intraoral cavity is within a range from 5 to 7.
Clause 20. The dental appliance of any one of Clauses 17 to 19, wherein the pH-sensitive molecule is configured to have a first color when the pH of the subject's intraoral cavity is greater than 5.5, and to have a second color different from the first color when the pH of the subject's intraoral cavity is less than 5.5.
Clause 21. The dental appliance of any one of Clauses 17 to 20, wherein the change in color of the pH-sensitive molecule is reversible.
Clause 22. The dental appliance of any one of Clauses 17 to 21, wherein the pH-sensitive molecule comprises one or more of chlorophenol red, methyl red, or bromocresol purple.
Clause 23. The dental appliance of any one of Clauses 17 to 22, wherein the intraoral sensor is a film comprising the pH-sensitive molecule and a biocompatible polymer.
Clause 24. The dental appliance of Clause 23, wherein the pH-sensitive molecule is covalently conjugated to the biocompatible polymer.
Clause 25. The dental appliance of Clause 23 or 24, wherein the biocompatible polymer comprises one or more of agarose, cellulose, carboxymethyl cellulose, hydroxyethyl cellulose, chitosan, gelatin, pectin, poly(2-hydroxyethyl methacrylate) (pHEMA), polyacrylamide, polyurethane, poly(vinyl alcohol) (PVA), poly(ethylene glycol) (PEG), polystyrene, polyvinylpyrrolidone (PVP), poly(lactic-co-glycolic acid) (PLGA), or starch.
Clause 26. The dental appliance of any one of Clauses 23 to 25, wherein the biocompatible polymer comprises poly(vinyl alcohol) (PVA) and the pH-sensitive molecule comprises chlorophenol red.
Clause 27. The dental appliance of Clause 26, wherein the pH-sensitive molecule comprises a chlorophenol red-formaldehyde complex that is conjugated to the PVA via a covalent bond between a formaldehyde group of the chlorophenol red-formaldehyde complex and a hydroxyl group of the PVA.
Clause 28. The dental appliance of any one of Clauses 23 to 27, wherein the film has a thickness within a range from 10 μm to 100 μm.
Clause 29. The dental appliance of any one of Clauses 23 to 28, wherein the film comprises:
a first surface configured to be coupled to a buccal surface of the dental appliance, and
   a second surface configured to be directly exposed to the subject's intraoral cavity.
Clause 30. The dental appliance of any one of Clauses 17 to 29, wherein the intraoral sensor comprises a second pH-sensitive molecule that is configured to change in color based on the pH of the subject's intraoral cavity, wherein the second pH-sensitive molecule is different from the first pH-sensitive molecule.
Clause 31. The dental appliance of any one of Clauses 17 to 30, wherein the intraoral sensor is coupled to the polymeric shell via one or more of an adhesive, a fastener, or a mechanical fit.
Clause 32. The dental appliance of Clause 31, wherein the intraoral sensor is coupled to the polymeric shell via the adhesive, and the adhesive comprises a UV-curable adhesive.
Clause 33. The dental appliance of any one of Clauses 17 to 32, wherein the intraoral sensor is coupled to an exterior surface of the polymeric shell.
Clause 34. The dental appliance of any one of Clauses 17 to 33, further comprising a color reference marker coupled to the polymeric shell.
Clause 35. The dental appliance of Clause 34, wherein the color reference marker is part of the intraoral sensor.
Clause 36. The dental appliance of Clause 34, wherein the color reference marker is separate from the intraoral sensor.
Clause 37. The dental appliance of any one of Clauses 17 to 36, further comprising a second intraoral sensor coupled to the polymeric shell, the second intraoral sensor comprising a second pH-sensitive molecule that is configured to change in color based on the pH of the subject's intraoral cavity, wherein the second pH-sensitive molecule is different from the first pH-sensitive molecule.
Clause 38. The dental appliance of Clause 37, wherein the first intraoral sensor is coupled to first portion of the polymeric shell, and the second intraoral sensor is coupled to a second portion of the polymeric shell, the second portion being different from the first portion.
Clause 39. A system comprising:
   an intraoral sensor configured to be coupled to a dental appliance, the intraoral sensor comprising a biocompatible polymer and a pH-sensitive molecule, wherein the pH-sensitive molecule is configured to change in color based on a pH of a subject's intraoral cavity, and wherein the pH-sensitive molecule is immobilized within the intraoral sensor; and
   an optical sensing device configured to generate data indicative of the color of the pH-sensitive molecule.
Clause 40. The system of Clause 39, wherein the optical sensing device comprises an imaging device.
Clause 41. The system of Clause 39 or 40, wherein the optical sensing device comprises a spectrophotometer.
Clause 42. The system of any one of Clauses 39 to 41, wherein the optical sensing device is a part of a mobile device.
Clause 43. The system of any one of Clauses 39 to 42, wherein the optical sensing device is part of a receptacle configured to receive a portion of the dental appliance including the intraoral sensor.
Clause 44. The system of Clause 43, further comprising the receptacle.
Clause 45. The system of Clause 44, wherein the receptacle is a case for the dental appliance.
Clause 46. The system of Clause 44, wherein the receptacle is configured to receive only the portion of the dental appliance.
Clause 47. The system of Clause 44 or 45, wherein the receptacle is configured to receive the entire dental appliance.
Clause 48. The system of any one of Clauses 44 to 47, wherein the receptacle comprises a light source configured to illuminate the portion of the dental appliance.
Clause 49. The system of any one of Clauses 44 to 48, wherein the receptacle comprises a registration structure configured to couple to the portion of the dental appliance such that the intraoral sensor is at a predetermined position and orientation relative to the optical sensing device.
Clause 50. The system of any one of Clauses 44 to 49, wherein the receptacle comprises a transmitter configured to transmit the data to a computing device.
Clause 51. The system of Clause 50, wherein the computing device is a mobile device.
Clause 52. The system of any one of Clauses 44 to 51, further comprising one or more processors configured to:
   access the data generated by the optical sensing device, determine a pH associated with the intraoral cavity based on the data, and
   send instructions to an output device to display an output indicative of the determined pH of the intraoral cavity.
Clause 53. The system of Clause 52, further comprising a color reference marker, wherein the data generated by the optical sensing device is indicative of a color of the color reference marker, and wherein the one or more processors are configured to determine the pH associated with the intraoral cavity based on the color of the color reference marker.
Clause 54. The system of Clause 53, wherein the color reference marker is part of the intraoral sensor.
Clause 55. The system of Clause 53, wherein the color reference marker is separate from the intraoral sensor.
Clause 56. The system of any one of Clauses 53 to 55, wherein the color reference marker has a fixed color.
Clause 57. The system of any one of Clauses 52 to 56, further comprising one or more processors configured to:
   determine whether the determined pH falls within a pH range associated with an oral disease or condition,
   determine one or more recommendations for remedying the oral disease or condition, and send instructions to an output device to display the one or more recommendations.
Clause 58. The system of any one of Clauses 39 to 57, wherein the pH-sensitive molecule is covalently conjugated to the biocompatible polymer.
Clause 59. The system of any one of Clauses 39 to 58, wherein the pH-sensitive molecule is configured to change in color when the pH of the subject's intraoral cavity is within a range from 5 to 7.
Clause 60. The system of any one of Clauses 39 to 59, wherein the pH-sensitive molecule is configured to have a first color when the pH of the subject's intraoral cavity is greater than 5.5, and to have a second color different from the first color when the pH of the subject's intraoral cavity is less than 5.5.
Clause 61. The system of any one of Clauses 39 to 60, wherein the change in color of the pH-sensitive molecule is reversible.
Clause 62. The system of any one of Clauses 39 to 61, wherein the pH-sensitive molecule comprises one or more of chlorophenol red, methyl red, or bromocresol purple.
Clause 63. The system of any one of Clauses 39 to 62, wherein the biocompatible polymer comprises one or more of agarose, cellulose, carboxymethyl cellulose, hydroxyethyl cellulose, chitosan, gelatin, pectin, poly(2-hydroxyethyl methacrylate) (pHEMA), polyacrylamide, polyurethane, poly(vinyl alcohol) (PVA), poly(ethylene glycol) (PEG), polystyrene, polyvinylpyrrolidone (PVP), poly(lactic-co-glycolic acid) (PLGA), or starch.
Clause 64. The system of any one of Clauses 39 to 63, wherein the biocompatible polymer comprises poly(vinyl alcohol) (PVA) and the pH-sensitive molecule comprises chlorophenol red.
Clause 65. The system of Clause 64, wherein the pH-sensitive molecule comprises a chlorophenol red-formaldehyde complex that is conjugated to the PVA via a covalent bond between a formaldehyde group of the chlorophenol red-formaldehyde complex and a hydroxyl group of the PVA.
Clause 66. The system of any one of Clauses 39 to 65, wherein the intraoral sensor comprises a film composed of the pH-sensitive molecule and the biocompatible polymer.
Clause 67. The system of Clause 66, wherein the film has a thickness within a range from 10 μm to 100 μm.
Clause 68. The system of Clause 66 or 67, wherein the film comprises: a first surface configured to be coupled to a buccal surface of the dental appliance, and a second surface configured to be directly exposed to the subject's intraoral cavity.
Clause 69. The system of any one of Clauses 39 to 68, wherein the intraoral sensor is configured to be coupled to the dental appliance via one or more of an adhesive, a fastener, or a mechanical fit.
Clause 70. The system of any one of Clauses 39 to 69, further comprising the dental appliance, wherein the dental appliance is an aligner, a palatal expander, a mouth guard, a night guard, or a retainer.
Clause 71. A computer-implemented method for monitoring a subject's intraoral cavity, the method comprising, by one or more processors:
   receiving data indicative of a color of an intraoral sensor coupled to a dental appliance that has been worn in the subject's intraoral cavity, wherein the intraoral sensor comprises a pH-sensitive molecule that produces a change in the color based on a pH of the intraoral cavity, and wherein the pH-sensitive molecule is immobilized within the intraoral sensor;
   determining the pH of the intraoral cavity based on the data; and
   displaying an output indicative of the determined pH of the intraoral cavity.
Clause 72. The computer-implemented method of Clause 71, wherein the data comprises image data of the intraoral sensor.
Clause 73. The computer-implemented method of Clause 72, further comprising:
   identifying a sensor region in the image data depicting the intraoral sensor, and
   determining a representative color value for the sensor region.
Clause 74. The computer-implemented method of Clause 73, further comprising:
   converting the representative color value from a first color space into a second color space, wherein the second color space comprises one or more luminance channels, and
   removing the one or more luminance channels from the converted representative color value.
Clause 75. The computer-implemented method of any one of Clauses 72 to 74, wherein the image data comprises at least one image obtained with camera flash activated.
Clause 76. The computer-implemented method of any one of Clauses 71 to 75, wherein the data comprises spectrophotometric data of the intraoral sensor.
Clause 77. The computer-implemented method of any one of Clauses 71 to 76, further comprising:
   processing the data to detect the color of the intraoral sensor, and correlating the detected color to the pH of the intraoral cavity.
Clause 78. The computer-implemented method of any one of Clauses 71 to 77, further comprising receiving data indicative of a color of a color reference marker coupled to the dental appliance, wherein the pH of the intraoral cavity is determined based on the color of the color reference marker.
Clause 79. The computer-implemented method of any one of Clauses 71 to 78, wherein the output comprises the determined pH.
Clause 80. The computer-implemented method of any one of Clauses 71 to 79, wherein the output comprises an alert that the subject may have an oral disease or condition.
Clause 81. The computer-implemented method of any one of Clauses 71 to 80, wherein the output comprises one or more previous pH values.
Clause 82. The computer-implemented method of any one of Clauses 71 to 81, further comprising determining whether the determined pH falls within a pH range associated with an oral disease or condition.
Clause 83. The computer-implemented method of Clause 82, further comprising:
   determining one or more recommendations for remedying the oral disease or condition, and
   displaying the one or more recommendations on a display of a computing device.
Clause 84. The computer-implemented method of Clause 82 or 83, wherein the pH range is less than 5.5, and the oral disease or condition is one or more of dental decay, periodontitis, or halitosis.
Clause 85. The computer-implemented method of any one of Clauses 82 to 84, wherein the computing device is associated with the subject.
Clause 86. The computer-implemented method of any one of Clauses 82 to 84, wherein the computing device is associated with a healthcare provider of the subject.
Clause 87. The computer-implemented method of any one of Clauses 71 to 86, wherein the data is received from an optical sensing device of a mobile device, and the output is displayed on the mobile device.
Clause 88. The computer-implemented method of any one of Clauses 71 to 87, wherein the data is received from an optical sensing device, and the output is displayed on a computing device separate from the optical sensing device.
Clause 89. The computer-implemented method of Clause 88, wherein the optical sensing device is part of a receptacle configured to receive a portion of the dental appliance including the intraoral sensor.
Clause 90. The computer-implemented method of any one of Clauses 71 to 89, wherein the pH-sensitive molecule is configured to change in color when the pH of the intraoral cavity is within a range from 5 to 7.
Clause 91. The computer-implemented method of any one of Clauses 71 to 90, wherein the pH-sensitive molecule is configured to have a first color when the pH of the intraoral cavity is greater than 5.5, and to have a second color different from the first color when the pH of the intraoral cavity is less than 5.5.
Clause 92. The computer-implemented method of any one of Clauses 71 to 91, wherein the change in color of the pH-sensitive molecule is reversible.
Clause 93. The computer-implemented method of any one of Clauses 71 to 92, wherein the pH-sensitive molecule comprises one or more of chlorophenol red, methyl red, or bromocresol purple.
Clause 94. The computer-implemented method of any one of Clauses 71 to 93, wherein the intraoral sensor is a film comprising the pH-sensitive molecule and a biocompatible polymer.
Clause 95. The computer-implemented method of Clause 94, wherein the pH-sensitive molecule is covalently conjugated to the biocompatible polymer.
Clause 96. The computer-implemented method of Clause 94 or 95, wherein the biocompatible polymer comprises one or more of agarose, cellulose, carboxymethyl cellulose, hydroxyethyl cellulose, chitosan, gelatin, pectin, poly(2-hydroxyethyl methacrylate) (pHEMA), polyacrylamide, polyurethane, poly(vinyl alcohol) (PVA), poly(ethylene glycol) (PEG), polystyrene, polyvinylpyrrolidone (PVP), poly(lactic-co-glycolic acid) (PLGA), or starch.
Clause 97. The computer-implemented method of any one of Clauses 71 to 96, wherein the dental appliance is an aligner, a palatal expander, a mouth guard, a night guard, or a retainer.
Clause 98. The computer-implemented method of any one of Clauses 71 to 97, wherein the pH is determined based on calibration data for the intraoral sensor, and wherein the calibration comprises at least one image of the intraoral sensor after exposure to a calibration solution.
Clause 99. A non-transitory computer-readable storage medium comprising instructions that, when executed by one or more processors of a computing system, cause the computing system to perform operations comprising:
   receiving data indicative of a color of an intraoral sensor coupled to a dental appliance that has been worn in the subject's intraoral cavity, wherein the intraoral sensor comprises a pH-sensitive molecule that produces a change in the color based on a pH of the intraoral cavity, and wherein the pH-sensitive molecule is immobilized within the intraoral sensor;
   determining the pH of the intraoral cavity based on the data; and
   displaying an output indicative of the determined pH of the intraoral cavity.
Clause 100. A dental appliance comprising: a polymeric shell comprising a plurality of cavities configured to receive a subject's teeth;
   a compliance indicator coupled to the polymeric shell, wherein the compliance indicator is configured to change in color based on a wear time of the dental appliance; and
   an intraoral sensor coupled to the polymeric shell, wherein the intraoral sensor is configured to detect a condition of the subject's intraoral cavity that affects the color of the compliance indicator.
Clause 101. The dental appliance of Clause 100, wherein the intraoral sensor comprises a pH sensor having a pH-sensitive molecule that changes in color based on a pH of the subject's intraoral cavity.
Clause 102. The dental appliance of Clause 100 or 101, wherein the intraoral sensor comprises a temperature sensor configured to measure a temperature of the subject's intraoral cavity.
Clause 103. A dental appliance comprising:
   a polymeric shell comprising a plurality of cavities configured to receive a subject's teeth; and
   an intraoral sensor coupled to the polymeric shell, wherein the intraoral sensor comprises a colorimetric molecule that is configured to change in color when exposed to a chemical species associated with an oral disease or condition.
Clause 104. The dental appliance of Clause 103, wherein the oral disease or condition comprises dental caries.

### CONCLUSION

Although many of the embodiments are described above with respect to systems, devices, and methods for monitoring a subject's intraoral cavity, the technology is applicable to other applications and/or other approaches, such as monitoring other locations on or within a subject's body. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-34B.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the term “subject” refers to any user of the disclosed monitoring devices, systems, and methods, including patients (e.g., patients undergoing orthodontic or dental treatments, patients with gum disease and/or other oral diseases or conditions), or other users who would benefit from the disclosed monitoring devices, systems, and methods.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A dental appliance comprising:
a polymeric shell comprising a plurality of cavities configured to receive a subject's teeth; and
an intraoral sensor coupled to the polymeric shell, wherein the intraoral sensor comprises a pH-sensitive molecule that is configured to change in color based on a pH of the subject's intraoral cavity, and wherein the pH-sensitive molecule is immobilized in the intraoral sensor.

2. The dental appliance of claim 1, wherein the intraoral sensor is a film comprising the pH-sensitive molecule and a biocompatible polymer.

3. The dental appliance of claim 2, wherein the pH-sensitive molecule is covalently conjugated to the biocompatible polymer.

4. The dental appliance of claim 2, wherein the film comprises:
a first surface configured to be coupled to a buccal surface of the dental appliance, and a second surface configured to be directly exposed to the subject's intraoral cavity.

5. The dental appliance of claim 1, further comprising a color reference marker coupled to the polymeric shell.

6. The dental appliance of claim 5, wherein the color reference marker is part of the intraoral sensor.

7. The dental appliance of claim 5, wherein the color reference marker is separate from the intraoral sensor.

8. A system comprising:
an intraoral sensor configured to be coupled to a dental appliance, the intraoral sensor comprising a biocompatible polymer and a pH-sensitive molecule, wherein the pH-sensitive molecule is configured to change in color based on a pH of a subject's intraoral cavity, and wherein the pH-sensitive molecule is immobilized within the intraoral sensor; and
an optical sensing device configured to generate data indicative of the color of the pH-sensitive molecule.

9. The system of claim 8, wherein the optical sensing device comprises an imaging device or a spectrophotometer.

10. The system of claim 8, wherein the optical sensing device is a part of a mobile device.

11. The system of claim 8, further comprising a receptacle configured to receive a portion of the dental appliance including the intraoral sensor, wherein the optical sensing device is part of the receptacle.

12. The system of claim 8, further comprising one or more processors configured to:
access the data generated by the optical sensing device,
determine a pH associated with the intraoral cavity based on the data, and
send instructions to an output device to display an output indicative of the determined pH of the intraoral cavity.

13. The system of claim 12, further comprising a color reference marker, wherein the data generated by the optical sensing device is indicative of a color of the color reference marker, and wherein the one or more processors are configured to determine the pH associated with the intraoral cavity based on the color of the color reference marker.

14. The system of claim 12, further comprising one or more processors configured to:
determine whether the determined pH falls within a pH range associated with an oral disease or condition,
determine one or more recommendations for remedying the oral disease or condition, and send instructions to an output device to display the one or more recommendations.

15. An intraoral sensor for sensing pH within an intraoral cavity of a subject, the intraoral sensor comprising:
a film comprising a biocompatible polymer and a pH-sensitive molecule, wherein the pH-sensitive molecule is configured to change in color based on a pH within a subject's intraoral cavity, and wherein the pH-sensitive molecule is immobilized in the film; and
an adhesive configured to couple the film to a surface of a dental appliance or a tooth of the subject.

16. The intraoral sensor of claim 15, wherein the pH-sensitive molecule is covalently conjugated to the biocompatible polymer.

17. The intraoral sensor of claim 15, wherein the pH-sensitive molecule is configured to change in color when the pH of the subject's intraoral cavity is within a range from 5 to 7.

18. The intraoral sensor of claim 15, wherein the pH-sensitive molecule comprises one or more of chlorophenol red, methyl red, or bromocresol purple.

19. The intraoral sensor of claim 15, wherein the biocompatible polymer comprises one or more of agarose, cellulose, carboxymethyl cellulose, hydroxyethyl cellulose, chitosan, gelatin, pectin, poly(2-hydroxyethyl methacrylate) (pHEMA), polyacrylamide, polyurethane, poly(vinyl alcohol) (PVA), poly(ethylene glycol) (PEG), polystyrene, polyvinylpyrrolidone (PVP), poly(lactic-co-glycolic acid) (PLGA), or starch.

20. The intraoral sensor of claim 15, further comprising a color reference marker having a fixed color.
